(19) United States
(12) Patent Application Publication
(10) Pub. No.: US 2026/0201873 A1
(43) Pub. Date: Jul. 16, 2026

(54) VAPOR RECOVERY MULTI-STAGE COMMON-ROD HYDRAULIC COMPRESSOR

(71) Applicant: I-JACK TECHNOLOGIES INCORPORATED, Moosomin (CA)

(72) Inventor: Dan McCarthy, Moosomin (CA)

(21) Appl. No.: 19/281,445

(22) Filed: Jul. 25, 2025

Related U.S. Application Data
(63) Continuation-in-part of application No. 18/784,723, filed on Jul. 25, 2024.

(51) Int. Cl. F04B 25/00; B01D 19/00; F04B 39/00

(52) U.S. Cl. CPC F04B 25/00; B01D 19/0036; F04B 39/0005

(57) ABSTRACT

A multi-cylinder fluid compressor for compressing a working fluid. The compressor includes a first gas compression cylinder, divided into axially aligned compression chambers by a first reciprocating gas piston, and a second gas compression cylinder, divided into axially aligned compression chambers by a second reciprocating gas piston. The gas compression cylinders are axially aligned, axially connected, and the reciprocating gas pistons are driven by a common piston rod extending through the compression cylinders and operably connected with the reciprocating gas pistons. The common piston rod is reciprocally driven by a hydraulic fluid supply system to reciprocally drive the reciprocating gas pistons. The compressor system may be operated as a multi-stage compressor system by conveying working fluid outlet from one compression chamber to the inlet of another compression chamber. Cooling may be provided between stages. One application for the compressor is in a vapor recovery system for drawing low pressure vapors that can accumulate above hydrocarbon liquids in a tank.

### CROSS-REFERENCE TO RELATED APPLICATION

This application is a Continuation-in-part of U.S. patent application Ser. No. 18/784,723 filed on Jul. 25, 2024. The contents of the aforementioned application are incorporated by reference herein.

### FIELD

This disclosure relates to compressors, such as may be used to compress the products of an oil well, or for vapor recovery in an oil or fuel tank, and more particularly to a common drive rod multi-stage reciprocating piston compressor.

### BACKGROUND

While the main product of an oil well is generally extracted from the well by a liquid pumping arrangement, the oil well produces other byproducts including hydrocarbons in the liquid and/or gas phase. The ratio between liquid and gas phase byproducts varies from well to well and varies over time and as such is generally not fixed. At any given point in time the byproducts of the well could be comprised of anything between 100% gas byproduct to 100% liquid byproduct.

It is known that when compressing fluids in multiple stages, a significant amount of heat may be generated during each stage of compression, which can cause concerns with regards to safely handing the fluids and maintain within the desired operating temperatures of components of the compressor, such as the seals.

There are concerns in using hydraulic gas compressors in oil and gas field environments, relating to the potential contamination of the hydraulic fluid in the hydraulic cylinder of a gas compressor from components of the natural gas that is being compressed. There are additional concerns in inefficient hydraulic gas compressor operation and increased costs associated with using such compressors.

Improved gas compressors and control systems and methods are desirable, including gas compressors employed in connection with oil and gas field operations including in connection with oil and gas producing wells.

### SUMMARY

In an embodiment of the present disclosure, there is provided a multi-cylinder fluid compressor operable to compress a working fluid, said multi-cylinder fluid compressor comprising: a first gas compression cylinder, divided into first and second axially aligned compression chambers by a first reciprocating gas piston, each of the first and second compression chambers of the first gas compression cylinder having an inlet and an outlet; a second gas compression cylinder, divided into third and fourth axially aligned compression chambers by a second reciprocating gas piston, each of the third and fourth compression chambers of the second gas compression cylinder having an inlet and an outlet; wherein the first gas compression cylinder and the second gas compression cylinder are axially aligned; a common piston rod extending through said first and second axially aligned compression cylinders and operably connected with the first reciprocating gas piston and the second reciprocating gas piston; first and second hydraulic cylinders positioned at opposite ends of the multi-cylinder fluid compressor, with the first and second compression cylinders therebetween to axially drive the common piston rod; wherein the first and second hydraulic cylinders are adapted to be actuated by a hydraulic fluid supply system to reciprocally drive the common piston rod and thereby the first reciprocating gas piston and the second reciprocating gas piston.

In an embodiment of the present disclosure, the multi-cylinder fluid compressor further comprises a seal device between the common piston rod and the first gas compression cylinder and a seal device between the common piston rod and the second gas compression cylinder; a piston seal device between the first reciprocating gas piston and the first gas compression cylinder; and a piston seal device between the second reciprocating gas piston and the second gas compression cylinder.

In an embodiment of the present disclosure, the first hydraulic cylinder is at a head of the first gas compression cylinder and has a first hydraulic piston operatively connected to the piston rod to drive the piston rod in a first axial direction, and wherein the second hydraulic cylinder is at a head of the second gas compression cylinder and has a second hydraulic piston operatively connected to the piston rod to drive the piston rod in a second axial direction, the second axial direction opposite the first axial direction.

In an embodiment of the present disclosure, the multi-cylinder fluid compressor further comprises a first hydraulic piston seal device between the first hydraulic piston and the first hydraulic cylinder and a second hydraulic piston seal device between the second hydraulic piston and the second hydraulic cylinder.

In an embodiment of the present disclosure, the outlets of the first gas compression cylinder are in fluid communication with the inlets of the second gas compression cylinder to provide a multi-stage fluid compressor.

In an embodiment of the present disclosure, the multi-cylinder fluid compressor further comprises a cooler in fluid communication with the outlets of the first gas compression cylinder and the inlets of the second gas compression cylinder.

In an embodiment of the present disclosure, the multi-cylinder fluid compressor further comprises an outlet header fluidly connecting the outlets of the first gas compression cylinder and further comprising an inlet header fluidly connecting the inlets of the second gas compression cylinder, wherein the cooler is in fluid communication between the outlet header and the inlet header. In an embodiment of the present disclosure, the cooler comprises a plate and frame oil cooler.

In an embodiment of the present disclosure, the multi-cylinder fluid compressor further comprises a first buffer chamber, comprising a variable annular space between the common piston rod and the first hydraulic piston extending between the head of the first gas compression cylinder and the first hydraulic piston, and a second buffer chamber, comprising a variable annular space between the common piston rod and the second hydraulic piston extending between the head of the second gas compression cylinder and the second hydraulic piston. In an embodiment of the present disclosure, the first buffer chamber and the second buffer chamber are pressurized, pressure equalized, vented, fluidly connected, or combinations thereof.

In an embodiment of the present disclosure, the inlets of the first and second gas compression cylinders are proximate a top of the first and second gas compression cylinders.

In an embodiment of the present disclosure, the outlets of the first and second gas compression cylinders are proximate a bottom of the first and second gas compression cylinders.

In an embodiment of the present disclosure, one or more of the inlets or the outlets or both of the first and second gas compression cylinders are radial.

In an embodiment of the present disclosure, one or more of the inlets or the outlets or both of the first and second gas compression cylinders are axial.

In an embodiment of the present disclosure, the first and second gas compression cylinders are spaced axially apart. In an embodiment of the present disclosure a housing encloses the common piston rod between the first and second gas compression cylinders.

In an embodiment of the present disclosure, the first and second gas compression cylinders are substantially adjacent, and connected by a connector plate.

In an embodiment of the present disclosure, the multi-cylinder fluid compressor further comprising a variable volume pocket fluidly connected with at least one of the first, second, third, and fourth compression chambers.

In an embodiment of the present disclosure, each of the inlets and the outlets of the first, second, third, and fourth compression chambers are in fluid communication with a one-way check valve.

In an embodiment of the present disclosure, the piston seal devices include one or more wear rings.

In an embodiment of the present disclosure, the multi-cylinder fluid compressor further comprises a third gas compression cylinder, divided into fifth and sixth axially aligned compression chambers by a third reciprocating gas piston, each of the fifth and sixth compression chambers of the third gas compression cylinder having an inlet and an outlet; wherein the third gas compression cylinder is substantially axially aligned with the first gas compression cylinder and the second gas compression cylinder; wherein the common piston rod is operably connected to the third reciprocating gas piston; wherein the outlets of the second gas compression cylinder are in fluid communication with the inlets of the third gas compression cylinder; a seal device between the common piston rod and the third gas compression cylinder; and a piston seal device between the third reciprocating gas piston and the third gas compression cylinder.

In an embodiment of the present disclosure, the multi-cylinder fluid compressor further comprising the hydraulic fluid supply system.

In a further embodiment of the present disclosure, there is provided a method of recovering vapor from a tank containing liquid hydrocarbons, the method comprising: delivering a flow of the vapor to a first gas compression cylinder of a multi-cylinder fluid compressor, the first gas compression cylinder divided into first and second axially aligned compression chambers by a first reciprocating gas piston; operating the first reciprocating gas piston to increase pressure of the vapor delivered to the first and second compression chambers to provide a flow of pressurized vapor; delivering the flow of pressurized vapor to a second gas compression cylinder of the multi-cylinder fluid compressor, the second gas compression cylinder divided into third and fourth axially aligned compression chambers by a second reciprocating gas piston; operating the second reciprocating gas piston in common with the first reciprocating gas piston, to further increase pressure of the pressurized vapor delivered to the third and fourth compression chambers to provide a flow of further pressurized vapor; and delivering the flow of further pressurized vapor from the third and fourth compression chambers.

In an embodiment of the present disclosure, the method further comprises cooling the flow of pressurized vapor from the first and second compression chambers to provide a flow of cooled pressurized vapor, prior to delivering the flow of cooled pressurized vapor to the third and fourth compression chambers.

In an embodiment of the present disclosure, operating the second reciprocating gas piston in common with the first reciprocating gas piston comprises starting the operating, stopping the operating, setting a speed of the operating, adjusting a speed of the operating, maintaining the speed of the operating, or combinations thereof.

In an embodiment of the present disclosure, operating the second reciprocating gas piston in common with the first reciprocating gas piston is responsive to pressure of the vapor in the tank.

In an embodiment of the present disclosure, there is provided a multi-cylinder fluid compressor operable to compress a working fluid, said multi-cylinder fluid compressor comprising: a first gas compression cylinder, divided into first and second axially aligned compression chambers by a first reciprocating gas piston, each of the first and second compression chambers of the first gas compression cylinder having an inlet and an outlet; a second gas compression cylinder, divided into third and fourth axially aligned compression chambers by a second reciprocating gas piston, each of the third and fourth compression chambers of the second gas compression cylinder having an inlet and an outlet; wherein the second gas compression cylinder has a diameter less than the first gas compression cylinder; wherein the first gas compression cylinder and the second gas compression cylinder are axially aligned, and substantially axially adjacent; wherein a second gas cylinder head of the first gas compression cylinder and a first gas cylinder head of the second gas compression cylinder are axially connected; wherein the first gas cylinder head of the second gas compression cylinder provides an internal inlet flow passage extending between the inlet and the third compression chamber and an internal outlet flow passage extending between the third compression chamber and the outlet, a common piston rod extending through said first and second axially aligned compression cylinders and operably connected with the first reciprocating gas piston and the second reciprocating gas piston; first and second hydraulic cylinders positioned at opposite ends of the multi-cylinder fluid compressor, with the first and second compression cylinders therebetween to axially drive the common piston rod; wherein the first and second hydraulic cylinders are adapted to be actuated by a hydraulic fluid supply system to reciprocally drive the common piston rod and thereby the first reciprocating gas piston and the second reciprocating gas piston.

In an embodiment of the present disclosure, the multi-cylinder fluid compressor further comprises a seal device between the common piston rod and the first gas compression cylinder and a seal device between the common piston rod and the second gas compression cylinder; a piston seal device between the first reciprocating gas piston and the first gas compression cylinder; and a piston seal device between the second reciprocating gas piston and the second gas compression cylinder.

In an embodiment of the present disclosure, the first hydraulic cylinder is at a head of the first gas compression cylinder and has a first hydraulic piston operatively connected to the piston rod to drive the piston rod in a first axial direction, and wherein the second hydraulic cylinder is at a head of the second gas compression cylinder and has a second hydraulic piston operatively connected to the piston rod to drive the piston rod in a second axial direction, the second axial direction opposite the first axial direction.

In an embodiment of the present disclosure, the multi-cylinder fluid compressor further comprises a first hydraulic piston seal device between the first hydraulic piston and the first hydraulic cylinder and a second hydraulic piston seal device between the second hydraulic piston and the second hydraulic cylinder.

In an embodiment of the present disclosure, the outlets of the first gas compression cylinder are in fluid communication with the inlets of the second gas compression cylinder to provide a multi-stage fluid compressor.

In an embodiment of the present disclosure, the multi-cylinder fluid compressor further comprises a cooler in fluid communication with the outlets of the first gas compression cylinder and the inlets of the second gas compression cylinder.

In an embodiment of the present disclosure, the multi-cylinder fluid compressor further comprises an outlet header fluidly connecting the outlets of the first gas compression cylinder and further comprising an inlet header fluidly connecting the inlets of the second gas compression cylinder, wherein the cooler is in fluid communication between the outlet header and the inlet header.

In an embodiment of the present disclosure, the cooler comprises a plate and frame oil cooler. In an embodiment of the present disclosure, the multi-cylinder fluid compressor further comprises a first buffer chamber, comprising a variable annular space between the common piston rod and the first hydraulic piston extending between the head of the first gas compression cylinder and the first hydraulic piston, and a second buffer chamber, comprising a variable annular space between the common piston rod and the second hydraulic piston extending between the head of the second gas compression cylinder and the second hydraulic piston.

In an embodiment of the present disclosure, the first buffer chamber and the second buffer chamber are pressurized, pressure equalized, vented, fluidly connected, or combinations thereof.

In an embodiment of the present disclosure, the inlets of the first and second gas compression cylinders are proximate a top of the first and second gas compression cylinders.

In an embodiment of the present disclosure, the outlets of the first and second gas compression cylinders are proximate a bottom of the first and second gas compression cylinders.

In an embodiment of the present disclosure, one or more of the inlets or the outlets or both of the first and second gas compression cylinders are radial.

In an embodiment of the present disclosure, one or more of the inlets or the outlets or both of the first and second gas compression cylinders are axial.

In an embodiment of the present disclosure, the multi-cylinder fluid compressor further comprises a variable volume pocket fluidly connected with at least one of the first, second, third, and fourth compression chambers.

In an embodiment of the present disclosure, wherein each of the inlets and the outlets of the first, second, third, and fourth compression chambers are in fluid communication with a one-way check valve.

In an embodiment of the present disclosure, the piston seal devices include one or more wear rings.

In an embodiment of the present disclosure, the multi-cylinder fluid compressor further comprises: a third gas compression cylinder, divided into fifth and sixth axially aligned compression chambers by a third reciprocating gas piston, each of the fifth and sixth compression chambers of the third gas compression cylinder having an inlet and an outlet; wherein the third gas compression cylinder is substantially axially aligned with the first gas compression cylinder and the second gas compression cylinder; wherein the third gas compression cylinder has a diameter less than the second gas compression cylinder; wherein the third gas compression cylinder and the second gas compression cylinder are axially aligned, and substantially adjacent; wherein a head of the second gas compression cylinder and a head of the third gas compression cylinder are axially connected; wherein the head of the third gas compression chamber provides an internal inlet flow passage extending between the inlet and the fifth compression chamber, and an internal outlet flow passage extending between the fifth compression chamber and the outlet, wherein the common piston rod is operably connected to the third reciprocating gas piston; wherein the outlets of the second gas compression cylinder are in fluid communication with the inlets of the third gas compression cylinder; a seal device between the common piston rod and the third gas compression cylinder; and a piston seal device between the third reciprocating gas piston and the third gas compression cylinder.

In an embodiment of the present disclosure, the multi-cylinder fluid compressor further comprises the hydraulic fluid supply system.

In an embodiment of the present disclosure, there is provided a method of recovering vapor from a tank containing liquid hydrocarbons, the method comprising: providing a multi-cylinder fluid compressor disclosed herein; conveying the vapor to the first gas compression cylinder; operating the multi-cylinder fluid compressor to increase pressure of the vapor to provide first stage pressurized vapor; cooling the first stage pressurized vapor to provide cooled first stage pressurized vapor; conveying the cooled first stage pressurized vapor to the second gas compression cylinder; and operating the multi-cylinder fluid compressor to increase pressure of the cooled first stage pressurized vapor to provide second stage pressurized vapor.

In an embodiment of the present disclosure, the method further comprises cooling the second stage pressurized vapor to provide cooled second stage pressurized vapor.

In an embodiment of the present disclosure, the method further comprises conveying the cooled second stage pressurized vapor to one or more of a makeup gas system, a vapor recovery unit, a sales gas pipeline, a storage vessel, and/or a flare.

In an embodiment of the present disclosure, operating the multi-cylinder fluid compressor comprises starting the operating, stopping the operating, setting a speed of the operating, setting a stroke of the operating, adjusting a speed of the operating, maintaining a speed of the operating, adjusting a stroke of the operating, maintaining a stroke of the operating, or any combinations thereof.

In an embodiment of the present disclosure, operating the multi-cylinder fluid compressor is responsive to pressure of the vapor in the tank. In an embodiment of the present disclosure, the pressure of the vapor in the tank is between about 0 oz/in² to about 4 oz/in².

In an embodiment of the present disclosure, there is provided a method of recovering vapor from a tank containing liquid hydrocarbons, the method comprising: providing a multi-cylinder fluid compressor as disclosed herein; conveying vapor to the first gas compression cylinder; operating the multi-cylinder fluid compressor to increase pressure of the vapor to provide first stage pressurized vapor; cooling the first stage pressurized vapor to provide cooled first stage pressurized vapor; conveying the cooled first stage pressurized vapor to the second gas compression cylinder; operating the multi-cylinder fluid compressor to increase pressure of the cooled pressurized vapor to provide second stage pressurized vapor; cooling the second stage pressurized vapor to provide cooled second stage pressurized vapor; conveying the cooled second stage pressurized vapor to the third gas compression cylinder; operating the multi-cylinder fluid compressor to increase pressure of the cooled second stage pressurized vapor to provide third stage pressurized vapor.

In an embodiment of the present disclosure, the method further comprises cooling the third stage pressurized vapor to provide cooled third stage pressurized vapor.

In an embodiment of the present disclosure, the method further comprises conveying the cooled third stage pressurized vapor to one or more of a makeup gas system, a vapor recovery unit, a sales gas pipeline, a storage vessel, and/or to a flare.

### BRIEF DESCRIPTION OF THE DRAWINGS

In drawings which illustrate embodiments, FIG. 1 is a high-level overview of a compressor shown compressing a working fluid from an oil well;

FIG. 2 is a schematic view of a system involving a compressor being used for vapor recovery on an oil tank according to an embodiment;

FIG. 3 is a schematic view of a system involving a compressor being used for vapor recovery on an oil tank according to another embodiment;

FIG. 4 is a cross-sectional view of a first embodiment of a multi-stage compressor;

FIG. 5 is a block diagram of a hydraulic fluid supply and control system of a compressor of the present disclosure;

FIG. 6 is a partially transparent perspective view of a multi-stage compressor according to a second embodiment;

FIG. 7 is a partially transparent perspective view of the compressor of FIG. 6;

FIG. 8 is a cross-sectional view of the compressor of FIG. 6, depicting a first embodiment of a working fluid communication system;

FIGS. 9A-9B are partially transparent perspective views of the compressor of FIG. 6, depicting a second embodiment of a working fluid communication system;

FIG. 10A is a partially transparent perspective view of a multi-stage compressor according to a third embodiment;

FIG. 10B is a cross-sectional view of the compressor of FIG. 10A;

FIG. 10C is a perspective view of the compressor of FIG. 10A;

FIG. 10D is another cross-sectional view of the compressor of FIG. 10A;

FIG. 10E is a top plan view of the compressor of FIG. 10A;

FIG. 10F is an end view of the compressor of FIG. 10A;

FIG. 11A is a perspective view of a piston rod section, housing and seal devices of the compressor of FIG. 10A;

FIG. 11B is a partially exploded view of the piston rod section, housing and seal devices of FIG. 11A;

FIG. 11C is a top plan view of the piston rod section and housing of FIG. 11A;

FIG. 11D is a side plan view of the piston rod section and housing of FIG. 11A;

FIG. 12 is a partially exploded view of a seal device of FIG. 11B;

FIGS. 13A-13B is a chart showing discharge pressure against volume for various single and multistage compressors;

FIG. 14 is a compression chart showing various parameters of multi-stage compressors of the present disclosure;

FIGS. 15A-15C is another compression chart showing various parameters of multi-stage compressors of the present disclosure;

FIG. 16A-16C is another compression chart showing various parameters of multi-stage compressors of the present disclosure;

FIG. 17 is a cross-sectional view of a further embodiment of a multi-stage compressor of the present disclosure;

FIG. 18 is a simplified perspective view of a further embodiment of a multi-stage compressor of the present disclosure;

FIG. 19 is a rotated view of the multi-stage compressor of FIG. 18;

FIG. 20 is a bottom perspective view of the multi-stage compressor of FIG. 18;

FIG. 21 is a side view of the multi-stage compressor of FIG. 18;

FIG. 22 is a side cross-sectional view of the multi-stage compressor of FIG. 18;

FIG. 23 is a partial detail view of the multi-stage compressor of FIG. 18;

FIG. 24 is a further partial detail view of the multi-stage compressor of FIG. 18;

FIG. 25 is a simplified enlarged view of axially connected gas cylinder heads of the present disclosure.

### DETAILED DESCRIPTION

### Oil and Gas Well System

Referring to FIG. 1, a common rod multi-stage compressor apparatus 126 is shown in use for drawing a working fluid comprising liquid and gas phase hydrocarbons from an oil and gas well system 100. The system may be installed at, a well shaft (also referred to as a well bore) 108 and may be used for extracting liquid and/or gases (e.g., oil and/or natural gas) from an oil and gas bearing reservoir 104. The working fluid may comprise a multiphase fluid comprising a gas and up to 5% by volume of liquid.

Extraction of liquids including oil and other liquids such as water from the reservoir 104 may be achieved by operation of a down-well pump 106 positioned at the bottom of the well shaft 108. For extracting oil from the reservoir 104, the down-well pump 106 may be operated by up-and-down reciprocating motion of a sucker rod 110 that extends through the well shaft 108 to and out of a well head 102. It should be noted that in some applications, the well shaft 108 may not be oriented entirely vertically but may have horizontal components and/or portions to its path.

The well shaft 108 may have along its length, one or more generally hollow cylindrical tubular, concentrically positioned, well casings 120a, 120b, 120c, including an inner-most production casing 120a that may extend for substantially the entire length of the well shaft 108. Intermediate casing 120b may extend concentrically outside of the production casing 120a for a substantial length of the well shaft 108, but not to the same depth as the production casing 120a. Surface casing 120c may extend concentrically around both the production casing 120a and the intermediate casing 120b but may only extend from proximate the surface of the ground level, down a relatively short distance of the well shaft 108. The casings 120a, 120b, 120c may be made from one or more suitable materials such as, for example, steel. Casings 120a, 120b, 120c may function to hold back the surrounding earth/other material in the sub-surface to maintain a generally cylindrical tubular channel through the sub-surface into the oil and (natural) gas bearing reservoir 104.

The casings 120a, 120b, 120c may each be secured and sealed by a respective outer cylindrical layer of material such as layers of concrete 111a, 111b, 111c, which may be formed to surround the casings 120a, 120b, 120c in concentric tubes that extend substantially along the length of the respective casing 120a, 120b, 120c. Production tubing 113 may be received inside the production casing 120a and may be generally of a constant diameter along its length and have an inner tubing passageway/annulus to facilitate the communication of liquids (e.g. oil) from the bottom region of the well shaft 108 to the surface region. The casings 120a, 120b, 120c generally, and the casing 120a in particular, can protect the production tubing 113 from corrosion and wear damage from use. Along with other components that constitute a production string, the production tubing 113 provides a continuous passageway, e.g. tubing annulus 107 from the region of the pump 106 within the reservoir 104 to the well head 102. The tubing annulus 107 provides a passageway for the sucker rod 110 to extend through and within which to move and provides a channel for the flow of liquid (oil) from the bottom region of the well shaft 108 to the region of the surface.

An annular casing passageway or gap (referred to herein as a casing annulus 121) is typically provided between the inward facing generally cylindrical surface of the production casing 120a and the outward facing generally cylindrical surface of the production tubing 113. The casing annulus 121 typically extends along the co-extensive length of the production casing 120a and the production tubing 113 and thus provides a passageway/channel that extends from the bottom region of the well shaft 108 proximate the oil and gas bearing reservoir 104 to the ground surface region proximate the top of the well shaft 108. Natural gas (that may be in liquid form in the reservoir 104) may flow from the reservoir 104 into the well shaft 108 and may be, or may transform into, a gaseous state and then flow upwards through the casing annulus 121 towards the well head 102. In some situations, such as where the well shaft 108 is newly formed, the level of the liquid (mainly oil and natural gas in solution) may actually extend a significant way from the bottom/end of the well shaft 108 to close to the surface in both the tubing annulus 107 and the casing annulus 121, due to relatively high downhole pressures.

The down-well pump 106 may have a plunger 103 that is attached to the bottom end region of the sucker rod 110 and the plunger 103 may be moved upwardly and downwardly within a pump chamber by the sucker rod 110. The down-well pump 106 may include a one-way travelling valve 112 which is a mobile check valve which is interconnected with the plunger 103 and which moves in an up and down reciprocating motion with the movement of the sucker rod 110. The down-well pump 106 may also include a one-way standing intake valve 114 that is stationary and attached to the bottom of the barrel of the pump 106/production tubing 113. The travelling valve 112 keeps the liquid (oil) in the tubing annulus 107 of the production tubing 113 during the upstroke of the sucker rod 110. The standing intake valve 114 keeps the fluid (oil) in the tubing annulus 107 of the production tubing 113 during the downstroke of the sucker rod 110. During a downstroke of the sucker rod 110 and the plunger 103, the travelling valve 112 opens, admitting liquid (oil) from the reservoir 104 into the annulus of the production tubing 113 of the down-well pump 106. During this downstroke, the one-way standing intake valve 114 at the bottom of the well shaft 108 is closed, preventing liquid (oil) from escaping.

During each upstroke of the sucker rod 110, the plunger 103 of the down-well pump 106 is drawn upwardly and the travelling valve 112 is closed. Thus, liquid (oil) drawn in through travelling valve 112 during the prior downstroke can be raised. As the standing intake valve 114 opens during the upstroke, liquid (oil) can enter the production tubing 113 below the plunger 103 through perforations 116 in the production casing 120a and the concrete layer 111a, and past the standing intake valve 114. Successive upstrokes of the down-well pump 106 form a column of liquid/oil in the well shaft 108 above the down-well pump 106. Once this column of liquid/oil is formed, each upstroke pushes a volume of oil toward the surface and the well head 102. The liquid/oil eventually reaches a T-junction device 140 which has connected thereto an oil flow line 133. The oil flow line 133 may contain a valve 138 that is configured to permit oil to flow only towards a T-junction interconnection 134 to be mixed with compressed natural gas from piping 130 that is delivered from the compressor apparatus 126 or 1126 and then together both flow away in a main oil/gas output flow line 132.

The sucker rod 110 may be actuated by a suitable lift system 118 that may, for example as illustrated schematically in FIG. 1, be a pump jack system 119 that may include a walking beam mechanism 117 driven by a pump jack drive mechanism 115, which may include a motor 123 that is powered, for example, by electricity or a supply of natural gas, such as, for example, natural gas produced by the oil and gas well system 100. The motor 123 may be interconnected to and drive a rotating counterweight 122 that may cause pivoting movement of the walking beam mechanism 117 that causes the reciprocating upward and downward movement of the sucker rod 110.

Natural gas exiting from the annulus 121 of the casing 120a may be fed by suitable piping 124 through a valve 128 to the interconnected compressor apparatus 126 or 1126. The piping 124 may be made of any suitable material(s) such as steel pipe or flexible hose such as Aeroquip FC 300 AOP elastomer tubing made by Eaton Aeroquip LLC. In normal operation of the system 100, the flow of natural gas communicated through the piping 124 to the compressor apparatus 126 is not restricted by the valve 128 and the working fluid, in this case natural gas, will flow therethrough. The valve 128 may be closed (e.g., manually) if for some reason it is desired to shut off the flow of working fluid from the annulus 121.

Pressurized working fluid that has been compressed by the compressor apparatus 126, 1126 may be conveyed via the piping 130 through a one-way check valve 131 to interconnect with the oil flow line 133 to form the combined oil and gas flow line 132 which can deliver the oil and gas therein to a location remote from the compressor apparatus for processing and/or use. The piping 130 may be made of any suitable material(s) such as steel pipe or flexible hose such as Aeroquip FC 300 AOP elastomer tubing made by Eaton Aeroquip LLC.

### Vapor Recovery Unit (VRU)

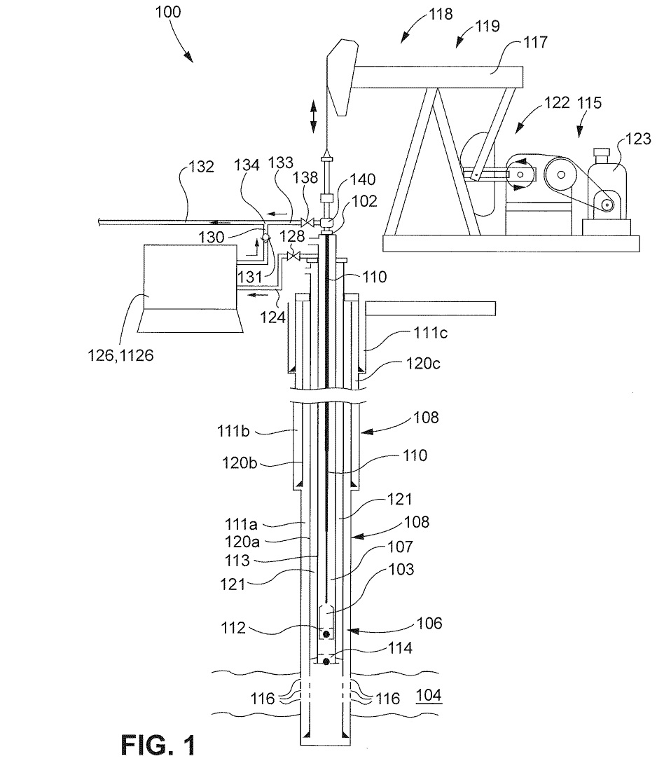

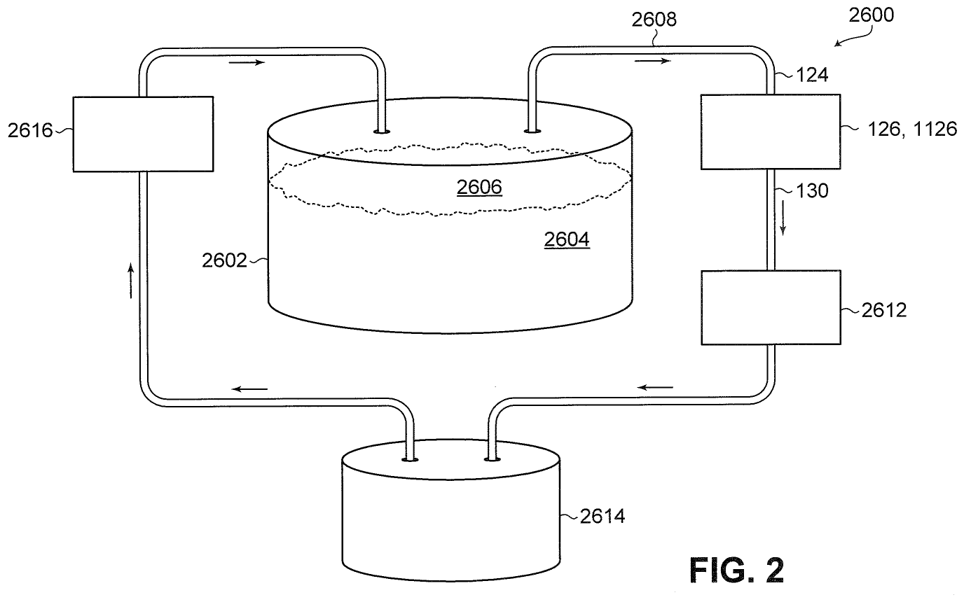

Referring to FIG. 2, the compressor apparatus 126, 1126 of any of the embodiments described herein can also or alternatively be used in a vapor recovery system 2600 for drawing gas that can accumulate above a volume of liquid hydrocarbon in a tank or vessel. The liquid hydrocarbon may be for example, a refined hydrocarbon containing material such as gasoline or kerosine or a partially or unrefined hydrocarbon containing material such as raw (unrefined or processed) oil and gas extracted from a well.

For example, when raw oil and gas extracted from a well is stored in a tank, some gas may be trapped in the liquid phase of the material. This may include light hydrocarbons, such as methane and other volatile organic compounds (VOCs), natural gas liquids (NGLs) such as ethane, propane, butane, isobutane, hazardous air pollutants (such as benzene, toluene ethyl-benzene, and xylene) and natural inert gases (such as nitrogen and carbon dioxide) that are dissolved in the liquid phase. Over time, some of these light hydrocarbons may vaporize or “flash out” of the liquid phase for example due to temperature changes, agitation of the contents of the tank or due to variation in the liquid level of the tank. Also, as the tank heats up due to environmental conditions, for example, the gas and liquid expands, which increases the pressure in the tank. Generally, such tanks are rated to withstand 1 psi gauge pressure before failure. Conventionally, such tanks have makeup systems where when fluid is pumped out of the tank, a replacement gas such as methane is admitted into the tank to keep oxygen out to guard against creating an explosive or combustible environment. Often, pressure increases and decreases in such tanks are addressed by venting into the atmosphere or by the use of a flare stack. Venting into the atmosphere presents environmental challenges and the use of a flare stack means burning off a portion of the revenue available from the contents of the tank.

In the system shown in FIG. 2, a vapor recovery system 2600 in relation to an oil tank 2602. The system includes an oil tank 2602 holding a volume of oil 2604 and a headspace 2606 above a surface of the oil 2604. Gasses trapped in the oil rise to the headspace 2606 and increase the gas pressure inside the oil tank 2602.

A vent hose 2608 is in fluid communication with the headspace 2606 at the top of the oil tank 2602 and is also in fluid communication with compressor apparatus 126, 1126 disclosed herein. The compressor apparatus 126, 1126 is configured to automatically turn on when the pressure in the oil tank 2602 exceeds about 0.1 psi gauge, for example, and to shut off when the pressure is about 0 psi gauge, for example.

When the compressor apparatus 126, 1126 is turned on, it effectively pumps gasses from the headspace 2606 at the top of the oil tank 2602, thereby reducing the gas pressure inside the tank. The pressurized working fluid discharged by the compressor apparatus 126, 1126 may be passed through a scrubber 2612 to remove select impurities and/or cooling fluid present in the discharged pressurized working fluid. The scrubbed gas from the scrubber 2612 may be passed to a clean gas tank or vessel 2614 to be held along with clean gas, such as methane from any source.

The pressurized working fluid discharged by the compressor apparatus 126, 1126 may include a mixture of gas and condensed liquid. A pump 2616 pumps at least some of the clean gas, and the scrubbed gas from the scrubber 2612 held in the clean gas tank 2614, into the oil tank 2602 to replace the gas extracted from that oil tank 2602 by the compressor 126, 1126, and to fill any increased headspace 2606 in the oil tank 2602 with oxygen free gas to maintain the pressure in the oil tank 2602 within design limits (for example to avoid a negative pressure developing within the tank) and to keep oxygen, e.g. in air, from entering the oil tank 2602.

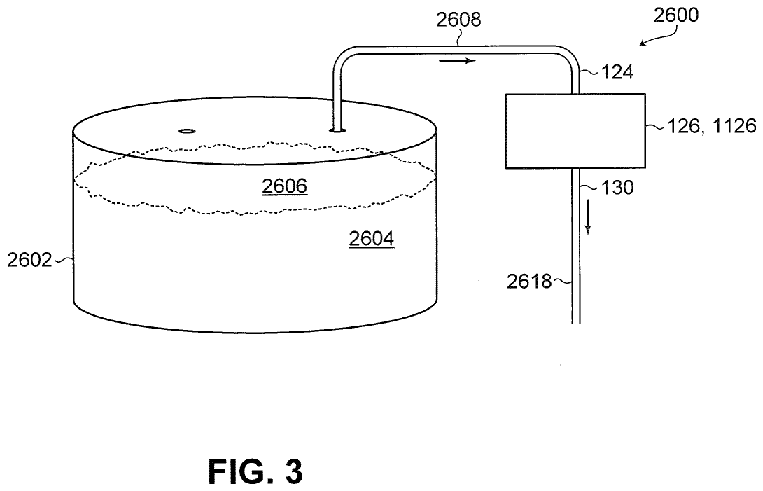

With reference to FIG. 3, another embodiment of the compressor apparatus 126, 1126 in a vapor recovery system 2600 is depicted. In this embodiment, the pressurized working fluid discharged by the compressor apparatus 126, 1126 via piping 130 may instead be transported via piping 2618 for further use or disposal. For example, the pressurized working fluid may be used for, gas lift, gas injection, used as a fuel for onsite operations or be piped to a natural gas pipeline for further processing/sale. In other embodiments, the pressurized working fluid discharged by the compressor 126, 1126 may be conveyed to a suitable disposal well.

The above are simplified examples of a vapor recovery system 2600, and in some embodiments one or more of control valves, control systems, and liquid/vapor separators, compressors, pumps, and recycle, bypass, and return lines may be provided upstream and/or downstream of compressor apparatus 126, 1126, but are not shown for simplicity.

### First Embodiment: Multi-Stage Compressor

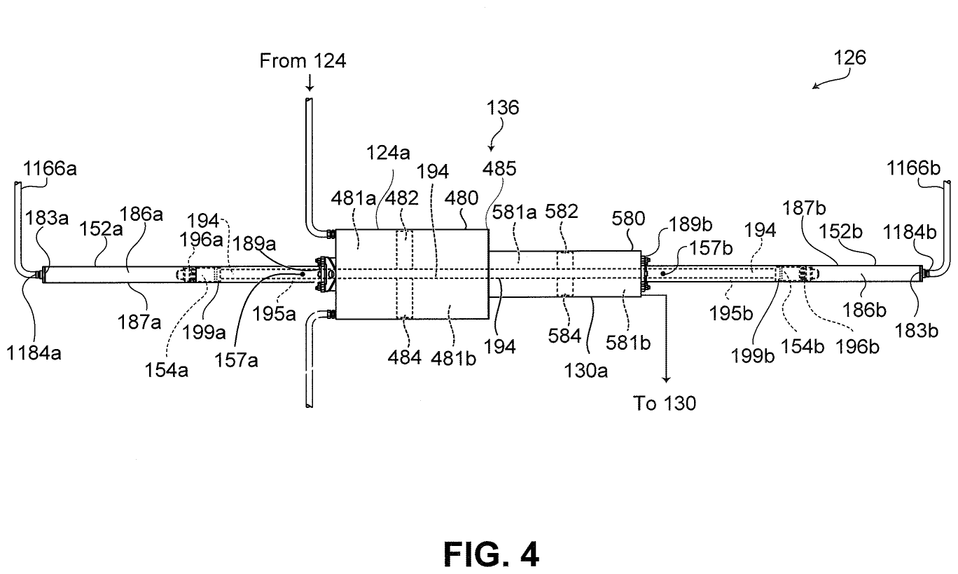

Referring to FIG. 4, the compressor apparatus 126 according to a first embodiment is shown in more detail. The compressor apparatus 126 has general applications for pressurizing a working fluid comprising a gas and/or a mixture of gas and liquid, such as oil and gas, but may be used for compressing other gases or other multiphase mixtures.

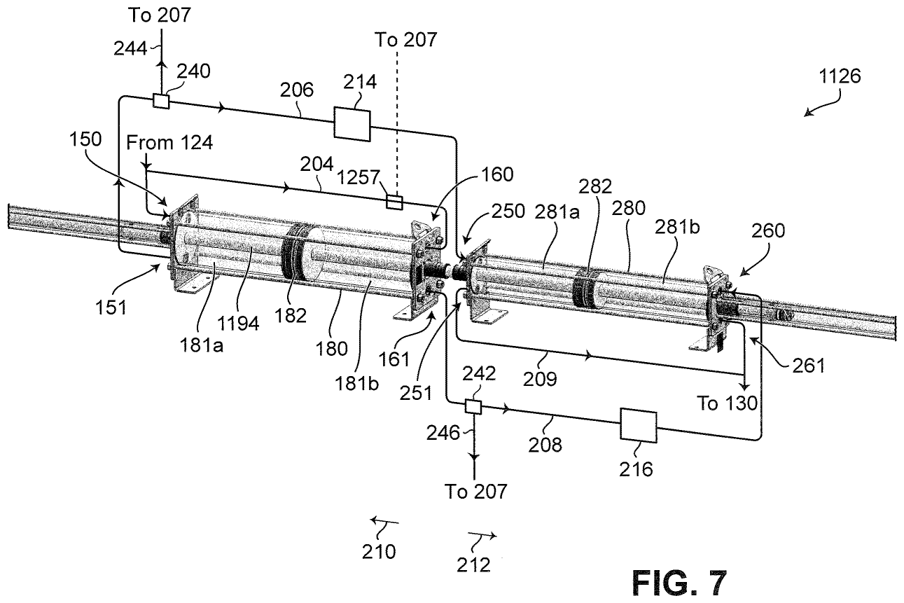

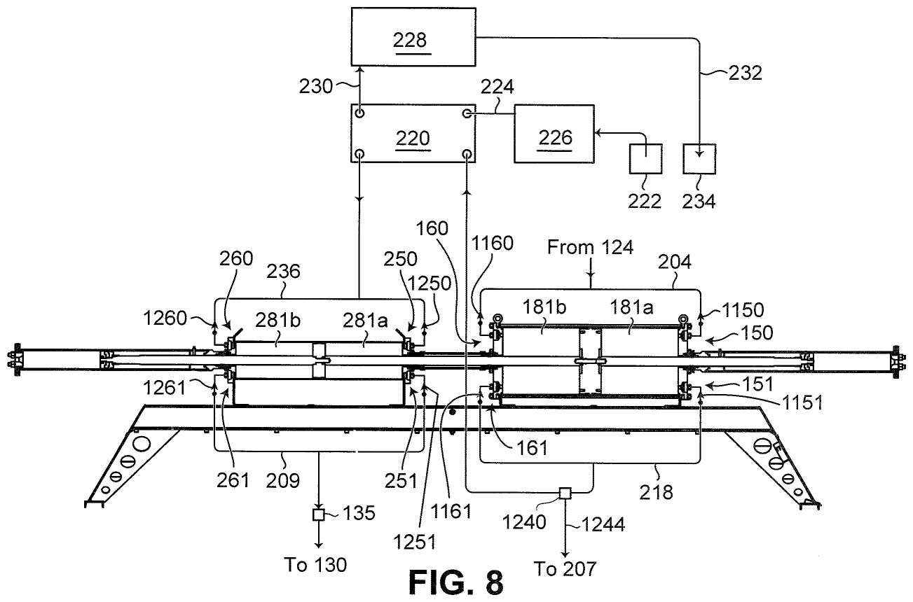

The compressor apparatus 126 comprises a gas compressor portion 136 configured to receive a supply of working fluid, e.g. from piping 124 (FIGS. 1-3) or other supply, and compress the working fluid and discharge the pressurized working fluid to piping 130. In this FIG. 4, to not obscure other details, a single inlet from piping 124, in relation to first compression chamber 481a of first gas compression cylinder 480, and a single outlet to piping 130, in relation to fourth compression chamber 581b of second gas compression cylinder 580 are shown. Additional inlets/outlets to first gas compression cylinder 480 and second gas compression cylinder 580 are provided and illustrated in other FIGS., e.g. FIGS. 7, 8 etc.

In an embodiment disclosed, inlets from piping 124 are proximate a top of the first gas compression cylinder 480 and/or the second gas compression cylinder 580. In an embodiment disclosed, the inlets are at or on the top of the first gas compression cylinder 480 and/or the second gas compression cylinder 580. In an embodiment disclosed, outlets to piping 130 are proximate a bottom of the first gas compression cylinder 480 and/or the second gas compression cylinder 580. In an embodiment disclosed, the outlets are at or on the bottom of the first gas compression cylinder 480 and/or the second gas compression cylinder 580. In some embodiments, a bottom outlet may help, for example with liquids and/or contaminant handling, as liquids and/or contaminants in or from the working fluid may more readily drain from the gas compression cylinder, for example to piping 130. A small amount of liquid may occur, for example when compressor apparatus 126 is used with a vapor recovery system 2600, for example when the working fluid is compressed and cooled, as a portion of working fluid in vapor may condense into liquid temporarily and/or the working fluid may contain liquids, for example liquid water.

The working fluid in a system for vapor recovery may include water and dirty wet gas and other fluids. One option is to use a screw compressor with lubricating oil, which may require exotic lubricating oil and frequent maintenance, e.g. bi-weekly. Use of a compressor apparatus 126 of the present disclosure negates the need for exotic lubricating oil and provides reduced maintenance requirements. In addition, a screw compressor may be operated continuously on recycle. Use of a compressor apparatus 126 of the present disclosure, in an on-off operation, uses less energy, for example 30-50% reduction in electrical energy.

Compressor apparatus 126 includes first and second one-way acting hydraulic cylinders 152a, 152b positioned at opposite ends of the compressor apparatus 126. The cylinders 152a, 152b are each configured to provide respective driving forces that act in opposite directions to each other, both acting inwardly towards each other and towards gas compressor portion 136 positioned generally inwardly between the hydraulic cylinders 152a, 152b.

Gas compressor portion 136 comprises a plurality of gas compression cylinders, each connected in series. Each gas compression cylinder (or “stage”) may be configured to receive a supply of working fluid, compress the working fluid and discharge the working fluid to the next compression cylinder.

In some embodiments, compressor apparatus 126 may be configured as a multi-stage common rod compressor, wherein each gas compression cylinder of the plurality of gas compression cylinders is connected in series, such that the fluid from the first compression cylinder is compressed in the first gas compression cylinder 480 and the compressed working fluid is discharged to the next stage (next gas compression cylinder), e.g. second gas compression cylinder 580 and so on in the plurality of gas compression cylinders.

In other embodiments, compressor apparatus 126 may be configured as a multi-cylinder common rod compressor, wherein each gas compression cylinder of the plurality of gas compression cylinders are configured in a parallel arrangement, whereby each gas compression cylinder receives a portion of a supply of working fluid from a common supply conduit, e.g. piping 124 and compress the working fluid and discharges the compressed working fluid to a common discharge conduit.

In some embodiments, more than one of such multi-cylinder common rod compressors may be connected in series, for multi-stage compression of the working fluid.

Gas compressor portion 136 may comprise any suitable number of gas compression cylinders, for example two, three, four, five, six or more gas compression cylinders. The number of gas compression cylinders may be selected based on one or more factors such as the pressure of the working fluid being supplied to compressor 126, the desired pressure of the working fluid to be discharged by compressor 126, a selected temperature of the working fluid to be discharged by compressor 126 or combinations thereof.

As will be explained in more detail below, each of the gas compression cylinders of gas compressor portion 136 may be divided into first and second axially aligned compression chambers by a reciprocating gas piston. Accordingly, working fluid in each of the compression chambers may be alternately compressed by alternating inwardly directed driving forces of the hydraulic cylinders 152a, 152b driving reciprocal movement of the reciprocating piston which are interconnected to a piston rod 194.

Each of the plurality of gas compression cylinders of the gas compression cylinders 480, 580 and the hydraulic cylinders 152a, 152b may have generally circular interior cross sections, although alternately shaped cross sections are possible in some embodiments.

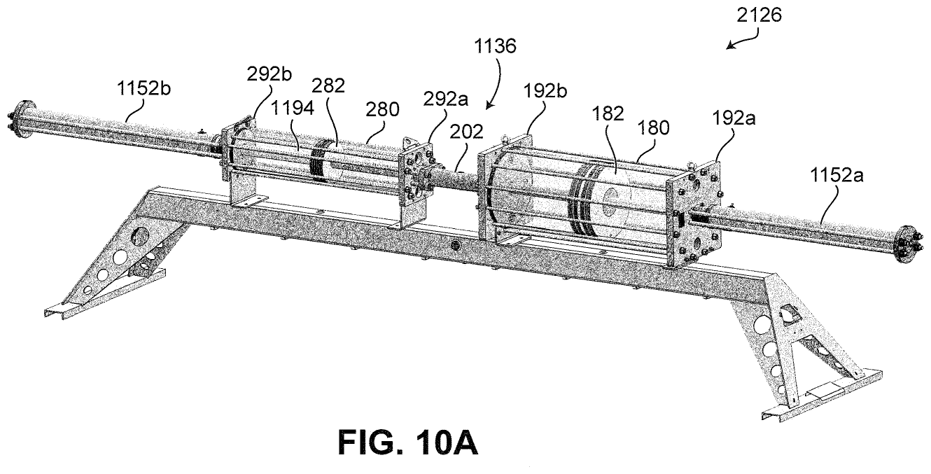

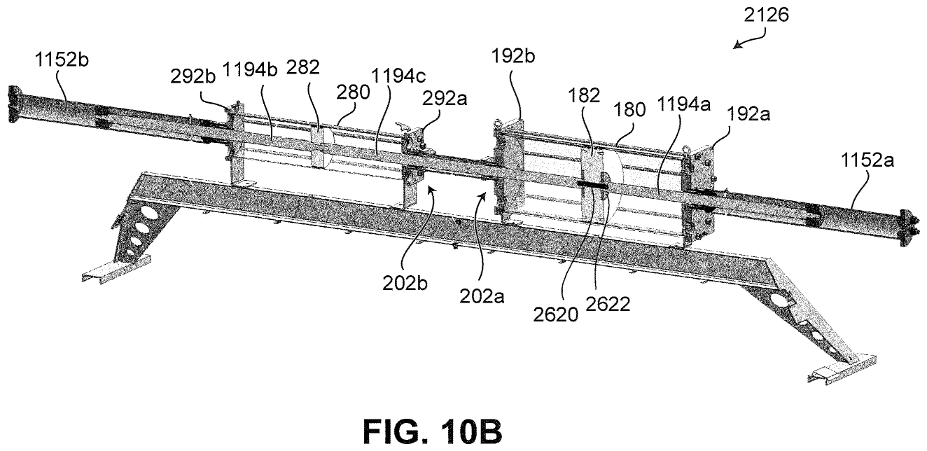

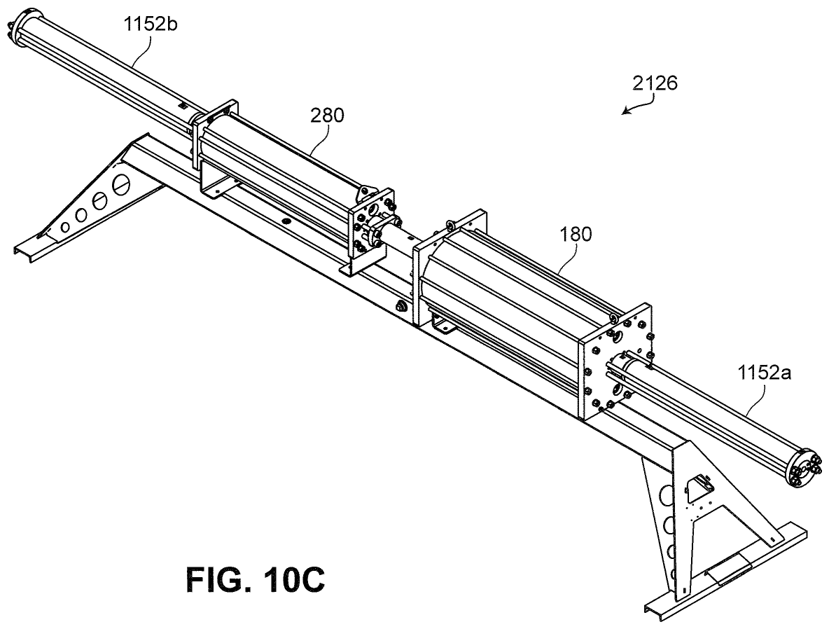

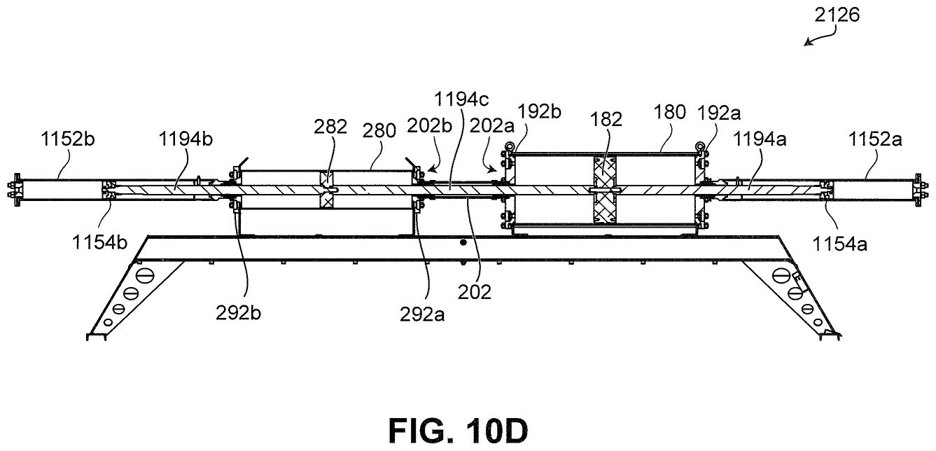

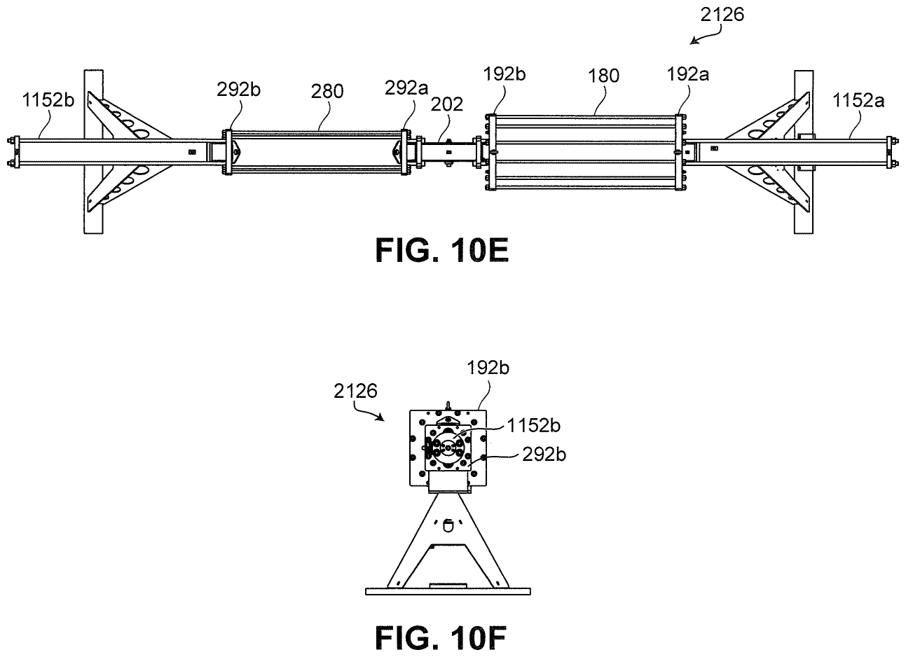

Inlets/outlets may be into the cylinder head, see e.g. FIG. 10A first/second gas cylinder head 192a/192b, 292a/292b. In an embodiment disclosed, the inlets and/or outlets may be generally axial, substantially axial, or axial. In an embodiment disclosed, the inlets and/or outlets may be into the compression cylinder, see e.g. FIG. 4, inlet from piping 124 enters a top side 124a of the first gas compression cylinder 480, and outlet to piping 130 exits a bottom side 130a of the second gas compression cylinder 580. In an embodiment disclosed, the inlets and/or outlets may be generally radial, substantially radial, or radial.

First gas compression cylinder 480 and second compression cylinder 580 may be axially spaced apart, e.g. having a gap, e.g. as in FIG. 7 or having a housing, e. g, 202 as in FIG. 10A. In an embodiment disclosed, connector plate 485 may be used, with the gas compression cylinders in close proximity. In such embodiment, radial inlets/outlets may be used, as there is less or insufficient space for axial inlets/outlets. In an embodiment disclosed, connector plate 485 may be ported, having one or more flow passages extending from an outer edge of the connector plate, through the connector plate, and into the respective compression cylinder. In an embodiment disclosed, the connector plate 485 may have four flow passages, one for each of the two inlets and two outlets, e.g. when first gas cylinder 480 and second gas compression cylinder each abut the connector plate 485, e.g. as in FIG. 4. In an embodiment disclosed, connector plate 485 may have four ports, radially, axially, or otherwise spaced apart, to allow room for porting and/or check-valve and/or piping connections.

In the embodiment shown in FIG. 4, gas compressor portion 136 comprises a first gas compression cylinder 480 and a second gas compression cylinder 580. The first gas compression cylinder 480 is divided into the first and second compression chambers 481a, 481b by a first reciprocating piston 482. The second gas compression cylinder 580 is divided into the third and fourth compression chambers 581a, 581b by a second reciprocating piston 582.

First gas compression cylinder 480 is configured to receive a supply of working fluid, compress the working fluid and discharge the compressed working fluid to second gas compression cylinder 580. Second gas compression cylinder 580 is configured to compress the working fluid received from first gas compression cylinder 480 and discharge the compressed working fluid.

### First Hydraulic Cylinder

The hydraulic cylinder 152a has a hydraulic cylinder base 183a at an outer end thereof. A first hydraulic fluid chamber 186a is thus formed between a cylinder barrel/tubular wall 187a, the hydraulic cylinder base 183a, and a hydraulic piston 154a. The hydraulic cylinder base 183a has a hydraulic input/output fluid connector 1184a that is adapted for connection to a hydraulic fluid communication line 1166a. Thus, through the hydraulic fluid communication line 1166a and the hydraulic input/output fluid connector 1184a, hydraulic fluid can be communicated into and out of the first hydraulic fluid chamber 186a.

### Second Hydraulic Cylinder

At the opposite end of the gas compressor apparatus 126, there is a similar arrangement. The hydraulic cylinder 152b has a hydraulic cylinder base 183b at an outer end thereof. A second hydraulic fluid chamber 186b is thus formed between a cylinder barrel/tubular wall 187b, the hydraulic cylinder base 183b, and a hydraulic piston 154b. The hydraulic cylinder base 183b has an input/output fluid connector 1184b that is adapted for connection to a hydraulic fluid communication line 1166b. Thus, through the hydraulic fluid communication line 1166b and the hydraulic input/output fluid connector 1184b, hydraulic fluid can be communicated into and out of the second hydraulic fluid chamber 186b.

### Hydraulic Connections

In the embodiment shown in FIG. 4, input/output fluid connector 1184a, 1184b are each connected to the hydraulic fluid communication lines 1166a, 1166b, respectively, that may, depending upon the operational configuration of the system, either be communicating hydraulic fluid to, or communicating hydraulic fluid away from, a respective one of the hydraulic fluid chamber 186a and the hydraulic fluid chamber 186b. However, in alternative embodiments, other configurations for communicating hydraulic fluid to and from the hydraulic fluid chambers 186a, 186b are possible.

### Seals

The hydraulic pistons 154a, 154b also have seal devices 196a, 196b respectively at their outer circumferential surface areas to provide fluid/gas seals with the inner wall surfaces of the hydraulic cylinder barrels 187a, 187b respectively. The seal devices 196a, 196b, may substantially prevent or inhibit movement of hydraulic fluid out of the hydraulic fluid chambers 186a, 186b during operation of the compressor apparatus 126 and may prevent or at least inhibit the migration of any gas/liquid that may be in respective adjacent buffer chambers 195a, 195b (as described further hereafter) into the hydraulic fluid chambers 186a, 186b.

The hydraulic piston seal devices 196a, 196b may include one or more polymer, for example a synthetic polymer. In an embodiment disclosed, seal devices 196a, 196b may include one or more seal rings, and one or more energizer for the one or more seal rings. In an embodiment disclosed, seal devices 196a, 196b include a plurality of polytetrafluoroethylene (PTFE) (e.g., Teflon™) seal rings and may also include Hydrogenated Nitrile Butadiene Rubber (HNBR) energizers/energizing rings for the seal rings.

First and second reciprocating pistons 482, 582 may include piston seal devices 484, 584 respectively, to provide a seal with the inner wall surfaces of gas compression cylinders 480, 580 to substantially prevent or inhibit movement of fluid such as various mixtures/ratios of natural gas, oil, water, and possibly additional components associated with the natural gas and oil, between first and second compression chambers 481a, 481b and between third and fourth compression chambers 581a, 581b. Piston seal devices 484, 584 may also assist in maintaining pressure differences between the adjacent compressor chambers during operation of compressor apparatus 126.

In an embodiment disclosed, piston seal devices 484, 584 may include one or more wear rings, e.g. PTFE wear rings, one or more seals, e.g. PTFE seals and/or combinations thereof. In an embodiment disclosed, the one or more wear rings provide lateral support, e.g. vertical support, to support and/or guide the reciprocating pistons and/or centralize the reciprocating pistons in the respective cylinder. This may serve to reduce wear and/or improve seal life and sealing effectiveness.

### First and Second Buffer Chambers

Located on the inward side of the hydraulic piston 154a, within the hydraulic cylinder barrel 187a, is the first buffer chamber 195a. The buffer chamber 195a is defined by an inner surface of the hydraulic piston 154a, the cylindrical inner wall surface of the hydraulic cylinder barrel 187a, and a hydraulic cylinder head 189a.

Similarly, located on the inward side of the hydraulic piston 154b, within the hydraulic cylinder barrel 187b, is the second buffer chamber 195b. The second buffer chamber 195b is defined by an inner surface of the hydraulic piston 154b, the cylindrical inner wall surface of the hydraulic cylinder barrel 187b, and a hydraulic cylinder head 189b.

As the hydraulic pistons 154a, 154b are mounted at opposite ends of the piston rod 194, the piston rod 194 passes through the buffer chambers 195a, 195b, which isolates working fluid from hydraulic fluid in compressor apparatus 126.

It is possible that small amounts of working fluid, and/or other components such as hydrogen sulphide, water, oil may still at least in some circumstances be able to travel into the respective buffer chambers 195a, 195b. For example, oil may be adhered to the surface of the piston rod 194 and during reciprocating movement of the piston rod 194, it may carry such other components from the compressor portion 136 and into areas of the respective hydraulic cylinder barrels 187a, 187b that provide the respective buffer chambers 195a, 195b. High temperatures that typically occur within compressor portion 136 may increase the risk of contaminants being able to pass into buffer chambers 195a, 195b. However, the buffer chambers 195a, 195b each provide an area that may tend to hold any contaminants that move from the compressor portion 136 and restrict the movement of such contaminants into the areas of cylinder barrels that provide the hydraulic cylinder fluid chambers 186a, 186b.

During operation of compressor apparatus 126, hydraulic fluid is in contact with hydraulic pistons 154a, 154b and the inner wall surfaces of the hydraulic cylinder barrels 187a, 187b respectively and working fluid is in contact with piston rod 194. As the inner wall surfaces of the hydraulic cylinder barrels 187a, 187b and piston rod 194 never mechanically touch, working fluid is isolated from hydraulic fluid and vice-versa.

In some embodiments, pressure in buffer chambers 195a, 195b is equalized and/or vented, for example to avoid a pressure and/or vacuum forming in buffer chambers 195a, 195b. In some embodiments, buffer chambers 195a, 195b may be hydraulically connected to one-another, directly and/or indirectly. In some embodiments, buffer chambers 195a, 195b may be hydraulically connected to a holding tank to allow for drainage of any liquids that may have accumulated in each of buffer chambers 195a, 195b.

### Position Sensors

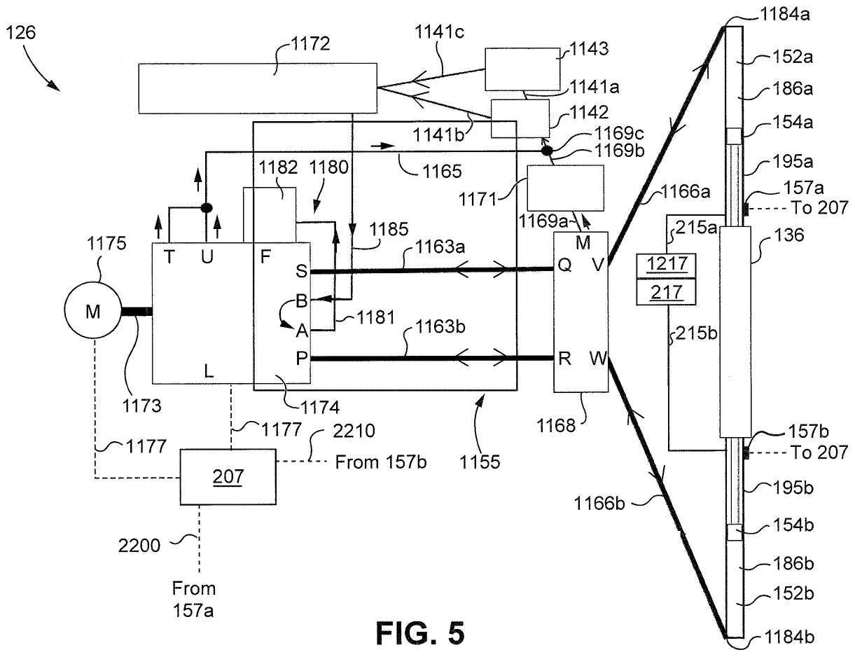

Referring to FIG. 4, mounted on and extending within the cylinder barrel 187a close to the hydraulic cylinder head 189a, is a first position sensor 157a. The first position sensor 157a is operable such that during operation of the compressor apparatus 126, as the piston 154a is moving from left to right, just before the piston 154a reaches the far right end of the cylinder barrel 187a (as viewed in FIG. 4), the first position sensor 157a will detect the presence of the hydraulic piston 154a within the hydraulic cylinder 152a at a longitudinal position that is shortly before the end of the stroke. The position sensor 157a sends a first position signal to a controller 207 (e.g. shown in FIG. 5), in response to which the controller 207 can take steps to change the operational mode of a hydraulic fluid supply system 1155.

Similarly, mounted on and extending within the cylinder barrel 187b close to the hydraulic cylinder head 189b, is a second position sensor 157b. The second position sensor 157b is operable such that during operation of the gas compressor apparatus 126, as the piston 154b is moving from right to left, just before the piston 154b reaches the far right end of the cylinder barrel 187b (as viewed in FIG. 4), the second position sensor 157b detects the presence of the hydraulic piston 154b within the hydraulic cylinder 152b at a longitudinal position that is shortly before the end of the stroke. The second position sensor 157b will then send a second position signal to controller 207, in response to which controller 207 can take steps to change the operational mode of the hydraulic fluid supply system 1155.

The first and second position sensors 157a, 157b are in communication with the controller 207. In some embodiments, the first and second position sensors 157a, 157b may be implemented using inductive proximity sensors, such as model BI-2-M12-Y1X-H1141 sensors manufactured by Turck, Inc. These inductive sensors are operable to generate position signals responsive to the proximity of a metal portion operably associated with the piston rod 194 proximate to the hydraulic pistons 154a, 154b. For example, sensor rings such as annular collars 199a, 199b (see FIG. 4) may be attached around the piston rod 194 at suitable positions towards, but spaced apart from, the hydraulic pistons 154a, 154b, respectively. The first and second position sensors 157a, 157b shown in FIG. 4 may detect when the collars 199a, 199b, respectively, on the piston rod 194 pass by. The annular collars 199a, 199b may be made of steel, may be mounted to the piston rod 194, and may be held on the piston rod 194 with set screws and an adhesive such as LOCTITE™ made by Henkel Corporation.

### Hydraulic System

Referring to FIG. 5, the controller 207 includes a microprocessor, or programmable controller or the like, programmed to control the hydraulic fluid supply system 1155 to provide for a relatively smooth slowing down, a stop, reversal in direction and speeding up of the piston rod 194 along with the hydraulic pistons 154a, 154b and interconnected reciprocating pistons of each of the gas compression cylinders as the piston rod 194, hydraulic pistons 154a, 154b and reciprocating pistons go through a cycle of movement involving movement of the hydraulic pistons 154a, 154b to the left in FIG. 4, followed by movement of the hydraulic pistons 154a, 154b to the right in FIG. 4, and then repeating the cycle. In some embodiments, controller 207 may comprise a programmable logic controller (PLC).

In the embodiment shown, the hydraulic fluid supply 1155 is a closed loop system and includes a pump unit 1174, the hydraulic fluid communication lines 1163a, 1163b, 1166a, 1166b, and a hot oil shuttle valve 1168. The shuttle valve 1168 may be, for example, a hot oil shuttle valve made by Sun Hydraulics Corporation under model XRDCLNN-AL.

The fluid communication line 1163a fluidly connects a port S of the pump unit 1174 to a port Q of the shuttle valve 1168. The fluid communication line 1163b fluidly connects a port P of the pump unit 1174 to a port R of the shuttle valve 1168. The fluid communication line 1166a fluidly connects a port V of the shuttle valve 1168 to the input/output fluid connector 1184a of the hydraulic cylinder 152a. The fluid communication line 1166b fluidly connects a port W of the shuttle valve 1168 to the input/output fluid connector 1184b of the hydraulic cylinder 152b. An output port M of the shuttle valve 1168 may be connected to an upstream end of a bypass fluid communication line 1169 having a first portion 1169a, a second portion 1169b, and a third portion 1169c that are arranged in series. A filter 1171 may be interposed in the bypass line 1169 between the portions 1169a and 1169b. The filter 1171 may be operable to remove contaminants from hydraulic fluid flowing from the shuttle valve 1168 before it is returned to a reservoir 1172. The filter 1171 may, for example, include a type HMK05/25 5 micro-meter filter made by Donaldson Company, Inc. A downstream end of the line portion 1169b joins with the upstream end of the line portion 1169c at a T-junction where a downstream end of a pump case drain line 1165 is also fluidly connected. The case drain line 1165 may drain hydraulic fluid leaking within the pump unit 1174. The fluid communication line portion 1169c is connected at an opposite end to an input port of a thermal valve 1142. Depending upon the temperature of the hydraulic fluid flowing into the thermal valve 1142 from the communication line portion 1169c of the bypass fluid communication line 1169, the thermal valve 1142 directs the hydraulic fluid to either a fluid communication line 1141a, or a fluid communication line 1141b. If the temperature of the hydraulic fluid flowing into the thermal valve device 1142 is greater than a set threshold level, the valve device 1142 directs the hydraulic fluid through the fluid communication line 1141 a to a cooler 1143 where the hydraulic fluid can be cooled before being passed through a fluid communication line 1141c to the reservoir 1172. If the hydraulic fluid entering the fluid valve 1142 does not require cooling, then the thermal valve 1142 directs the hydraulic fluid received therein from the communication line portion 1169c to the communication line 1141b which leads directly to the reservoir 1172. An example of a suitable thermal valve 1142 is a model 67365-110F made by TTP (formerly Thermal Transfer Products). An example of a suitable cooler 1143 is a model BOL-16-216943 also made by TTP.

The drain line 1165 connects output case drain ports U and T of the pump unit 1174 to a T-connection in the communication line 1169b at a location after the filter 1171. Thus, any hydraulic fluid directed out of the case drain ports U/T of the pump unit 1174 can pass through the drain line 1165 to the T-connection of the communication line portions 1169b, 1169c, (without going through the filter device 1171) where it can mix with any hydraulic fluid flowing from the filter 1171 and then flow to the thermal valve 1142 where it can be directed to either the cooler 1143 before flowing to the reservoir 1172 or directly to the reservoir 1172. By not passing hydraulic fluid from the case drain line 1165 through the relatively fine filter 1171, the risk of the filter 1171 being clogged can be reduced. An additional filter 1182 provides a secondary filter for fluid that is re-charging the pump unit 1174 from the reservoir 1172.

The reservoir 1172 holds any suitable driving fluid, which may be any suitable hydraulic fluid that is suitable for driving the hydraulic cylinders 152a, 152b.

The cooler 1143 may be operable to maintain the hydraulic fluid within a desired temperature range, thus maintaining a desired viscosity. For example, in some embodiments, the cooler 1143 may be operable to cool the hydraulic fluid when the temperature of the hydraulic fluid goes above about 50° C., and to stop cooling when the temperature falls below about 45° C. In some applications, such as where the ambient temperature of the environment can become very cold, the cooler 1143 may be a combined heater and cooler and may further be operable to heat the hydraulic fluid when the temperature goes below, for example, about −10° C. The hydraulic fluid may be selected to maintain a viscosity in the hydraulic fluid supply system 1155 of generally between about 20 and about 40 mm²s⁻¹ over this temperature range.

### Ports S & P

The hydraulic pump 1174 includes outlet ports S and P for selectively and alternately delivering a pressurized flow of hydraulic fluid to the hydraulic fluid communication lines 1163a and 1163b respectively, and for allowing hydraulic fluid to be returned to the pump unit 1174 at the ports S and P. Thus, the hydraulic fluid supply system 1155 is part of a closed loop hydraulic circuit, except to the extent described hereinafter. The pump unit 1174 may be implemented using a variable-displacement hydraulic pump capable of producing a controlled flow hydraulic fluid alternately at the outlets S and P. In one embodiment, the pump unit 1174 may be an axial piston pump having a swashplate that is configurable at a varying angle a. For example, the pump unit 1174 may be an HPV-02 variable pump manufactured by Linde Hydraulics GmbH & Co. KG of Germany, a model that is operable to deliver displacement of hydraulic fluid of up to about 55 cubic centimeters per revolution at pressures in the range of 58-145 psi. In other embodiments, the pump unit 1174 may be another suitable variable displacement pump, such as a variable piston pump or a rotary vane pump, for example. For the Linde HPV-02 variable pump, the angle a of the swashplate may be adjusted from a maximum negative angle of about −21°, which may correspond to a maximum flow rate condition at the outlet S, to about 0°, corresponding to a substantially no flow condition from either port S or P, and a maximum positive angle of about +21°, which corresponds to a 100% maximum flow rate condition at the outlet P.

In the embodiment shown, the pump unit 1174 includes an electrical input for receiving a displacement control signal 1177 from the controller 207. The displacement control signal 1177 is operable to drive a coil of a solenoid (not shown) for controlling the displacement of the pump unit 1174 and thus controls a hydraulic fluid flow rate produced alternately at the outlets P and S. The electrical input is connected to a 24 VDC coil within the hydraulic pump unit 1174, which is actuated in response to a controlled pulse width modulated (PWM) excitation current of between about 232 mA (i₀ᵤ) for a no flow condition and about 425 mA (iᵤ) for a maximum flow condition.

For the Linde HPV-02 variable pump unit 1174, the swashplate is actuated to move to an angle a either +21° or −21°, only when a signal is received from controller 207. Controller 207 will provide such a signal to the pump unit 1174 based on the positions of the hydraulic pistons 154a, 154b as detected by the position sensors 157a, 157b as described above, which provide signals to the controller 207 when the respective piston 482, 582 is approaching the end of a compression stroke in one direction, and commencement of a compression stroke in the opposite direction.

The pump unit 1174 may also be part of a fluid charge system 1180 operable to maintain sufficient hydraulic fluid within the pump unit 1174 and may maintain/hold a fluid pressure of, for example, at least 300 psi at both ports S and P so as to be able to control and maintain the operation of the main pump so that it can function to supply a flow of hydraulic fluid under pressure alternately at ports S and P.

### Charge Pump

The fluid charge system 1180 may include a charge pump that may include a 16-cc charge pump supplying for example 6-7 gpm (gallons per minute). The fluid charge system 1180 functions to supply hydraulic fluid as may be required by the pump unit 1174, to replace any hydraulic fluid that may be directed from the port M of the shuttle valve 1168 through a relief valve associated with the shuttle valve 1168 to the reservoir 1172 and to address any internal hydraulic fluid leakage associated with the pump unit 1174. The shuttle valve 1168 may, for example, redirect in the range of 3-4 gpm from the hydraulic fluid circuit. The charge pump will then replace the redirected hydraulic fluid 1:1 by maintaining a low side loop pressure.

The relief valve associated with the shuttle valve 1168 will typically only divert to the port M a very small proportion of the total amount of hydraulic fluid circulating in the fluid circuit and which passes through the shuttle valve 1168 into and out of the hydraulic cylinders 152a, 152b. For example, the relief valve associated with the shuttle valve may only divert approximately 3 to 4 gallons per minute of hydraulic fluid at 200 psi, accounting, for example, for only about 1% of the hydraulic fluid in the substantially closed loop hydraulic fluid circuit. This allows at least a portion of the hydraulic fluid being circulated to the gas compressor apparatus 126 on each cycle to be cooled and filtered.

The charge pump may draw hydraulic fluid from the reservoir 1172 on a fluid communication line 1185 that connects the reservoir 1172 with an input port B of the pump unit 1174. The charge pump of the pump unit 1174 then directs and forces that fluid to port A where it is then communicated on the fluid communication line 1181 to the filter device 1182 (which may, for example, be a 10 micro-meter filter made by Linde).

After passing through the filter 1182, the hydraulic fluid may then enter port F of the pump unit 1174 where it will be directed to the fluid circuit that supplies hydraulic fluid at the ports S and P. In this way, a minimum of 300 psi of pressure of the hydraulic fluid may be maintained during operation at the ports S and P. The charge pressure gear pump may be mounted on the rear of the main pump and driven through a common internal shaft.

### Prime Mover

In a swashplate pump, rotation of the swashplate drives a set of axially oriented pistons (not shown) to generate fluid flow. In the embodiment of FIG. 5, the swashplate of the pump unit 1174 is driven by a rotating shaft 1173 that is coupled to a prime mover 1175 for receiving a drive torque. In some embodiments, the prime mover 1175 is an electric motor but in other embodiments, the prime mover may be implemented in other ways such as for example by using a diesel engine, gasoline engine, or a gas driven turbine.

The prime mover 1175 is responsive to the displacement control signal 1177 received from controller 207 at a control input to deliver a controlled substantially constant rotational speed and torque at the shaft 1173. While there may be some minor variations in rotational speed, the shaft 1173 may be driven at a speed that is substantially constant and can, for a period of time as required, produce a substantially constant flow of fluid alternately at the outlet ports S and P. In one embodiment, the prime mover 1175 is selected and configured to deliver a rotational speed of about 1750 rpm which is controlled to be substantially constant within about ±1%.

In some embodiments, during operation of compressor apparatus 126, buffer chambers 195a, 195b may each be separately open to ambient air, such that air within a buffer chamber may be exchanged with the external environment (e.g. air at ambient pressure and temperature). However, it may not desirable for the air in buffer chambers 195a, 195b to be discharged into the environment and possibly other components to be discharged directly into the environment, due to the potential for other components that are not environmentally friendly also being present with the air and/or it may not be desirable for ambient air and environment (e.g. water, etc.) to be drawn into buffer chambers 195a, 195b. Thus a closed system may be provided such that for example buffer chambers 195a, 195b may be in fluid communication with each other such that an amount of gas (e.g. such as air, nitrogen, natural gas etc.) is shuttled back and forth through communication lines such as communication lines 215a, 215b.

In an embodiment disclosed, pressurized gas regulator system 217 may for example maintain a gas at a desired gas pressure within buffer chambers 195a, 195b that is above the respective pressure of the working fluid that are communicated into and compressed in compression chambers 181a, 281b respectively. For example, pressurized gas regulator system 217 may provide a buffer gas such as purified natural gas, air, or purified nitrogen gas, or another inert gas, within buffer chambers 195a, 195b. This may then prevent or substantially restrict working fluid migrating into buffer chambers 195a, 195b. Furthermore if the buffer gas is inert, any buffer gas that seeps into compression chambers 181a, 281b will not react with the working fluid or contaminants. Due the different pressures involved, pressurized gas regulator system 217 may provide buffer gas at pressures suitable and relative to compression chambers 181a, 281b.

In some embodiments, communication lines 215a, 215b may not be in fluid communication with pressurized gas regulator system 217 but instead may be interconnected with each other to provide a substantially unobstructed fluid communication channel between buffer chambers 195a, 195b.

Also, instead of being directly connected with each other, buffer chambers 195a, 195b may be both in communication with a common holding tank 1217 that may provide a source of gas that may be communicated between buffer chambers 195a, 195b. The gas in the buffer chamber gas circuit may be at ambient pressure in some embodiments and pressurized in other embodiments. The holding tank 1217 may in some embodiments also serve as a separation tank whereby any liquids being transferred with the gas in the buffer chamber system can be drained off.

### Operation of Control System

To alternately drive the hydraulic cylinders 152a, 152b to provide the reciprocating axial motion of the hydraulic pistons 154a, 154b and thus reciprocating motion of the reciprocating pistons of each of the gas compression cylinders of gas compressor portion 136, the displacement control signal 1177 is sent from the controller 207 to the pump unit 1174 and a signal is also provided by the controller 207 to the prime mover 1175. In response, the prime mover 1175 drives the rotating shaft 1173, to drive the swashplate in rotation. The displacement control signal at the input of the pump unit 1174 drives a coil of a solenoid (not shown) to cause the angle a of the swashplate to be adjusted to a desired angle, such as a maximum negative angle of about −21°, which may correspond to a maximum flow rate condition at the outlet S and no flow at outlet P. As a result, pressurized hydraulic fluid is driven from the port S of the pump unit 1174 along the fluid communication line 1163a to the input port Q of the shuttle valve device 1168. The shuttle valve device 1168, having a relatively lower pressure hydraulic fluid at the port R, is configured to direct the pressurized hydraulic fluid flowing into the port Q to flow out of the port V and thus into and along the fluid communication line 1166a. The pressurized hydraulic fluid then enters the hydraulic fluid chamber 186a of the hydraulic cylinder 152a. The flow of hydraulic fluid into the hydraulic fluid chamber 186a causes the hydraulic piston 154a to be driven axially in a manner which expands the hydraulic fluid chamber 186a, thus resulting in movement, in a direction towards the hydraulic cylinder base 183b, of the piston rod 194, the hydraulic pistons 154a, 154b, the reciprocating pistons 182, 282 of the gas compression cylinders 180, 280 of gas compressor portion 136.

During the expansion of the hydraulic fluid chamber 186a as the piston 154a moves within the hydraulic cylinder barrel 187a, there is a corresponding contraction in size of the hydraulic fluid chamber 186b of the hydraulic cylinder 152b within the hydraulic cylinder barrel 187b. This results in hydraulic fluid being driven out of hydraulic fluid chamber 186b through the input/output fluid connector 1184b and into and along the fluid communication line 1166b. The shuttle valve device 1168 is configured such that on this relatively low-pressure side, hydraulic fluid can flow into the port W and out of the port R, then along the fluid communication line 1163b to the port P of the pump unit 1174. However, the relief valve associated with the shuttle valve device 1168 may, in this operational configuration, direct a small portion of the hydraulic fluid flowing along the line 1166b to the port M for communication to the reservoir 1172, as discussed above. However, most (e.g., about 99%) of the hydraulic fluid flowing in the communication line 1166b will be directed to the communication line 1163b for return to the pump unit 1174 and will enter the pump unit 1174 at the port P.

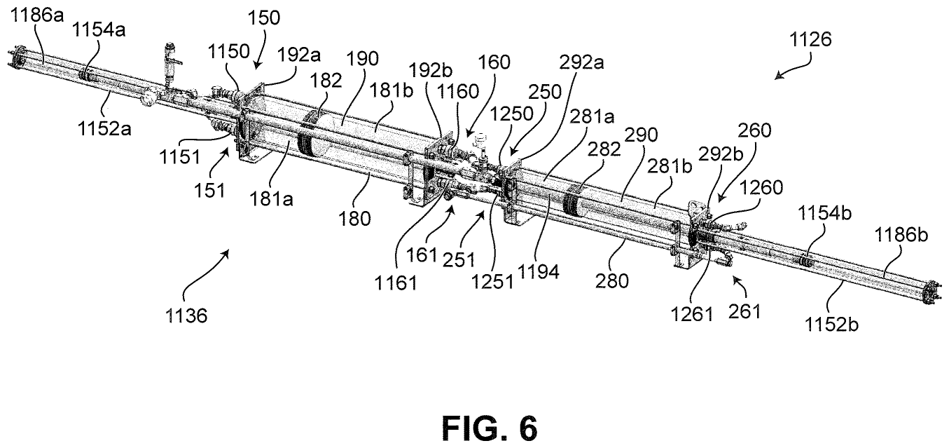

When the hydraulic piston 154a approaches the end of its drive stroke, a signal is sent by the position sensor 157a to the controller 207 which causes the controller 207 to send a displacement control signal 1177 to the pump unit 1174. In response to receiving the displacement control signal 1177 at the input of the pump unit 1174, a coil of the solenoid (not shown) is driven to cause the angle a of the swashplate of the pump unit 1174 to be altered such as to be set at a maximum positive angle of about +21°, which may correspond to a maximum flow rate condition at the outlet P and no flow at the outlet S. As a result, pressurized hydraulic fluid is driven from the port P of the pump unit 1174 along the fluid communication line 1163b to the port R of the shuttle valve device 1168. Due to the resulting change in relative pressures of hydraulic fluid in lines 1163a, and 1163b, the configuration of the shuttle valve device 1168 is adjusted such that on this relatively high-pressure side (i.e., corresponding to the fluid communication lines 1163b and 1166b), hydraulic fluid can flow into the port R and out of the port W of the shuttle valve device 1168, and then along the fluid communication line 1166b to the fluid connector 1184b. Pressurized hydraulic fluid will then enter the hydraulic fluid chamber 186b of the hydraulic cylinder 152b. This will cause the hydraulic piston 154b to be driven in an opposite axial direction in a manner which expands the hydraulic fluid chamber 186b, thus resulting in synchronized movement, in a direction towards the hydraulic cylinder base 183a, of the hydraulic pistons 154a, 154b, and the reciprocating pistons 182, 282 of the gas compression cylinders 180, 282 of gas compressor portion 136, to provide an intake stroke in the second compression chamber 181b and the fourth compression chamber 281b (see FIG. 6).

During the expansion of the hydraulic fluid chamber 186b of the hydraulic cylinder 152b, there is a corresponding contraction of the hydraulic fluid chamber 186a of the hydraulic cylinder 152a. This results in hydraulic fluid being driven out of the hydraulic fluid chamber 186a through the input/output fluid connector 1184a, and into and along the fluid communication line 1166a. The shuttle valve device 1168 is configured such that on what is now a relatively low-pressure side, hydraulic fluid can now flow into the port V and out of the port Q, then along the fluid communication line 1163a to port S of the pump unit 1174. However, the relief valve associated with the shuttle valve device 1168 may, in this operational configuration, direct a small portion of the hydraulic fluid flowing along the line 1166a to port M for communication to the reservoir 1172, as discussed above. However, most (e.g., about 99%) of the hydraulic fluid flowing in the communication line 1166a will be directed to the communication line 1163a, for return to the pump unit 1174 and will enter the pump unit 1174 at port S.

The foregoing describes one cycle which is repeated continuously for multiple cycles, as required during operation of the gas compressor apparatus 126. If a change in flow rate/fluid pressure is required in the hydraulic fluid supply system 1155, to change the speed of movement and increase the frequency of the cycles, the controller 207 may send an appropriate signal to the prime mover 1175 to vary the output to vary the rotational speed of the shaft 1173. Alternately and/or, the controller 207 may send a displacement control signal 1177 to the input of the pump unit 1174 to drive the solenoid (not shown) to cause a different angle a of the swashplate to provide different flow rate conditions at the port P and no flow at outlet S or to provide different flow rate conditions at the port S and no flow at outlet P. If zero flow is required, the swash plate may be moved to an angle of zero degrees. In an embodiment disclosed, compressor apparatus 126 may be operated in a start-stop or on-off manner where the compressor apparatus is started when it is needed and stopped when it is not, for example by controller 207 or otherwise.

### Second Embodiment: Two Stage Compressor

Turning now to FIGS. 6 and 7, a second embodiment of the common rod multi-stage compressor apparatus is shown generally at 1126. Compressor apparatus 1126 includes a compressor portion 1136 located between the two hydraulic cylinders 1152a, 1152b. The general operation of hydraulic cylinders 1152a, 1152b is described above (i.e., the first embodiment) with respect to hydraulic cylinders 152a, 152b and hydraulic fluid supply system 1155.

In this embodiment, compressor portion 1136 comprises a first gas compression cylinder 180 and a second compression cylinder 280. First gas compression cylinder 180 is configured to receive a supply of working fluid, such as from piping 124 and compress the working fluid to produce a first pressurized working fluid, which is supplied to second gas compression cylinder 280. Second gas compression cylinder 280 is configured to receive the first pressurized working fluid from first gas compression cylinder 180 and compress the first pressurized working fluid to produce a second pressurized working fluid, which is discharged to the piping 130.

The first gas compression cylinder 180 is divided into first and second compression chambers 181a, 181b by the first reciprocating piston 182. The first compression chamber 181a is defined by a cylinder barrel/tubular wall 190, the first reciprocating piston 182 and a first gas cylinder head 192a. The second compression chamber 181b is defined by the cylinder barrel/tubular wall 190, the first reciprocating piston 182 and a second gas cylinder head 192b and is formed on the opposite side of first reciprocating piston 182 from the first compression chamber 181a.

The second gas compression cylinder 280 is divided into the third and fourth compression chambers 281a, 281b by the second reciprocating piston 282. The third compression chamber 281a is defined by a cylinder barrel/tubular wall 290, the second reciprocating piston 282 and a first gas cylinder head 292a. The fourth compression chamber 281b is defined by the cylinder barrel/tubular wall 290, the second reciprocating piston 282 and a second gas cylinder head 292b and is formed on the opposite side of second reciprocating piston 282 from the third compression chamber 281a.

The components forming the hydraulic cylinders 1152a, 1152b and the gas compression cylinders 180, 280 may be made from any one or more suitable materials. By way of example, the cylinder barrel 190, 290 of the gas compression cylinders 180, 280 may be formed from chrome plated steel; the barrels of the hydraulic cylinders 1152a, 1152b, may be made from a suitable steel; the reciprocating pistons 182, 282 may be made from T6061 aluminum; the hydraulic pistons 1154a, 1154b may be made generally from ductile iron; and the piston rod 194 may be made from induction hardened chrome plated steel.

The diameter of the hydraulic pistons 1154a, 1154b may be selected depending upon the required output gas pressure to be produced by the gas compressor apparatus 1126 and a diameter (e.g., from a diameter of about 2.25 inches to about 7 inches or more, for example about 2.25, 2.75, 3, 3.5, 4.5, 6, or 7 inches) that is suitable to withstand a desired or selected pressure of hydraulic fluid in the hydraulic fluid chambers 1186a, 1186b (for example, a maximum pressure of about 2800 psi).

The diameter of the first reciprocating piston 182 and the corresponding inner surface of the gas cylinder barrel 190 of the first gas compression cylinder 180 are selected depending upon factors such as the required volume of working fluid or desired compression ratio and may vary widely (e.g., from a diameter of about 4.5 inches to 34 inches or more). Similarly, the diameter of the second reciprocating piston 282 and the corresponding inner surface of the gas cylinder barrel 290 of the second gas compression cylinder 280 may also vary widely (e.g., from a diameter of about 4.5 inches to 34 inches or more, for example about 5, 6, 8, 10, 12, 16, 18, 22, 32, or 34 inches). The diameters of the first and second reciprocating pistons 182, 282 may be selected based on one or more factors such as the suction pressure of the working fluid being supplied to compressor apparatus 1126 and/or the required differential pressure (i.e., the difference between the pressure of the working fluid being supplied to compressor apparatus 1126 and the pressure of the compressed working fluid discharged from compressor apparatus 1126. For example, for a suction pressure of about 40 psi and a discharge pressure of about 290 psi (corresponding to a differential pressure of about 250 psi), first reciprocating piston 182, may have a diameter of about 22 inches and second reciprocating piston 282 may have a diameter of about 16 inches. In another embodiment, for example, for a suction pressure of about 0.5 psi and a discharge pressure of about 250.5 psi (corresponding to a differential pressure of about 250 psi), first reciprocating piston 182, may have a diameter of about 22 inches and second reciprocating piston 282 may have a diameter of about 8 inches.

For example, the diameter of the first or second reciprocating pistons 182, 282 (and the corresponding inner surfaces of the respective gas cylinder barrels 190, 290) may be about 4.5 inches, about 5 inches, about 6 inches, about 8 inches, about 10 inches, about 12 inches, about 14 inches, about 16 inches, about 18 inches, about 22 inches, about 32 inches or about 34 inches. However, these are merely non-limiting examples. The diameters of the cylinders/pistons is not limited to any listed US/standard diameter, and may be for example a Sl/standard diameter and/or a custom diameter, and/or combinations thereof to provide selected multi-stage compression of the working fluid.

In an embodiment, the first reciprocating piston 182 may have a diameter of about 12 inches, the second reciprocating piston 282 may have a diameter of about 6 inches, the piston rod 1194 may have a length of about 50 inches and a diameter of about 2.5 inches, the hydraulic pistons 1154a, 1154b may have a diameter of about 3.5 inches and the hydraulic pump, e.g. pump unit 1174 may be about a 50 horsepower (hp) 105 cubic centimeter (cc) pump.

In an embodiment, the first reciprocating piston 182 may have a diameter of about 22 inches, the second reciprocating piston 282 may have a diameter of about 12 inches, the piston rod 1194 may have a length of about 50 inches and a diameter of about 3 inches, the hydraulic pistons 1154a, 1154b may have a diameter of about 6 inches and the hydraulic pump, e.g. pump unit 1174 may be about a 50 horsepower (hp) 105 cubic centimeter (cc) pump.

In some embodiments, first pressurized working fluid from the first gas compression cylinder 180 is supplied to the second gas compression cylinder 280. As piston rod 1194 reciprocates in a similar manner, e.g. stroke, the diameter of the first reciprocating piston 182 and corresponding inner surface of the gas cylinder barrel 190 of the first gas compression cylinder 180 and the diameter of the second reciprocating piston 282 and corresponding inner surface of the gas cylinder barrel 290 of the second compression cylinder 280 may be selected to provide about the same mass flowrate, e.g. taking into account pressure and/or temperature.

In some embodiments, in order to balance a flow condition, for example mass flowrate and/or pressures of the first and second gas compression cylinders 180, 280, the first gas compression cylinder 180 and/or second gas compression cylinder 280 may include a variable volume pocket configured to allow adjustment of the head volumes of compressor 1126. For example, a variable volume pocket at first gas cylinder head 192a may allow the volume of the first gas compression chamber 181a to be increased or decreased and a variable volume pocket at second gas cylinder head 192b may allow the volume of the second gas compression chamber 181b to be increased or decreased, thereby increasing or decreasing the compression ratio of first gas compression cylinder 180. See e.g. FIG. 6.

Similarly, a variable volume pocket at first gas cylinder head 292a may allow the volume of the third gas compression chamber 281a to be increased or decreased and a variable volume pocket at second gas cylinder head 292b may allow the volume of the fourth gas compression chamber 281b to be increased or decreased, thereby increasing or decreasing the compression ratio of second gas compression cylinder 280.

In some embodiments, the variable volume pocket may comprise a suitable vessel in fluid communication with a gas compression chamber of compressor 1126. For example, the variable volume pocket may comprise a vessel in communication with first compression chamber 181a via a port (not shown in the Figures) extending through first gas cylinder head 192a. The variable volume pocket may comprise, for example, a length of pipe or tubing that is connected to the port in first gas cylinder head 192a at a first end and is suitably sealed at a second end. The length and diameter of the pipe may be selected based on a desired volume increase for first compression chamber 181a. A variable volume pocket may similarly be provided for second compression chamber 181b via a port extending through second gas cylinder head 192b, third compression chamber 281a via a port extending through first gas cylinder head 292a, and fourth compression chamber 281b via a port extending through second gas cylinder head 292b. In some embodiments, the variable volume pocket may be on-off selectable to provide unloading/loading of the respective cylinder, for example a length of pipe or tubing that may be selectively closed and opened, for example by a valve. In some embodiments, the variable volume pocket may be adjustable to selectively provide an adjustable variable effective volume. In an embodiment disclosed, the variable volume pocket may be described as a variable volume clearance pocket, in that the variable volume increases the effective clearance/volume that is not compressed by the piston.

In some embodiments, piston rod 1194 may be formed as a single unitary portion. In other embodiments, piston rod 1194 may be formed as multiple sections, which may be permanently connected (e.g., by welding) or are releasably coupled. This may improve the ease of assembly and/or disassembly of compressor apparatus 1126, for transport, installation, service or maintenance. For example, piston rod 1194 may be formed in two or more portions, coupled at one or more portions, for example in the portion of piston rod 1194 that protrudes between first gas compression cylinder 180 and second compression cylinder 280. In some embodiments, a coupling or coupling arrangement is provided to couple portions of the piston rod 1194 together.

In some embodiments, piston rod 1194 may comprise a plurality of sections. Referring to FIGS. 10B, 10D, for example, piston rod 1194 is formed of interconnected piston rod sections 1194a, 1194b, 1194c. Piston rod sections 1194a, 1194b are interconnected at first reciprocating piston 182 and similarly piston rod sections 1194b, 1194c are interconnected at second reciprocating piston 282. In some embodiments, reciprocating pistons 182, 282 comprise a one-piece structure. The reciprocating pistons 182, 282 may comprise a metal, for example aluminum.

In some embodiments, at least a portion of piston rod 1194 may extend through the reciprocating piston to interconnect with the next section of the piston rod 1194 to transfer the reciprocating forces. As an example, this is illustrated in FIG. 10B relative to second reciprocating piston 282. In some embodiments, a bridging member 2620 may extend through the reciprocating piston to connect piston rod sections and to transfer the reciprocating forces. As an example, this is illustrated in FIG. 10B relative to first reciprocating piston 182 where bridging member 2620 connects piston rod section 1194a and piston rod section 1194b. Also illustrated are bearing plates 2622 to adapted to distribute loads applied between the piston rod 1194 to the reciprocating piston 182, e.g. axial compression loads.

In some embodiments, reciprocating pistons 182, 282 may comprise a multiple-piece structure, such as a split-cylinder, to sandwich the piston rod 1194 between the multiple-piece structure to secure the reciprocating pistons 182, 282 to the piston rod 1194. The above are non-limiting examples, and the piston rod 1194 and reciprocating pistons 182, 282 may be interconnected in a wide variety of suitable arrangements.

The reciprocating pistons 182, 282 may also include a conventional gas compression piston seal devices 484, 584 at its outer circumferential surface to provide a seal with the inner wall surface of the respective gas cylinder barrels 190, 290 to substantially prevent or inhibit movement of the working fluid and any constituents thereof across the reciprocating pistons 182, 282 between the gas compression cylinder sections (i.e., between the compression chambers 181a and 181b, and 281a and 281b). The reciprocating piston seal devices 484, 584 may also assist in maintaining the gas pressure differences between adjacent gas compression cylinder sections during operation of compressor apparatus 1126.

As noted above, referring to FIG. 6, the hydraulic pistons 1154a, 1154b are formed at opposite ends of the piston rod 1194. The piston rod 1194 passes through the gas compression chambers 181a, 181b, 281a, 281b and passes through sealed (e.g., by welding, threaded, and/or otherwise) central axial openings through the reciprocating pistons 182, 282 and is configured and adapted so that the reciprocating pistons 182, 282 are fixedly and sealably mounted to the piston rod 1194.

The piston rod 1194 also passes through axially oriented openings in first gas cylinder head 192a and second gas cylinder head 192b of first gas compression cylinder 180, located at opposite ends of the gas cylinder barrel 190. Similarly, the piston rod 1194 also passes through axially oriented openings in first gas cylinder head 292a and second gas cylinder head 292b of second gas compression cylinder 280, located at opposite ends of the gas cylinder barrel 290. Thus, reciprocating axial/longitudinal movement of the piston rod 1194 will result in reciprocating synchronous axial/longitudinal movement of each of the hydraulic pistons 1154a, 1154b in the respective hydraulic fluid chambers 1186a, 1186b, the first reciprocating piston 182 within the first and second compression chambers 181a, 181b of the first gas compression cylinder 180 and the second reciprocating piston 282 within the third and fourth compression chambers 281a, 281b of the second gas compression cylinder 280.

Seal devices, e.g. seal device 198 (typical) are provided between the piston rod 1194 and respective openings of first gas cylinder head 192a and second gas cylinder head 192b of first gas compression cylinder 180 as well as of first gas cylinder head 292a and second gas cylinder head 292b of second gas compression cylinder 280. The seal devices may comprise one or more sealing ring, such as a v-packing seal set. In an embodiment disclosed, the seal devices may comprise one or more Viton™ v-rings with top, middle, and bottom polytetrafluoroethylene (PTFE) (e.g., Teflon™) parts and may comprise one or more optional lantern rings.

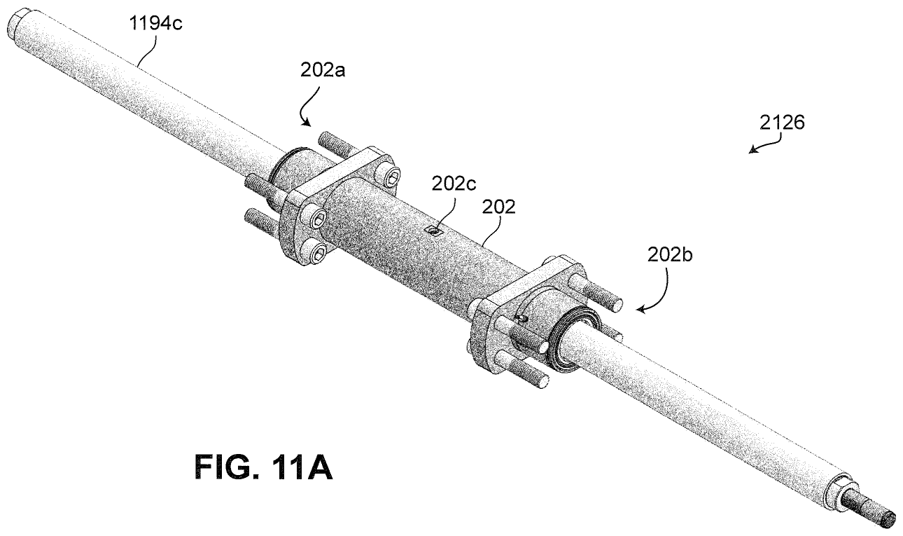

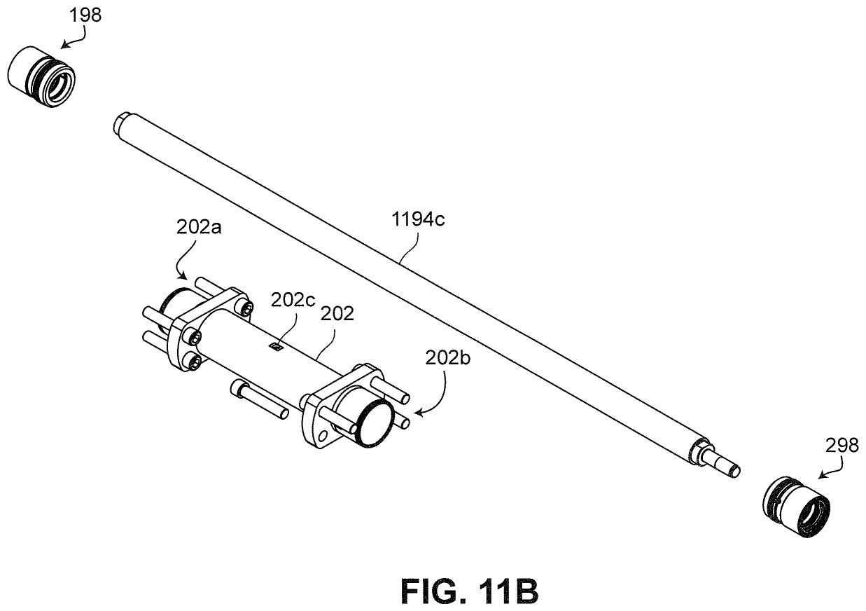

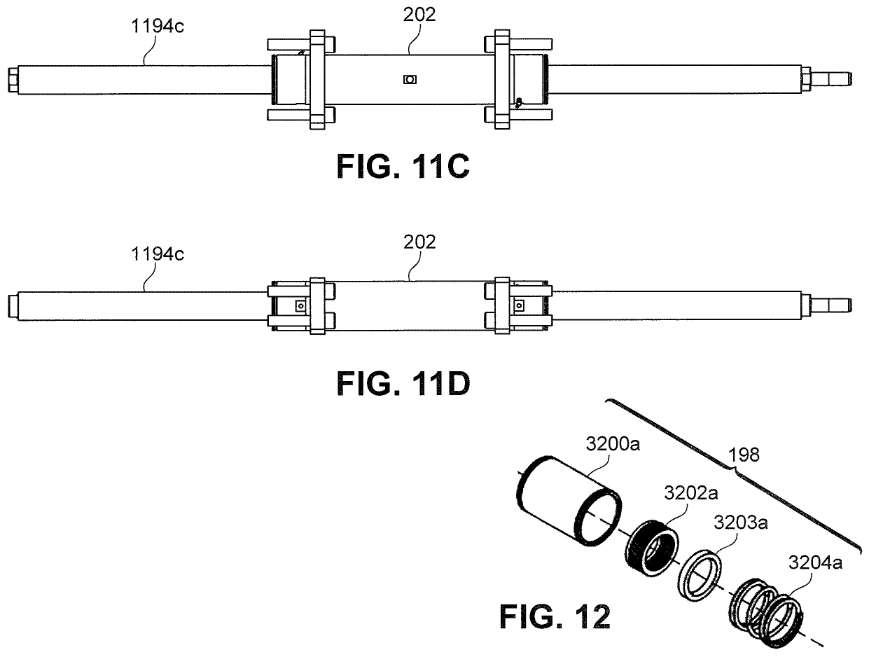

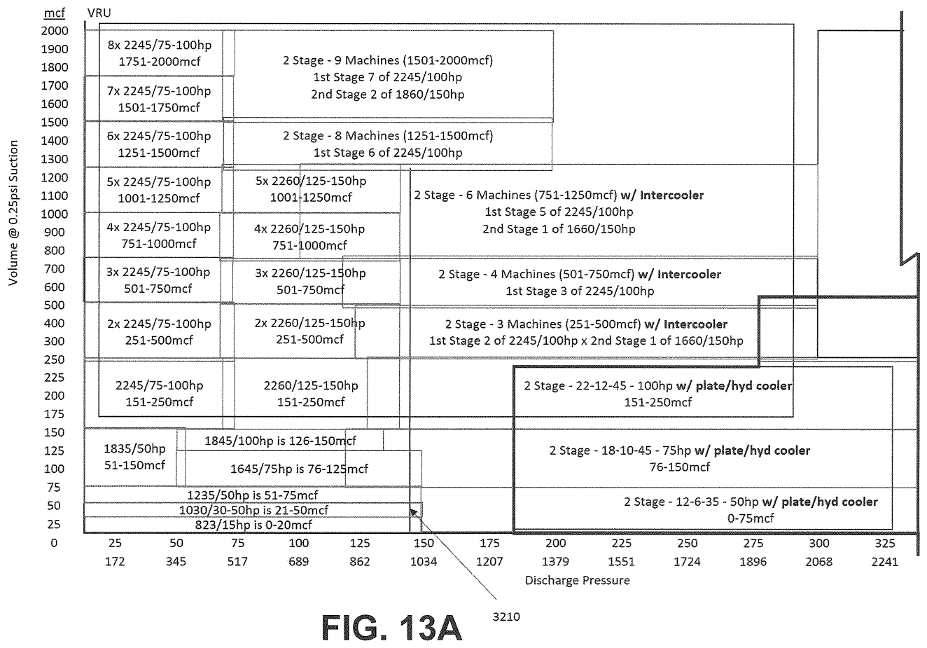

Seal devices 198, 298 (see e.g. FIGS. 11B, 12) may be similar or may be simpler, as a small leakage of the working fluid into the housing 202 is less problematic than leakage of the working fluid into buffer chambers 195a, 195b. Seal devices 198, 298 may include a plurality of polytetrafluoroethylene (PTFE) (e.g., Teflon™) seal rings and may also include Hydrogenated Nitrile Butadiene Rubber (HNBR) energizers/energizing rings for the seal rings. One or more lantern rings may also be provided.

In an embodiment disclosed, housing 202 with seal devices 198, 298 at respective ends 202a, 202b extends between second gas cylinder head 192b of first gas compression cylinder 180 and the first gas cylinder head 292a of second gas compression cylinder 280 substantially enclosing or enclosing piston rod 1194 (see e.g. FIG. 8). In an embodiment disclosed, a housing is optional and/or not used (see e.g. FIG. 7). However, due to the reciprocating action, the respective gas compression cylinders must be mounted firmly, as the housing 202 (see e.g. FIG. 8) may help secure the gas compression cylinders 180, 280 axially.

### Working Fluid Path

The compressor apparatus 1126 may also include a working fluid communication system to allow working fluid to be delivered from the piping 124 (FIGS. 1-3) to the first and second compression chambers 181a, 181b of the first gas compression cylinder 180 shown in FIG. 6, communicate the resulting first pressurized working fluid from the first and second compression chambers 181a, 181b to the third and fourth compression chambers 281a, 281b of the second gas compression cylinder 280 and then communicate the resulting second pressurized working fluid from the third and fourth compression chambers 281a, 281b to the piping 130, e.g. as in FIGS. 1-3, for example delivery to the oil flow line 133, delivery to scrubber 2612, delivery to piping 2618 or delivery otherwise to convey the discharged second pressurized working fluid to a location remote from the compressor apparatus 126, 1126, for example.

Referring to e.g. FIG. 8, the working fluid communication system includes a first input valve and connector device 150, a second input valve and connector device 160, a first output valve and connector device 151 and a second output valve and connector device 161. A working fluid input suction distribution line 204 fluidly interconnects the first input valve and connector device 150 with the second input valve and connector device 160.

Referring e.g. to FIG. 7, the working fluid communication system may include first pressurized working fluid distribution lines 206 and 208. First pressurized working fluid distribution line 206 fluidly interconnects first output valve and connector device 151 and a third input valve and connector device 250. First pressurized working fluid distribution line 208 fluidly interconnects second output valve and connector device 161 and a fourth input valve and connector device 260. A second pressurized working fluid output pressure distribution line 209 fluidly interconnects a third output valve and connector device 251 with and a fourth output valve and connector device the output valve and connector device 261.

Whilst not shown in the Figs., the input valve and connector devices 150, 160, 250, and 260 may include a compression chamber section valve and connector, a gas pipe input connector, and a gas suction distribution line connector. In some embodiments an excess pressure valve and bypass connector are also provided. In an alternate embodiment, there is no bypass connector. However, in this latter embodiment there is a lubrication connector which is attached in series to an input port of a lubrication device comprising suitable fittings and valves. The lubrication device allows a lubricant such as a lubricating oil (like WD-40™ oil) to be injected into the passageway where the working fluid passes though the connector device. The WD-40 can be used to dissolve hydrocarbon sludges and soots to keep seals functional.

The working fluid communication system includes an electronic gas pressure sensing/transducer device, for example see e.g. gas pressure sensing device 1257 as typical, which may, for example, be a model AST46HAP00300PGT1L000 made by American Sensor Technologies. The output port of the gas pressure sensing device may be connected to an input connector of the working fluid input suction distribution line 204 and/or first pressurized working fluid distribution lines 206 and 208. This sensor reads the gas pressure in the working fluid supplied to the connector devices 150, 160, 250 and/or 260. Additional pressure and/or temperature sensor(s) may be provided to measure the pressure and/or temperature of the working fluid at one or more locations between piping 124 and piping 130. Pressure and/or temperature measurements may be provided to controller 207. Controller 207 may adaptively control the hydraulic fluid supply system 1155 and/or the compressor apparatus 1126 in response to the pressure and/or the temperature of the working fluid at one or more locations in the working fluid path through and/or upstream and/or downstream the compressor apparatus 1126.

The gas pressure sensing device/transducer may be in electronic communication with the controller 207 shown in FIG. 5 and may provide signals to the controller 207 indicative of the pressure of the gas in the working fluid input suction distribution line 204. In response to such signals, the controller 207 may modify the operation of the oil and gas well system 100 or vapor recovery system 2600 and in particular the operation of the hydraulic fluid supply system 1155. For example, if the pressure in the working fluid input suction distribution line 204 descends to a first threshold level (e.g., 8 psi, i.e., low working fluid supply pressure, for the oil and gas well system 100) the controller 207 can control the operation of the hydraulic fluid supply system 1155 to slow down the reciprocating motion of the gas compressor apparatus 1126, which should allow the pressure of the gas that is being fed to the associated connector device and the associated gas suction distribution line to increase. If the pressure measured by the sensing device reaches a second, lower threshold level-such that it may be getting close to zero or negative pressure (e.g., 3 psi)-the controller 207 may cause the hydraulic fluid supply system 1155 to cease the operation of the hydraulic fluid supply system 1155 shown in FIG. 5 and hence the gas compressor apparatus 1126.

The hydraulic fluid supply system 1155 may then be re-started by the controller 207, if and when the pressure measured by the gas pressure sensing device/transducer again rises to an acceptable threshold level as detected by a signal received by controller 207.

In use with a vapor recovery system 2600 for example, the first threshold level and the second, lower threshold level in the working fluid input suction distribution line 204 will be lower than that of oil and gas well system 100. The first threshold level may be e.g. about 0.1 to about 0.25 psi and the second, lower threshold level may be e.g. about 0 psi.

The working fluid may be conveyed through first gas compression cylinder 180 and second gas compression cylinder 280 in various routes/sequences and with or without pre-cooling, inter-stage cooling, and/or after-cooling. As previously described, first gas compression cylinder 180 and second gas compression cylinder 280 may be piped in parallel and/or in series configurations. When piped in series, working fluid may be routed in various ways. As an example, referring to FIG. 7, working fluid from piping 124 may be provided to first gas compression cylinder 180 by working fluid input suction distribution line 204, compressed, and via first pressurized working fluid distribution line 208 to heat exchanger 216 and first pressurized working fluid distribution line 206 to heat exchanger 214, to second gas compression cylinder 280, compressed, and via second pressurized working fluid output pressure distribution line 209 to piping 130. Heat exchangers 214, 216 may be used to cool the respective first pressurized working fluid distribution line 206, 208. As another example, referring to FIG. 8, working fluid from piping 124 may be provided to first gas compression cylinder 180 by working fluid input suction distribution line 204, compressed, provided to cooler 220 by pressurized working fluid distribution line 218, and via first pressurized working fluid input suction distribution line 236 provided to second gas compression cylinder 280, compressed, and via second pressurized working fluid output pressure distribution line 209 to piping 130.

In an embodiment disclosed heat exchangers 214, 216 and/or cooler 220 may include a length of finned tubing through which the working fluid is conveyed. The finned tubing may be passively cooled, for example by natural convection and/or by active cooling, e.g. by forced air convection. However, in an embodiment disclosed heat exchangers 214, 216 and/or cooler 220 are plate and frame heat exchangers. In an embodiment disclosed, plate and frame heat exchangers include a plurality of plates stacked together within a frame, the plurality of plates providing fluid paths therebetween though which hot fluid is flowed on one side and cooling fluid is flows on the other side, to provide heat exchange through the plates, in particular from the hot fluid to the cooling fluid.

With reference to FIG. 6, first output valve and connector device 151 may include a one-way check valve 1151, a gas pressure distribution line connector (not shown in FIGS.), a gas pipe output connector (not shown in FIGS.) and a pressure relief valve (not shown in FIGS.). In some embodiments there is no bypass valve.

With reference to FIGS. 6 and 7, first input valve and connector device 150 is fluidly connected to the first compression chamber 181a through a one-way check valve 1150. Working fluid flows through the connector device 150 and then the check valve 1150, and into the first compression chamber 181a. Similarly, pressurized working fluid may flow out of the first compression chamber 181a through the one-way check valve 1151 of the first output valve and connector device 151, and into first pressurized working fluid distribution line 206 (see FIG. 7).

The check valve 1150 associated with the connector device 150 is operable to allow gas to flow into and the first compression chamber 181a if the working fluid pressure at the connector 150 is higher than the working fluid pressure on the inward side of the check valve 1150. This will occur, for example, when the first compression chamber 181a is undergoing expansion as the first reciprocating piston 182 moves away from the first gas cylinder head 192a, resulting in a drop in pressure within the first compression chamber 181a.

The check valve 1151 is operable to allow pressurized working fluid to flow out of the first compression chamber 181a, if the working fluid pressure in the first compression chamber 181a is higher than the working fluid pressure on the outward side of the check valve 1151 of first output valve and connector device 151, and when the working fluid pressure reaches a certain minimum threshold pressure that allows it to open. The check valve 1151 may be operable to be adjusted to set the threshold opening pressure difference that causes/allows the check valve 1151 to open. An increase in pressure in the first compression chamber 181a will occur, for example, when the first compression chamber 181a is undergoing a reduction in size as the first reciprocating piston 182 moves toward the first gas cylinder head 192a, resulting in an increase in pressure within the first compression chamber 181a.

With continued reference to FIGS. 6 and 7, the second input valve and connector device 160 is connected to working fluid input suction distribution line 204 opposite to the end with the first input valve and connector 150. A one-way check valve 1160 is installed within the second input valve and connector device 160. Working fluid may flow from the working fluid input suction distribution line 204 through the second input valve and connector device 160 and the one-way check valve 1160 and into the second compression chamber 181b.

Similarly, the second output valve and connector device 161 is connected to an end of the first pressurized working fluid distribution line 208 opposite to the end connected to the first output valve and connector device 151. A one-way check valve 1161 is installed within the connector device 161. Working fluid may flow out of the second compression chamber 181b, through the one-way check valve 1161 and connector device 161, and then through first pressurized working fluid distribution line 208 to the fourth input valve and connector device 260.

Referring back to FIG. 6, the one-way check valve 1160 is operable to allow working fluid to flow into the second compression chamber 181b if the working fluid pressure at the connector 1160 is higher than the working fluid pressure on the inward side of the check valve 1160. This will occur, for example, when the second compression chamber 181b is undergoing expansion as the first reciprocating piston 182 moves away from the second gas cylinder head 192b, resulting in a drop in pressure within the second compression chamber 181b.

The one-way check valve 1161 is operable to allow pressurized working fluid to flow out of the gas compression chamber 181b, if the working fluid pressure in the second compression chamber 181b is higher than the working fluid pressure on the outward side of the check valve 1161 of the connector device 161, and when the working fluid pressure reaches a certain minimum threshold pressure that allows it to open. The check valve 1161 may be operable to be adjusted to set the threshold opening pressure difference that causes/allows the one-way check valve to open. The increase in pressure in the second compression chamber 181b will occur, for example, when the second compression chamber 181b is undergoing a reduction in size as the reciprocating piston 182 moves towards the second gas cylinder head 192b, resulting in an increase in pressure within the second compression chamber 181b.

Similarly with regards to the second gas compression cylinder 280, connector device 250 is fluidly connected to the third compression chamber 281a through a one-way check valve 1250. Working fluid flows through the connector device 250 and then the check valve 1250, and into the third compression chamber 281a. Similarly, second pressurized working fluid may flow out of the third compression chamber 281a through the one-way check valve 1251 of the connector device 251, and into second pressurized working fluid output pressure distribution line 209 (FIG. 7).

The check valve 1250 associated with the connector 250 is operable to allow gas to flow into and the third compression chamber 281a if the working fluid pressure at the connector 250 is higher than the working fluid pressure on the inward side of the check valve 1250. This will occur, for example, when the third compression chamber 281a is undergoing expansion as the second reciprocating piston 282 moves away from the first gas cylinder head 292a, resulting in a drop in pressure within the third compression chamber 281a.

The check valve 1251 is operable to allow pressurized working fluid to flow out of the third compression chamber 281a, if the working fluid pressure in the third compression chamber 281a is higher than the working fluid pressure on the outward side of the check valve 1251 of connector device 251, and when the working fluid pressure reaches a certain minimum threshold pressure that allows it to open. The check valve 1251 may be operable to be adjusted to set the threshold opening pressure difference that causes/allows the check valve to open. An increase in pressure in the third compression chamber 281a will occur, for example, when the third compression chamber 281a is undergoing a reduction in size as the second reciprocating piston 282 moves toward the first gas cylinder head 292a, resulting in an increase in pressure within the third compression chamber 281a.

With reference to FIG. 6, the fourth input valve and connector device 260 is connected to first pressurized working fluid distribution line 208. A one-way check valve 1260 is installed within the connector device 260. First pressurized working fluid may flow from the first pressurized working fluid distribution line 208 through the connector device 260 and the one-way check valve 1260 and into the fourth compression chamber 281b.

Similarly, the fourth output valve and connector device 261 is connected to an end of the and into second pressurized working fluid output pressure distribution line 209 opposite to the end connected to the third output valve and connector device 251. A one-way check valve 1261 is installed within the connector device 261. The second pressurized working fluid may flow out of the fourth compression chamber 281b, through the one-way check valve 1261 and connector device 261, and then through second pressurized working fluid output pressure distribution line 209 and into piping 130 (see FIG. 7).

Referring back to FIG. 6, the one-way check valve 1260 is operable to allow working fluid to flow into the fourth compression chamber 281b if the working fluid pressure at the connector 260 is higher than the working fluid pressure on the inward side of the check valve 1260. This will occur, for example, when the fourth compression chamber 281b is undergoing expansion as the second reciprocating piston 282 moves away from the second gas cylinder head 292b, resulting in a drop in pressure within the fourth compression chamber 281b.

The one-way check valve 1261 is operable to allow pressurized working fluid to flow out of the fourth gas compression chamber 281b, if the working fluid pressure in the fourth compression chamber 281b is higher than the working fluid pressure on the outward side of the check valve 1261 of the connector 261, and when the working fluid pressure reaches a certain minimum threshold pressure that allows it to open. The check valve 1261 may be operable to be adjusted to set the threshold opening pressure difference that causes/allows the one-way check valve to open. The increase in pressure in the fourth compression chamber 281b will occur, for example, when the fourth compression chamber 281b is undergoing a reduction in size as the first reciprocating piston 282 moves towards the second gas cylinder head 292b, resulting in an increase in pressure within the fourth compression chamber 281b. Operation The following describes the general operation of the compressor apparatus 1126 controller and hydraulic system.

Referring to FIGS. 6 and 7, in operation of the gas compressor apparatus 1126, the hydraulic pistons 1154a, 1154b are driven in reciprocating longitudinal movement by the hydraulic fluid supply system 1155 as described above, e.g. in connection with FIG. 5, thus driving the first and second reciprocating pistons 182, 282 as well.

With the hydraulic pistons 1154a, 1154b and the reciprocating pistons 182, 282 in the positions shown in FIG. 7, working fluid will be already located in the first compression chamber 181a, having been previously drawn into first compression chamber 181a during the previous stroke due to a pressure differential that developed between the outer side of the one-way check valve 1150 (shown in FIG. 6) and the inner side of the check valve 1150 as the first reciprocating piston 182 moved from left to right. During that previous stroke, working fluid will have been drawn from piping 124 (e.g. shown in FIGS. 1-3), through the connector device 150 and its check valve 1150, into the first compression chamber 181a. The check valve 1151 of the first output valve and connector device 151 will be closed due to a pressure differential between the inner and outer sides of the check valve 1151, thus allowing the first compression chamber 181a to be filled with working fluid at a lower pressure than the working fluid on the outside of the first output valve and connector device 151.

At the same time, first pressurized working fluid will be already located in the third compression chamber 281a, having been previously drawn into the third compression chamber 281a during the previous stroke due to a pressure differential that developed between the outer side of the one-way check valve 1250 (shown in FIG. 6) and the inner side of the check valve 1250 as the second reciprocating piston 282 moved from left to right. During that previous stroke, working fluid will have been drawn from first pressurized working fluid distribution line 206 through the connector device 250 and its check valve 1250, into the third compression chamber 281a. The check valve 1251 of the connector device 251 will be closed due to a pressure differential between the inner and outer sides of the check valve 1251, thus allowing the third compression chamber 281a to be filled with working fluid at a lower pressure than the working fluid on the outside of the connector device 251.

### First Compression Stroke

With the first and second reciprocating pistons 182, 282 in the positions shown in FIG. 7, the hydraulic fluid chamber 1186b is supplied with pressurized hydraulic fluid in a manner such as is described above, thus driving the hydraulic piston 1154b, along with the piston rod 1194, the reciprocating pistons 182, 282 and the hydraulic piston 1154a attached to the piston rod 1194, to the left as indicated by direction arrow 210 FIG. 7. As this is occurring, hydraulic fluid in the hydraulic fluid chamber 1186a is forced out of the hydraulic fluid chamber 1186b and flows as described above.

As the first reciprocating piston 182 moves to the left as indicated by direction arrow 210 in FIG. 7, working fluid is drawn from piping 124, and into working fluid input suction distribution line 204, and then passes through the second input valve and connector device 160 and the one-way check valve 1160 and into the second compression chamber 181b. The working fluid flows in such a manner because as the first reciprocating piston 182 moves to the left as shown in FIG. 7, the pressure in the second gas compression chamber 181b will drop, which will create a suction that will cause the working fluid in piping 124 to flow into the second compression chamber 181b.

As the second reciprocating piston 282 moves to the left as indicated by direction arrow 210 in FIG. 7, first pressurized working fluid is drawn from the first pressurized working fluid distribution line 208 and then passes through the fourth input valve and connector device 260 and the one-way check valve 1260 and into the fourth compression chamber 281b. The working fluid flows in such a manner because as the second reciprocating piston 282 moves to the left as indicated by direction arrow 210 in FIG. 7, the pressure in the fourth compression chamber 281b will drop, which will create a suction that will cause the first pressurized working fluid in first pressurized working fluid distribution line 208 to flow into the fourth compression chamber 281b.

Simultaneously, the movement of the first reciprocating piston 182 to the left will compress the working fluid that is already present in the first compression chamber 181a. As the pressure rises in the first compression chamber 181a, working fluid flowing into the first input valve and connector 150 from the piping 124 will not enter the first compression chamber 181a. Additionally, working fluid being compressed in the first compression chamber 181a will stay in the first compression chamber 181a until the pressure therein reaches the threshold pressure of working fluid pressure that is provided by the one-way check valve 1151 (shown in FIG. 6). Working fluid being compressed in the first compression chamber 181a is prevented from flowing out of the first compression chamber 181a into the connector device 150 by the orientation of the check valve 1150 (shown FIG. 6).

Simultaneously, the movement of the second reciprocating piston 282 to the left will compress the working fluid that is already present in the third compression chamber 281a. As the pressure rises in the third compression chamber 281a, working fluid flowing into the third input valve and connector device 250 from first pressurized working fluid distribution line 206 will not enter the third compression chamber 281a. Additionally, working fluid being compressed in the third compression chamber 281a will stay in the third compression chamber 281a until the pressure therein reaches the threshold pressure of working fluid pressure that is provided by the one-way check valve 1251 (shown in FIG. 6). Working fluid being compressed in the third compression chamber 281a is prevented from flowing out of the third compression chamber 281a into the third input valve and connector device 250 by the orientation of the check valve 1250 (shown FIG. 6).

The foregoing movement and compression of working fluid and movement of hydraulic fluid continues as the first and second reciprocating pistons 182, 282 move in the direction indicated by direction arrow 210 to an end of stroke position (i.e., the furthest position of pistons 182, 282 prior to reversal of direction). During this movement, the pressure in the first compression chamber 181a increases until it is high enough to activate the check valve 1151, at which point the working fluid will be allowed to discharge from the first compression chamber 181a, through the first output valve and connector device 151, and into first pressurized working fluid distribution line 206. Simultaneously, during this movement, the pressure in the third compression chamber 281a increases until it is high enough to activate the check valve 1251, at which point the working fluid will be allowed to discharge from the third compression chamber 281a, through the connector device 251, and into second pressurized working fluid output pressure distribution line 209.

Just before the hydraulic piston 1154b reaches the end of stroke position, a position sensor (similar to the position sensor 157b described above with respect to compressor apparatus 126) will detect the presence of the hydraulic piston 1154b within the hydraulic cylinder 1152b at a longitudinal position that is a short distance before the end of the stroke within the hydraulic cylinder 1152b. The position sensor will then send a first position signal 2200 to the controller 207, in response to which the controller 207 will change the operational configuration of the hydraulic fluid supply system 1155, as described above. This will result in the hydraulic piston 1154b not being driven any further to the left in the hydraulic cylinder 1152b.

### End of First Compression Stroke

Once the hydraulic piston 1154b, along with the piston rod 1194, the reciprocating pistons 182, 282 and the hydraulic piston 1154a attached to the piston rod 1194, are at their end of stroke positions:

The working fluid will have been drawn through the connector device 160 and the check valve 1160 again due to the pressure differential that is developed between the second compression chamber 181b and the working fluid input suction distribution line 204, so that the second compression chamber 181b is filled with working fluid. Much of the working fluid in the first compression chamber 181a that has been compressed by the movement of the first reciprocating piston 182 in the direction indicated by direction arrow 210, will, once compressed sufficiently to exceed the threshold level of the check valve 1151, have exited the first compression chamber 181a and passed into the first pressurized working fluid distribution line 206 for delivery to the third compression chamber 281a.

The first pressurized working fluid will have been drawn through the connector device 260 and the one way check valve 1260 again due to the pressure differential that is developed between the fourth compression chamber 281b and the first pressurized working fluid distribution line 208, so that the fourth compression chamber 281b is filled with working fluid. Much of the working fluid in the third compression chamber 281a that has been compressed by the movement of the second reciprocating piston 282 in the direction indicated by direction arrow 210, will, once compressed sufficiently to exceed the threshold level of the check valve 1251, have exited the third compression chamber 281a and passed into the second pressurized working fluid output pressure distribution line 209.

### Second Compression Stroke

Next, the compressor apparatus 1126, including the hydraulic fluid supply system 1155 is reconfigured for a compression stroke in the second and fourth compression chambers 181b, 281b. As working fluid has been drawn into the second compression chamber 181b, it is ready to be compressed by the first reciprocating piston 182. The hydraulic cylinder chamber 1186a is supplied with pressurized hydraulic fluid by the hydraulic fluid supply system 1155, for example, as described above. This drives the hydraulic piston 1154a, along with the piston rod 194, the first and second reciprocating pistons 182, 282 and hydraulic piston 1254b attached to the piston rod 194, in the direction indicated by direction arrow 212 in FIG. 7. As this is occurring, hydraulic fluid in the hydraulic cylinder chamber 1186b will be forced out of the hydraulic fluid chamber 1186b and may be handled by the hydraulic fluid supply system 1155 as described above.

As the hydraulic piston 1154a, along with the piston rod 1194, the first and second reciprocating pistons 182, 282 and the hydraulic piston 1154b attached to the piston rod 1194, move in the direction indicated by direction arrow 212 in FIG. 7, working fluid is drawn from piping 124, through connector device 150, and into the first compression chamber 181a due to the drop in gas pressure in the first compression chamber 181a relative to the piping 124 and the outside of the connector device 150. Simultaneously, the movement of the first reciprocating piston 182 compresses the working fluid that is already present in the second compression chamber 181b. Once the working fluid pressure in the second compression chamber 181b reaches the threshold level of check valve 1161, the pressurized working fluid will be able to exit the second compression chamber 181b and pass through the connector device 161 into the first pressurized working fluid distribution line 208 for delivery to fourth compression chamber 281b.

Simultaneously, working fluid is drawn from the first pressurized working fluid distribution line 206, through connector device 250, and into the third compression chamber 281a due to the drop in gas pressure in the third compression chamber 281a relative to the first pressurized working fluid distribution line 206 and the outside of the connector device 250. Simultaneously, the movement of the second reciprocating piston 282 compresses the working fluid that is already present in the fourth compression chamber 281b. Once the working fluid pressure in the fourth compression chamber 281b reaches the threshold level of check valve 1261, the pressurized working fluid will be able to exit the fourth compression chamber 281b and pass through the connector device 261 into the second pressurized working fluid output pressure distribution line 209.

The foregoing movement and compression of working fluid and hydraulic fluid continue as the first and second reciprocating pistons 182, 282 move in the direction indicated by direction arrow 212 to an end of stroke position (i.e., the furthest position of reciprocating pistons 182, 282 prior to reversal of direction). Just before the hydraulic piston 1154a reaches the end of stroke position, a position sensor (similar to the position sensor 157a described above with respect to compressor apparatus 126) detect the presence of the hydraulic piston 1154a within the hydraulic cylinder 1152a at a longitudinal position that is a short distance before the end of the stroke within the hydraulic cylinder 1152a. The position sensor will then send a second position signal 2210 to the controller 207, in response to which the controller 207 will reconfigure the operational mode of the hydraulic fluid supply system 1155 as described above. This will result in the hydraulic piston 1154a not being driven any further to the right in the hydraulic cylinder 1152a.

Once the hydraulic piston 1154a, along with the piston rod 1194, the first and second reciprocating pistons 182, 282 and the hydraulic piston 1154b attached to the piston rod 1194, are at their end of stroke positions: Working fluid will have been drawn through the first input valve and connector device 150 so that the first compression chamber 181a is once again filled. Working fluid will have been drawn through the third input valve and connector device 250 so that the third compression chamber 281a is once again filled. The controller 207 then sends a signal to the hydraulic fluid supply system 1155 so that the gas compressor apparatus 1126 is ready to commence another cycle of operation.

### Interstage Cooling

As will be appreciated, the first, second, third and fourth compression chambers 181a, 181b, 281a, 281b are axially aligned and the first and second reciprocating pistons 182, 282, the controller 207, and the hydraulic fluid supply system 1155 are configured to reciprocate the pistons to alternately provide the first compression stroke and second compression stroke in the compression chambers 181a, 181b, 281a, 281b, and to provide the first intake stroke and second intake stroke.

The first intake stroke (in the first and third compression chambers 181a, 281a) occurs during the second compression stroke (in the second and fourth compression chambers 181b, 281b) and the second intake stroke (in the second and fourth compression chambers 181b, 281b) occurs during the first compression stroke (in the first and third compression chambers 181a, 281a).

As will be appreciated, as working fluid is compressed in the compression chambers 181a, 181b, 281a, 281b, this necessarily results in heating of such matter and as such, heat may be transferred to the components of the compressor, resulting in potentially high operating temperatures of the compressor. In some embodiments, compressor apparatus 1126 may include a heat exchanger configured to receive a flow of working fluid and to lower the temperature of the working fluid. Interstage cooling, or intercooling of the working fluid, between the first gas compression cylinder 180 and second gas compression cylinder 280 helps lower the operating temperature of the compressor and the outlet temperature of the working fluid from the compressor.

In the embodiment shown, e.g. in FIG. 7, compressor apparatus 1126 may include heat exchangers 214, 216. Heat exchanger 214 is positioned in first pressurized working fluid distribution line 206 and receives first pressurized working fluid from first compression chamber 181a and is configured to lower the temperature of the first pressurized working fluid prior to entering the third compression chamber 281a. Heat exchanger 216 is positioned in first pressurized working fluid distribution line 208 and receives first pressurized working fluid from second compression chamber 181b and is configured to lower the temperature of the first pressurized working fluid prior to entering the fourth compression chamber 281b.

Whilst heat exchangers 214, 216 are shown in FIG. 7 as separate units, in some embodiments, heat exchangers 214, 216 may be combined into a single heat exchanger. In an embodiment, see e.g. FIG. 8, a heat exchanger represented as cooler 220 is used to cool the combined outlet from the pressurized working fluid distribution line 218 from first output valve and connector device 151 and second output valve and connector device 161 of first gas compression cylinder 180 prior to the first pressurized working fluid input suction distribution line 236 to third input valve and connector device 250 and fourth input valve and connector device 260 of second gas compression cylinder 280.

In various embodiments, heat exchangers 214, 216 and/or cooler 220 are finned tube, shell and tube or plate heat exchangers.

In some embodiments, heat exchangers 214, 216 and/or cooler 220 are brazed plate heat exchangers, for example a BrazePak™ brazed plate heat exchanger manufactured by Xylem™.

In some embodiments, heat exchangers 214, 216 and/or cooler 220 are liquid-liquid heat exchangers in communication with a supply of hydraulic fluid (or other suitable fluid) from a fluid reservoir. As the first pressurized working fluid passes though the heat exchanger, heat may be transferred from the first pressurized working fluid to the hydraulic fluid. The hydraulic fluid may be cooled, such as with an air cooler, before being returned to the reservoir.

In some embodiments, the compressor apparatus 1126 may include one or more temperature sensors configured to produce a temperature signal representing a temperature of the working fluid. The temperature signal(s) may be received by a controller, such as controller 207. In response to such signals, the controller 207 may modify the operation of the hydraulic fluid supply system 1155 to control parameters such as the speed of movement of hydraulic pistons 1154a, 1154b, thereby controlling the stroke rate of first and second reciprocating pistons 182, 282. For example, if the temperature of the working fluid increases to a threshold temperature, controller 207 modifies the operation of the hydraulic fluid supply system 1155 to slow the stroke rate of first and second pistons 182, 282, to maintain the temperature of the working fluid below a selected operating temperature. The threshold temperature and selected operating temperature may be selected based on factors such as a desired temperature of the working fluid or safe operating temperatures for components of compressor apparatus 1126.

In some embodiments, the selected operating temperature may be below about 350° F. Temperature sensors may be used, for example, to measure the discharge temperature of the working fluid from the first gas compression cylinder 180 and/or the second gas compression cylinder 280.

In some embodiments, the temperature sensors are resistance temperature detector (RTD) sensors to provide a temperature signal, for example in Ohms, to controller 207. In an embodiment, the temperature sensors are TR10-2 sensors manufactured by Wika.

Referring to FIG. 7, first and second temperature sensors 240 and 242 are configured to produce first and second temperature signals 244 and 246 respectively. First temperature sensor 240 is positioned in first pressurized working fluid distribution line 206 prior to heat exchanger 214 and second temperature sensor 242 is positioned in first pressurized working fluid distribution line 208 prior to heat exchanger 216. The first temperature signal 244 represents the temperature of the working fluid discharged from first compression chamber 181a, prior to heat exchanger 214. The second temperature signal 246 represents the temperature of the working fluid discharged from second compression chamber 181b, prior to heat exchanger 216. The first and second temperature signals 244 and 246 are provided to an indicator and/or a controller, such as controller 207. Additional temperature sensor(s) may be provided to measure the temperature of the working fluid at one or more locations between piping 124 and piping 130.

In some embodiments, instead of or in addition to heat exchangers 214, 216, or combined heat exchanger cooler 220, e.g. providing interstage cooling, the working fluid communication system may include a heat exchanger 135 (see FIG. 8) positioned in fluid communication with pressurized working fluid output distribution line 209, which receives pressurized working fluid from third and fourth compression chambers 281a, 281b and is configured to lower the temperature of the pressurized working fluid before the pressurized working fluid is discharged from the working fluid communication system, e.g. after-cooling. In some embodiments, the heat exchanger 135 lowers the temperature of the pressurized working fluid to about 120° F. or less before the pressurized working fluid is discharged from the working fluid communication system. This may be desirable, for example to bring the temperature of the pressurized working fluid within pipeline specifications.

### Variable Head Gap

In some embodiments compressor apparatus 1126 may utilize a variable head gap to vary the temperature and pressure of the first and/or second pressurized working fluid. In this embodiment, the controller 207 may control the reversal of piston rod 1194 as described above to vary how close to the gas cylinder heads 192a and 192b reciprocating piston 182 will move and how close to the gas cylinder heads 292a and 292b piston 282 will move, prior to reversal. By increasing the distance between piston 182, 282 and the respective gas cylinder heads prior to reversal the head loss/final volume may be increased, thereby lowering the pressure and temperature of the first and/or second pressurized working fluid. Conversely, by decreasing the distance between piston 182, 282 and the respective gas cylinder heads prior to reversal the head loss/final volume may be decreased, thereby lowering the pressure and temperature of the first and/or second pressurized working fluid.

### Working Fluid Communication System: Second Embodiment

With reference to FIG. 8, another embodiment of a working fluid communication system for compressor apparatus 1126 is illustrated. In this embodiment, a first pressurized working fluid distribution line 218 fluidly interconnects first output valve and connector device 151 and second output valve and connector device 161 for receiving the first pressurized working fluid from first and second compression chambers 181a, 181b. Distribution line 218 is also fluidly interconnected to a cooler 220, which may be similar to heat exchangers 214, 216 described above.

Cooler 220 also receives a supply of hydraulic fluid (or other suitable heat transfer fluid) from a fluid reservoir 222 via fluid communication line 224 and pump 226. As the first pressurized working fluid passes though the cooler 220, heat may be transferred from the first pressurized working fluid to the hydraulic fluid. Cooler 220 is also in communication with an air cooler 228 via fluid communication line 230, where the hydraulic fluid, heated by the first pressurized working fluid, can be cooled before being passed through a fluid communication line 232 to a reservoir 234. In some embodiments, reservoirs 222 and 234 may be a common shared reservoir, where the hydraulic fluid circulates in a closed loop.

First pressurized working fluid that has been cooled in cooler 220 is communicated to a first pressurized working fluid input suction distribution line 236 which fluidly interconnects the heat exchanger 320 with the input valve and connector device 250 and the input valve and connector device 260 for communication of first pressurized working fluid to the third and fourth compression chambers 281a, 281b.

In some embodiments, the hydraulic fluid circulated through heat exchanger 220 is shared with the hydraulic fluid used in hydraulic fluid supply system 1155, i.e., reservoirs 222, 234 and 1172 are a common shared reservoir. Cooler 220 maintains complete separation between the hydraulic fluid received from reservoirs 222 and 234 and the working fluid, avoiding any contamination of the working fluid in cooler 220.

Similar to as described above, the working fluid communication may include a first temperature sensor 1240 configured to produce a first temperature signal 1244. The first temperature signal 1244 represents the temperature of the working fluid discharged from first and second compression chambers 181a and 181b, prior to cooler 220. The first temperature signal 1244 is provided to a controller, such as controller 207 and similar to as described above, in response to signal 1244, the controller 207 may modify the operation of the hydraulic fluid supply system 1155 to control parameters such as the speed of movement of hydraulic pistons 1154a, 1154b, thereby controlling the stroke rate of first and second pistons 182, 282 and controlling the temperature of the pressurized working fluid.

### Working Fluid Communication System: Third Embodiment

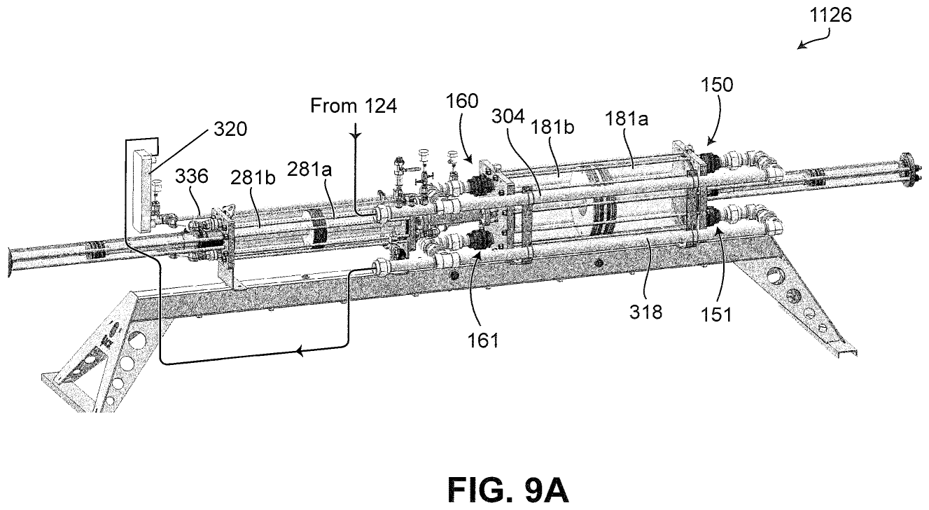

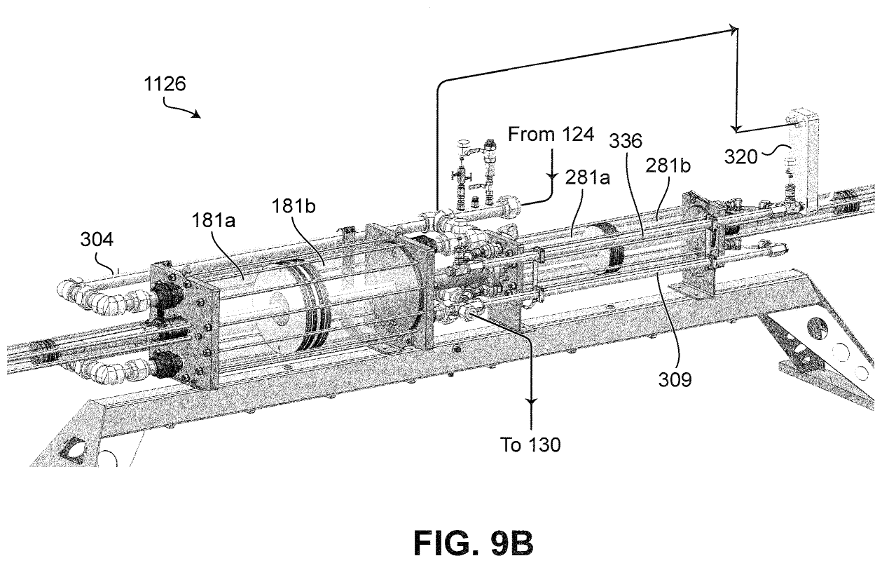

With reference to FIGS. 9A-9B, another embodiment of a working fluid communication system for compressor apparatus 1126 is illustrated. Similar to as described above, the working fluid communication system includes a working fluid input suction distribution line 304 (similar to input suction distribution line 204 described above) which fluidly interconnects first input valve and connector device 150 with second input valve and connector device 160.

The working fluid communication system also includes a first pressurized working fluid distribution line 318 (similar to fluid distribution line 218 described above) which fluidly interconnects first output valve and connector device 151 and second output valve and connector device 161 for receiving the first pressurized working fluid from first and second compression chambers 181a, 181b. The first pressurized working fluid distribution line 318 is also fluidly interconnected to a heat exchanger 320 (which may be similar to heat exchanger 214, 216 and/or cooler 220).

First pressurized working fluid that has been cooled in heat exchanger 320, is communicated to first pressurized working fluid input suction distribution line 336 which fluidly interconnects the heat exchanger 320 with the third input valve and connector device 250 and the fourth input valve and connector device 260 for communication of first pressurized working fluid to the third and fourth compression chambers 281a, 281b.

A second pressurized working fluid output pressure distribution line 309 fluidly interconnects third output valve and connector device 251 with fourth output valve and connector device 261.

Third Embodiment: Two Stage Compressor with Inter-stage Seal Turning now to FIGS. 10A-10F, a third embodiment of the common rod multi-stage compressor apparatus is shown generally at 2126. Compressor apparatus 2126 may be generally similar to compressor apparatus 126, 1126 and includes a compressor portion 1136 located between the two hydraulic cylinders 1152a, 1152b. The general operation of hydraulic cylinders 1152a, 1152b is described above with respect to compressor apparatus 126, 1126.

Piston rod 1194 of compressor apparatus 2126 may be formed in a plurality of sections, for example three sections: piston rod sections 1194a, 1194b and 1194c. Outer piston rod sections 1194a and 1194b may each be interconnected to central section 1194c and first and second reciprocating pistons 182, 192 respectively such as with a threaded or other connection. Outer piston rod sections 1194a and 1194b are also connected to hydraulic pistons 1154a, 1154b at their outer ends such as with a threaded connection.

Gas, liquid, solid material and contaminant seals may be provided at the connection of the hydraulic cylinders 1152a, 1152b and the respective cylinder heads 192a, 292b to prevent leakage from inside the respective chambers, therebetween. Seal devices 198, 298 are also provided at cylinder heads 192b, 292a to seal second and third compression chambers 181b, 281a respectively where piston rod section 1194c passes through the axially oriented openings in cylinder heads 192b, 292a.

With particular reference to FIGS. 11A-11D and 12, seal devices 198, 298 may be formed in a substantially identical manner and be generally mounted within respective central openings of gas cylinder heads 192a, 292b and within a portion of a housing 202. Housing 202 may be generally cylindrical and is sized to receive a portion of piston rod 1194, e.g. piston rod section 1194c therewithin for reciprocating movement. A first end 202a of housing 202 is configured to be attached to second gas cylinder head 192b of first gas compression cylinder 180 and a second end 202b of housing 202 is configured to be attached first gas cylinder head 292a of second gas compression cylinder 280, such as by bolts that are received in corresponding openings within the cylinder heads 192b, 292a. Housing 202 may in part be used to interconnect gas compression cylinders 180, 280 and increase the strength and rigidity of compressor apparatus 2126.

Housing 202 may receive a suitable lubricating fluid, such as grease, in order to provide lubrication for piston rod 1194 and seal devices 198, 298.

Housing 202 may include a vent 202c for communication of any build up of gas pressure or excess lubricating fluid from within housing 202. The vent 202c may be in fluid communication with a holding tank, such as the holding tank 1217 described above with respect to buffer chambers 195a, 195b or a separate holding tank. Alternatively, vent 202c may be utilized to provide suitable lubricating fluid, such as grease, in order to provide lubrication for piston rod 1194 and seal devices 198, 298.

In an embodiment disclosed, vent 202c may be in fluid communication with pressurized gas regulator system 217 described above. Due the different pressures involved, pressurized gas regulator system 217 may provide buffer gas at a pressure suitable and relative to housing 202c and adjacent compression chambers 181b, 281a. In an embodiment disclosed, vent 202c may be in fluid communication with buffer chambers 195a, 195b.

In addition to seal devices 198, 298 described above at first and second ends 202a, 202b of housing 202, similar seals are provided where piston rod 194 goes through cylinder heads 192a, 292b. In an embodiment disclosed, seal devices 198, 298 may be provided in cylinder heads 192b, 292a rather than received in housing 202.

Seal device 198 (typical) is shown in more detail in FIG. 12 and may comprise a pump sealing gland 3200a, a pump rod seal 3202a, a pump gland follower 3203a, a pump rod seal spring 3204a and an O-ring. Pump sealing glands 3200a may be made from a suitable material such as mild or stainless steel. Pump rod seal 3202a may comprise a plurality of v-rings and lantern rings. Pump rod seal 3202a components may be made from a combination of materials such as for example, rubber, fabric, brass or a combination thereof.

In some embodiments, additional O-rings may be provided to provide a seal around pump sealing gland 3200a, for example between pump sealing gland 3200a and housing 202 and between gland 3200a and cylinder head 192b. Seal device 298 may be configured in a similar manner from substantially identical components as seal device 198 and may comprise a corresponding pump sealing gland, pump rod seal, a pump gland follower, a pump rod seal and an O-ring.

A seal 198 (typical) at first gas cylinder head, having pump rod seal spring 3204 a exerts a force upon pump gland follower 3203a, which in turn applies pressure to pump rod seal 3202a, sealing piston rod section 1194a within the central opening of first gas cylinder head 192a and the interior surface of hydraulic cylinder 1152 a. A seal 198 (typical) at second gas cylinder head 292b, similarly seals piston rod section 1194b within central opening second gas cylinder 292b and the interior surface of hydraulic cylinder 1152b.

The seal devices 198, 298 may also assist to guide piston rod section 1194c, keep piston rod section 1194c and the interconnected piston rod sections 1194a and 1194b centered in the compression chambers 181a, 181b, 281a, 281b and absorb transverse forces exerted upon piston rod sections 1194a, 1194b, 1194c.

In other embodiments, seal devices 198, 298 may comprise a plurality of v-rings and lantern rings may be made from a combination of materials such as for example, rubber, fabric, brass or a combination thereof. For example, components of seal devices 198, 298 may be made from Viton™ or polytetrafluoroethylene (PTFE) (e.g. Teflon™).

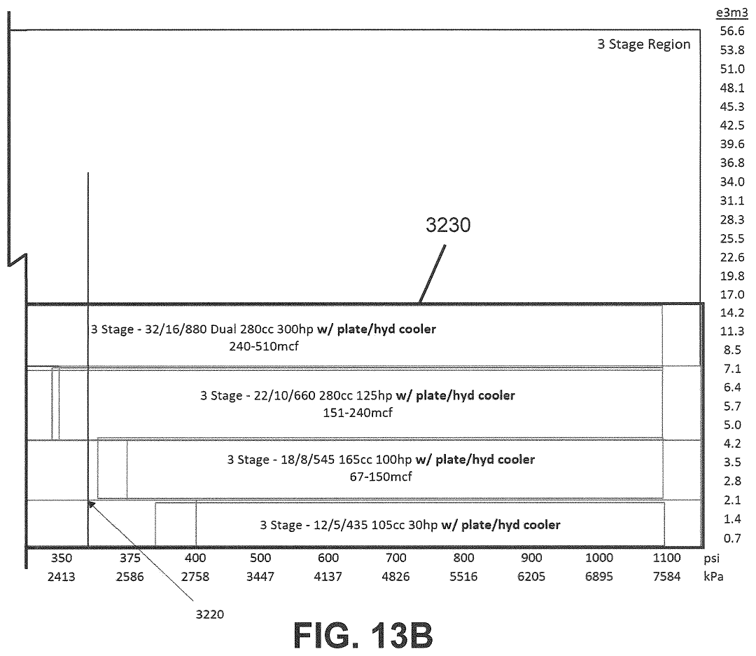

With reference to FIGS. 13A-13B, a chart showing discharge pressure against volume for various general examples of single and multistage compressors of the present disclosure is shown.

As indicated in FIGS. 13A-13B, a combination of compressor sizes, series operation/stages, parallel operation, and working fluid cooling provide a wide range of flow rates and discharge pressures. In some applications, a design maximum temperature may be selected, which should not be exceeded by the working fluid, for example 350° F. In some applications, a maximum temperature may be set for delivery of the working fluid, for example about 120° F. Therefore multiple-stages, for example 2-stage, 3-stage, or more, and in some cases interstage and/or outlet cooling of the working fluid, may be used to achieve the desired conditions.

Generally speaking, with an inlet or suction pressure of about 0.25 psi (4 oz/in² ), for example, common for vapor recover unit (VRU) applications, then below (to the left of) line 3210, a single-stage of compression may provide the required differential pressure/outlet pressure, e.g. because a 1^{st} stage delta above (to the right of) line 3210 exceeds a temperature threshold for a single stage of compression, and above (to the right of) line 3220, three-stages of compression may provide the required differential pressure/outlet pressure, e.g. because a 2^{nd} stage delta above (to the right of) line 3220 exceeds a temperature threshold for two-stages of compression.

The examples of FIGS. 13A-13B are merely examples of select configurations, with considerable overlap of differential pressure and flow rate, and alternate options and configurations available.

Regarding the nomenclature of and referring to FIGS. 13A-13B, as an example “1645/75 hp 76-125 mcf” refers to compressor using having 16″ inner diameter (ID) gas compression cylinder and a 4.5″ inner diameter (ID) hydraulic cylinder, and requires about 75 hp and is suitable for about 76-125 mcf for the discharge pressures indicated, with an inlet pressure of about 0.25 psi.

As a further example “2× 2260/125-150 hp 251-500 mcf” refers to two units of a compressor having a 22″ ID gas compression cylinder and a 6.0″ ID hydraulic cylinder, and requires about 125-150 hp and is suitable for about 251-500 mcf for the discharge pressures indicated, with an inlet pressure of about 0.25 psi.

As a further example “2stage—22-12-45—100 hp/plate/hyd cooler 151-250 mcf” refers to a common drive rod compressor of the present disclosure having a 22″ ID first compressor and a 12″ ID second compressor with a 4.5″ ID hydraulic cylinder, and requires about 100 hp, utilizing plate/hydraulic cooler, and is suitable for about 151-250 mcf for the discharge pressure indicated, with an inlet pressure of about 0.25 psi.

As a further example “3 stage—22/10/660 280 cc 125 hp w/plate/hyd cooler 151-240 mcf” refers to a common drive rod compressor of the present disclosure having a 22″ ID first compressor, a 10″ ID second compressor, a 6″ ID third compressor, with a 6.0″ ID hydraulic cylinder, and requires about 125 hp, utilizing plate/hydraulic cooler, and is suitable for about 151-240 mcf for the discharge pressure indicated, with an inlet pressure of about 0.25 psi.

As illustrated in FIGS. 13A-13B, a multi-stage common drive rod compressor of the present disclosure may provide mid-to high-differential pressures within a single machine, see e.g. outline 3230, utilizing a single hydraulic fluid supply system 1155 (FIG. 5). This may be particularly useful, for example, in VRU systems, e.g. having a relatively low inlet pressure. This may also be particularly useful, for example, where a relatively high outlet pressure is required, such a recompression of produced gas, for example from a well casing, in order to deliver the gas to a clean up process, a pipeline, a disposal well, a flare, or other destination.

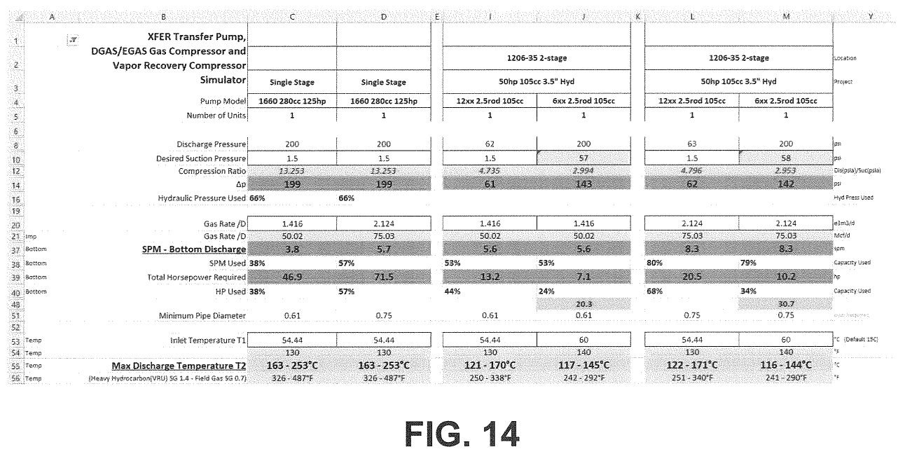

With reference to FIG. 14, a compression chart showing various parameters of examples of single and multi-stage compressors of the present disclosure is shown.

As shown in the chart, columns C and D represent simulation of parameters of single stage compressors at 50 and 75 thousand cubic feet per day (mcf/d).

Columns I and J are a simulation of parameters of a comparable 2-stage compressor at 50 mcf/d. As shown in the chart, the 2-stage compressor uses 20.3 HP in comparison to 46.9 HP used by a comparable single stage compressor (column C). The compressor of columns I and J uses interstage cooling to reduce the temperature between the first and second stages from about 250° F. to about 140° F.

Columns L and M are a simulation of parameters of a comparable 2-stage compressor at 75 mcf/d. As shown in the chart, the 2-stage compressor uses 30.7 HP, in comparison to 71.5 HP used by a comparable single stage compressor (column D). The compressor of columns L and M uses interstage cooling to reduce the temperature between the first and second stages from about 251° F. to about 140° F.

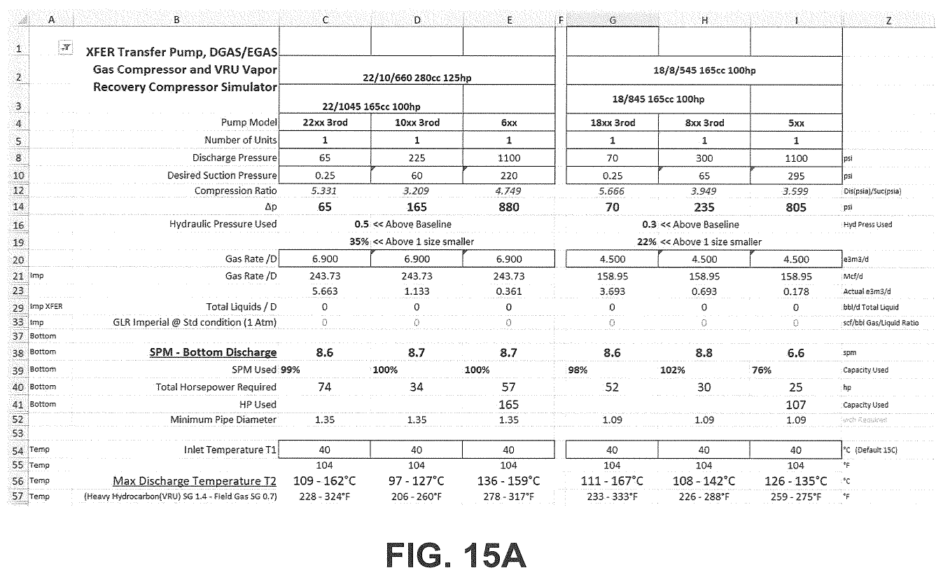

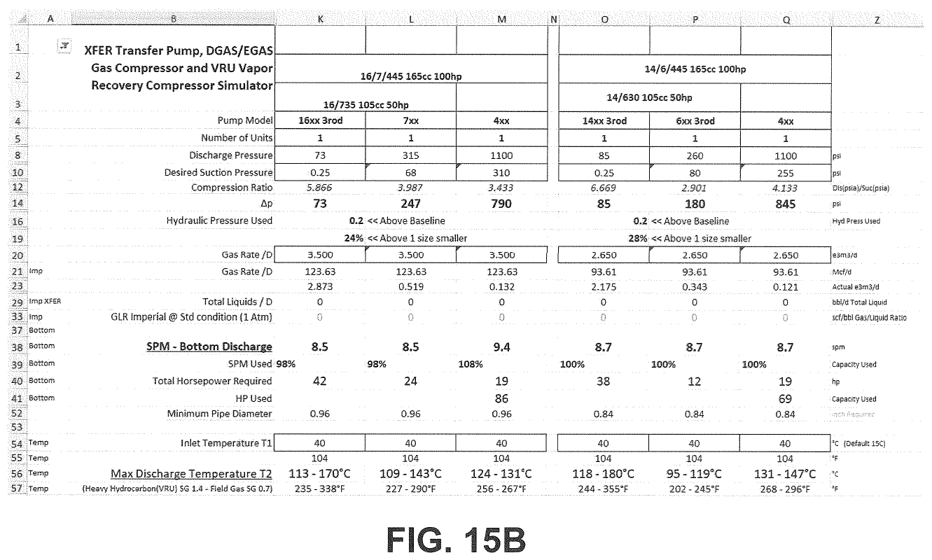

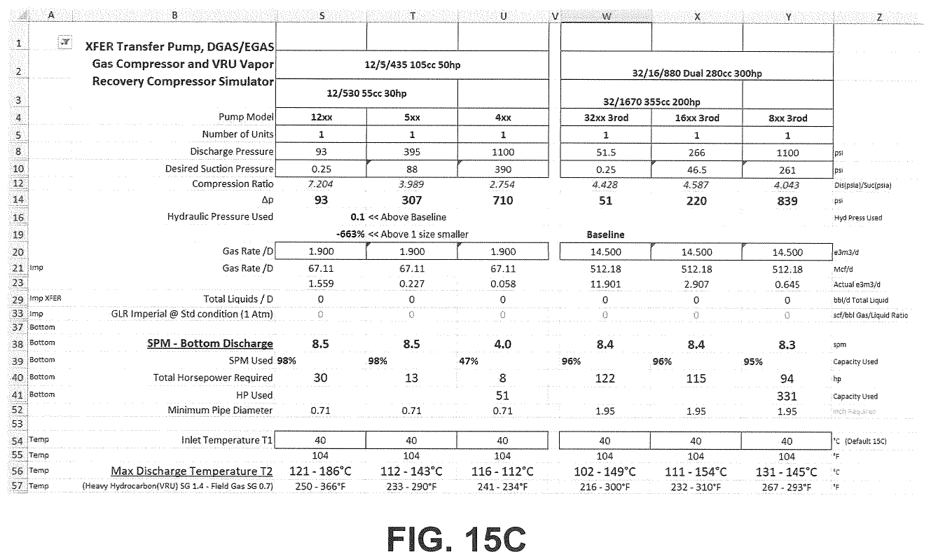

With reference to FIGS. 15A-15C, another compression chart showing various parameters of examples of multi-stage compressors of the present disclosure is shown. In particular, examples of 3-stage compressors are shown. In these examples, the initial inlet/suction pressure is about 0.25 psi, as one might encounter in a low pressure system, for example a VRU, with multi-stage compression to about 1100 psi. As indicated above, gas compressor portion 136 of compressor apparatus 126 may comprise any suitable number of gas compression cylinders, for example two, three, four, five, six or more gas compression cylinders.

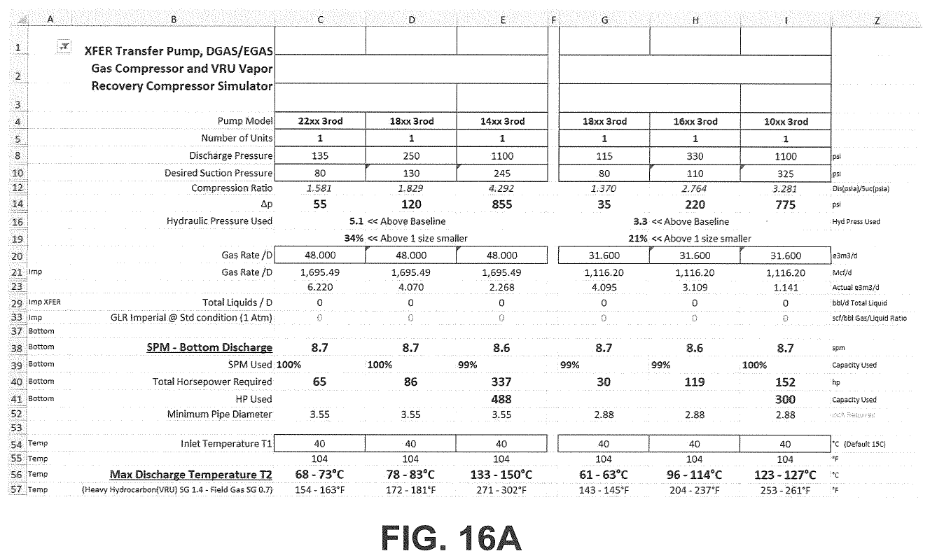

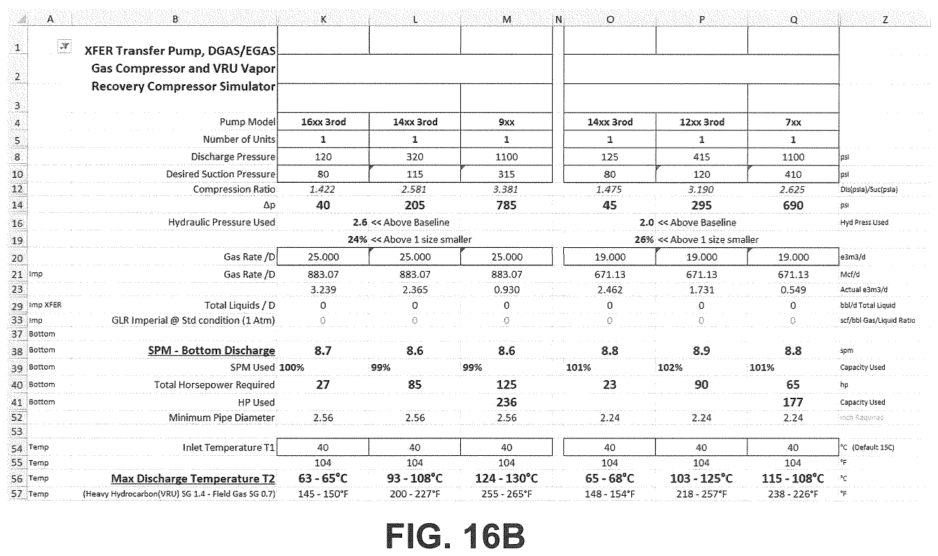

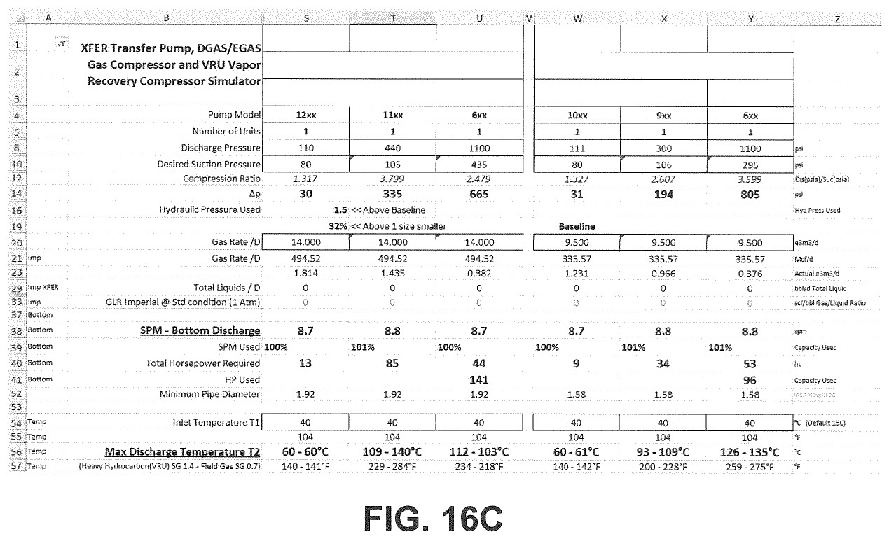

With reference to FIGS. 16A-16C, another compression chart showing various parameters examples of multi-stage compressors of the present disclosure is shown. In these examples, the inlet/suction pressure is about 80 psi, as one might encounter for example in an oil and gas well system 100, with multi-stage compression to about 1100 psi. In particular, examples of 3-stage compressors are shown. As indicated above, gas compressor portion 136 of compressor apparatus 126 may comprise any suitable number of gas compression cylinders, for example two, three, four, five, six or more gas compression cylinders.

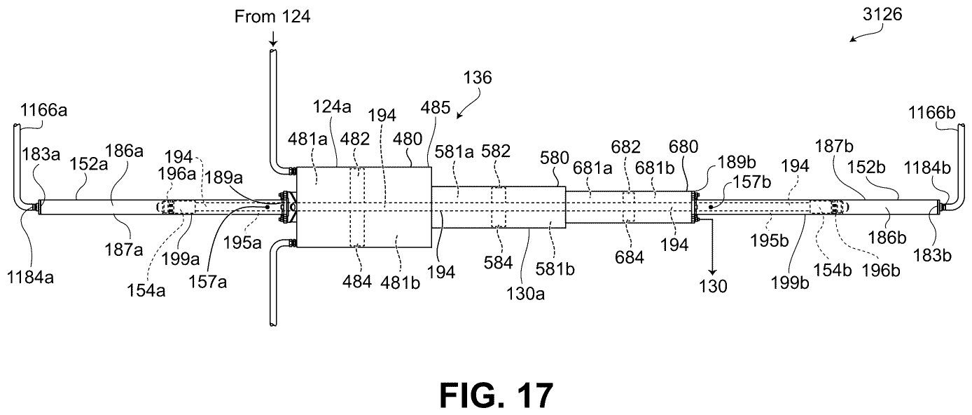

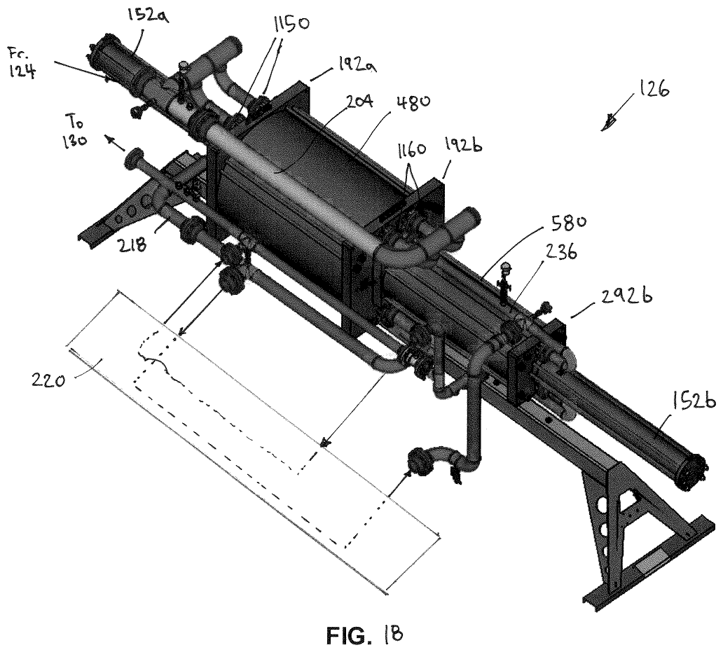

With reference to FIG. 17, another embodiment of the compressor apparatus 126, 3126 is depicted. In this embodiment, compressor apparatus 3126 includes a third gas compression cylinder 680, divided into fifth and sixth axially aligned compression chambers 681a, 681b by a third reciprocating gas piston 682. Third reciprocating gas piston 682 may include piston seal device 684, generally similar to piston seal devices 484, 584 described above.

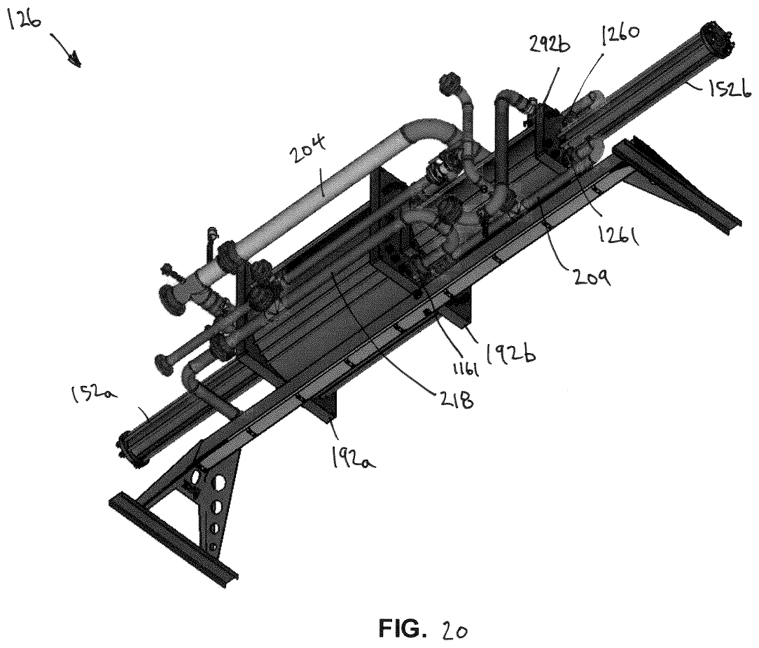

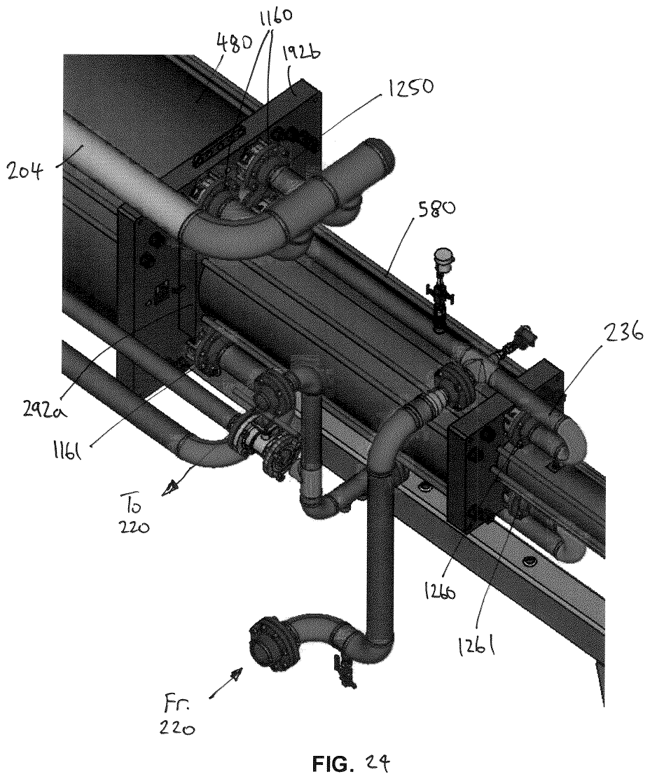

As described herein above, a multi-stage compressor of the present disclosure may include two or more compression cylinders. In axially spaced embodiments, the compression cylinders may be spaced apart axially, e.g. as in FIGS. 6, 8. In axially adjacent embodiments, the compression cylinders may be substantially axially adjacent, e.g. as in FIGS. 4, 17-24. Axially adjacent embodiments may provide, for example, a more compact overall axial length than axially spaced embodiments. This may reduce a footprint required for transport and/or installation of the compressor 126 and hydraulic fluid supply and control system, e.g. as in FIG. 5. In addition, reducing the overall length of piston rod 194 and/or reducing relative flexibility between compressor cylinders, e.g. first gas compression cylinder 480 and second gas compression cylinder 580, and/or second gas compression cylinder 580 and third gas compression cylinder 680 as applicable may improve reliability of the multi-stage compressor.

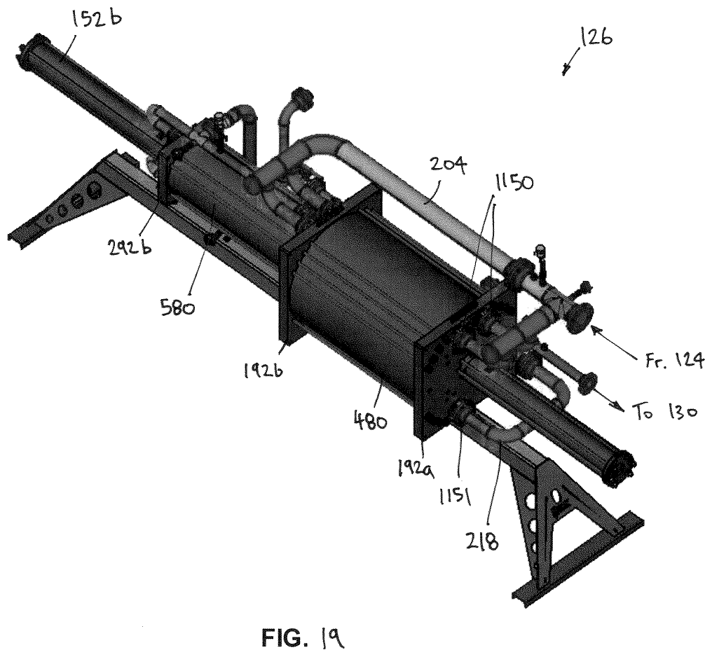

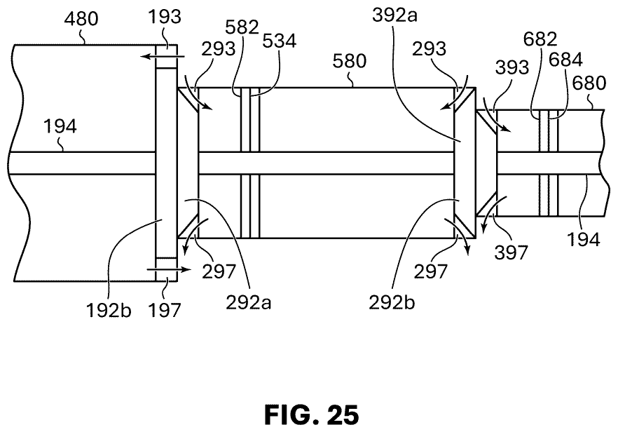

Referring to FIGS. 18-25, the illustrated axially adjacent embodiment of the multi-stage compressor 126 is similar to that of the axially spaced embodiments shown of the multi-stage compressor 1126 in FIGS. 6, 8, etc. with similar components and operation as illustrated in FIGS. 1-17, except without axially spacing between the second head 192b of the first gas compression cylinder 480 and the first head 292a of the second gas compression cylinder 580. In addition, the three-stage illustration of FIG. 25 is similar to that of FIG. 17. Unless otherwise indicated, the same reference numerals are used in FIGS. 18-25 to denote the same or functionally similar elements previously described. In axially adjacent embodiments, a connection is made between adjacent compression cylinders, e.g. directly or indirectly. In some embodiments, the connection may utilize a single plate, having the requisite inlet(s) and outlet(s) for at least one and optionally both compression cylinders axially adjacent to the plate. In some embodiments, the connection is provided by a connector plate 485 described above. In some embodiments, the connection may be provided by a plate, machined billet, cast steel, rolled steel or other mechanical connection. The connection may be made by a unitary single-piece component or an assembly of multiple components. In some embodiments disclosed, the connection may be provided by connecting adjacent gas cylinder heads.

In some embodiments, the connection may provide several functions. These functions may include i) a gas cylinder head of at least one axially adjacent gas compression cylinder, ii) a gas cylinder head of two axially adjacent gas compression cylinders; iii) an inlet or inlets of at least one axially adjacent gas compression cylinder, iv) an inlet or inlets of two axially adjacent gas compression cylinders; v) an outlet or outlets of at least one axially adjacent gas compression cylinder, vi) an outlet or outlets of two axially adjacent gas compression cylinders; vii) a mount or mounts for one or more check-valves of at least one axially adjacent gas compression cylinder, viii) a mount or mounts for one or more check-valves of two axially adjacent gas compression cylinders; ix) join two axially adjacent gas compression cylinders; and x) any combination or sub-combination thereof.

In some embodiments one or more inlets and/or one or more outlets may be radial and/or axial. In some embodiments, combinations of radial and/or axial inlets and/or outlets may be utilized.

In some embodiments, a plurality of inlets and/or outlets may be provided, i.e. instead of a single inlet and/or outlet. One reason for this may be to fit the required piping, e.g. diameter required to provide the total flow area required, into the available radial space. For example, there may be limited radial space between the outer diameter of the hydraulic cylinder 152a and the outer diameter of the first gas compression cylinder 480; between the outer diameter of the first gas compression cylinder 480 and the outer diameter of the second gas compression cylinder 580; between the outer diameter of the second gas compression cylinder 580 and the outer diameter of the hydraulic cylinder 152b; and/or between the outer diameter of the second gas compression cylinder 580 and the outer diameter of the third gas compression cylinder 680, and between the outer diameter of the third gas compression cylinder 680 and the outer diameter of the hydraulic cylinder 152b in a three-stage compressor; and so on. Another reason may to be to offset the necessary piping, for example illustrated in FIG. 24. Providing two inlets into the first gas compression cylinder 480, spaced apart laterally, provides additional spacing for the inlet into the second gas compression cylinder 580, e.g. centrally located between the two inlets of the first gas compression cylinder 480. In an embodiment disclosed, instead of two inlets into the first gas compression cylinder 480 (see e.g. FIG. 24), a single, laterally offset inlet may be provided, e.g. one or the other of the inlets illustrated in FIG. 24, which still provides additional spacing for the inlet into the second gas compression cylinder 580.

In particular, a plurality of inlets may be provided on the first stage inlet, where the inlet pressure is from a vapor recovery unit (VRU) or other very low, e.g. near zero psig/kPag source, requiring a relatively larger flow area (e.g. diameter) than subsequent outlet(s)/inlet(s) at increasing pressure requiring a relatively decreasing flow area (e.g. diameter). However, a plurality of inlets and/or outlets may be provided on any stage.

Referring generally to FIGS. 18-25, compressor apparatus 126 having a first gas compression cylinder 480 and second gas compression cylinder 580 may utilize a connection wherein second gas cylinder head 192b of first gas compression cylinder 480 and first gas cylinder head 292a of second gas compression cylinder 580 are connected. As shown, the gas cylinder heads are directly connected. However, indirect connection is also contemplated by the present disclosure, for example through one or more intermediate members, e.g. plate(s) or other body(ies) between the second gas cylinder head 192b and the first gas cylinder head 292a.

In an embodiment disclosed, a seal may be provided between second gas cylinder head 192b of first gas compression cylinder 480 and first gas cylinder head 292a of second gas compression cylinder 580. The seal may include an O-ring, circling the piston rod 194. A corresponding groove for the O-ring may be provided in the second gas cylinder head 192b of first gas compression cylinder 480 or the first gas cylinder head 292a of second gas compression cylinder 580 or both. As such, the seal, e.g. O-ring, provides secondary sealing, e.g. in the event that the seal device between the piston rod 194 and the second gas cylinder head 192b of first gas compression cylinder 480 and/or the seal device between the piston rod 194 and the first gas cylinder head 292a of second gas compression cylinder 580 leaks. The seal, e.g. O-ring may also assist in aligning the heads axially, e.g. when assembling the compressor to connect the adjacent heads, before the heads are fastened together, for example with fasteners which may include bolts and/or studs/nuts. In an embodiment disclosed, two radially spaced-apart O-rings may be provided, for example concentric with the axis of the compressor 126 and piston rod 194.

In this example configuration, the second gas cylinder head 192b of first gas compression cylinder 480 includes sufficient radial space to provide a mount for axial inlet one-way check valves 1160 (two thereof-one for each of the dual inlets illustrated), a mount for axial outlet one-way check valve 1161, and connects with first gas cylinder head 292a of second gas compression cylinder 580 (see e.g. FIG. 24).

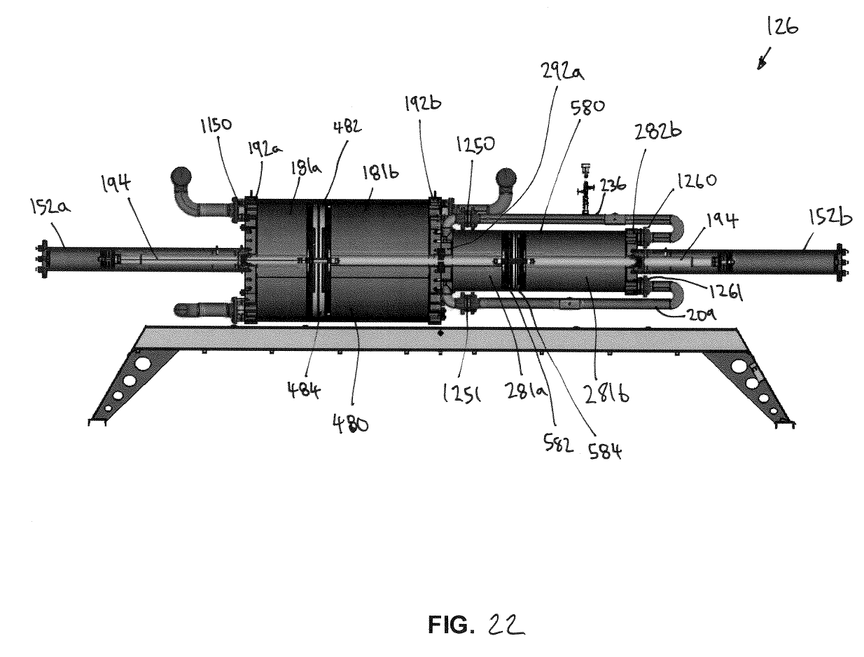

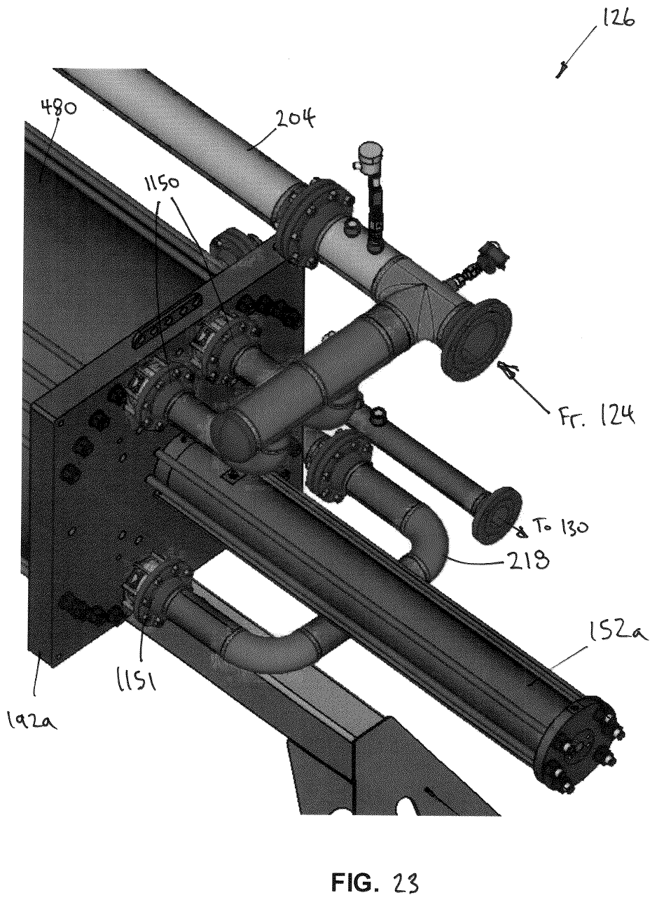

The first gas cylinder head 292a of second gas compression cylinder 580 includes a radial inlet, a radial outlet, and connects with the second gas cylinder head 192b of first gas compression cylinder 480 (see e.g. FIGS. 22, 25). Due to the radial inlet/outlet, inlet one-way check valve 1250 and outlet one-way check valve 1251 are configured in the piping, e.g. proximate the first gas cylinder head 292a in first pressurized working fluid input suction distribution line 236 and in second pressurized working fluid output distribution line 209, respectively, rather than directly connected to the second gas cylinder head 192b.

Internal flow passages extend though the gas cylinder heads to provide fluid communication between the interior of the respective gas cylinder and an outer opening of the gas cylinder head. Referring to FIGS. 22, 25 internal inlet flow passage 193 and internal outlet flow passage 197 extend through second gas cylinder head 192b in an axial configuration to permit inlet and outlet flow (see e.g. path/arrows), and internal inlet flow passage 293 and internal outlet flow passage 297 extend through first gas cylinder head 292a in a radial-axial configuration to permit inlet and outlet flow (see e.g. path/arrows). Referring to FIG. 25, internal inlet flow passage 293 and internal outlet flow passage 297 extend through second gas cylinder head 292b in a radial-axial configuration to permit inlet and outlet flow (see e.g. path/arrows), and internal inlet flow passage 393 and internal outlet flow passage 397 extend through first gas cylinder head 392a in a radial-axial configuration to permit inlet and outlet flow (see e.g. path/arrows).

A seal may be provided between second gas cylinder head 292b of second gas compression cylinder 580 and first gas cylinder head 392a of third gas compression cylinder 680. The seal may include an O-ring, circling the piston rod 194. A corresponding groove for the O-ring may be provided in the second gas cylinder head 292b of second gas compression cylinder 580 or the first gas cylinder head 392a of third gas compression cylinder 680 or both. As such, the seal, e.g. O-ring, provides secondary sealing, e.g. in the event that the seal device between the piston rod 194 and the second gas cylinder head 292b of second gas compression cylinder 580 and/or the seal device between the piston rod 194 and the first gas cylinder head 392a of third gas compression cylinder 680 leaks. The seal, e.g. O-ring may also assist in aligning the heads axially, e.g. when assembling the compressor to connect the adjacent heads, before the heads are fastened together, for example with fasteners which may include bolts and/or studs/nuts. In an embodiment disclosed, two radially spaced-apart O-rings may be provided, for example concentric with the axis of the compressor 126 and piston rod 194.

The outlet from the first compression cylinder is directed to a cooler, e.g. similar to 220 (see FIG. 8), which cools the working fluid before the working fluid is conveyed to the inlet of the second compression cylinder.

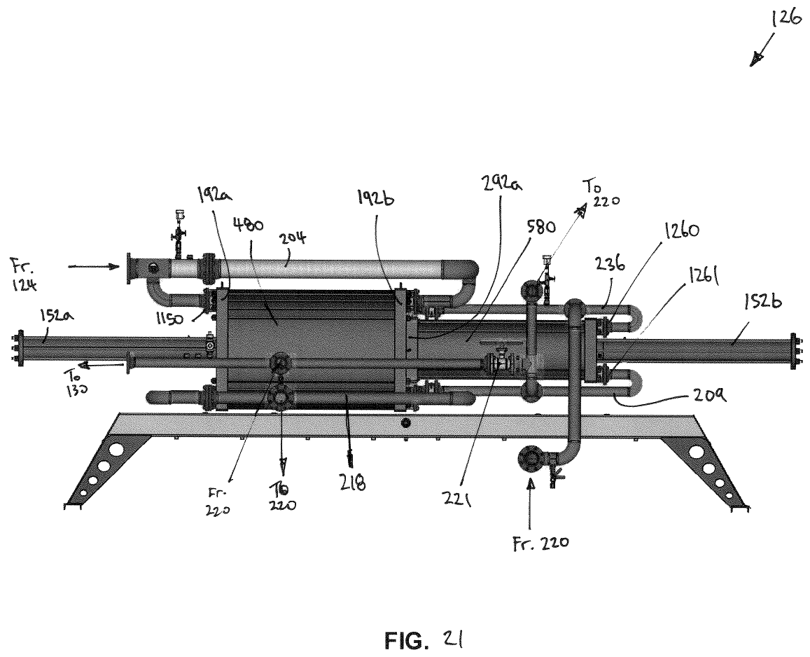

Depending on the stream composition and properties, it may be that liquids and/or solids drop out of the vapor phase and results in condensed liquid and/or precipitated solids, for example as the working fluid pressure changes and/or as the working fluid temperature is reduced in cooler 220. Referring to FIG. 21, valve 221 may be used to bypass cooler 220 after the last stage of the compressor 126.

When the compressor is used in a vapor recovery unit (VRU), unlike conventional compressor systems, the compressor is very tolerant of liquids. In contrast, VRUs using conventional compressors tend to require one or more separator vessel, sometimes referred to as a scrubber or separator to ensure that liquid(s) are not conveyed to the inlet of such compressors. A separator vessel may receive the working fluid, possibly containing gas (vapor), liquid, and/or multiphase fluids, and separates non-vapors by gravity. In a simple configuration, the working fluid is received mid-height into the separator vessel and liquids and/or solids drop to the bottom leaving the vapors to exit upper or top of the separator vessel. However, the liquid tolerance of the compressor disclosed herein may permit a VRU to operate without need of a separator vessel, saving capital cost, operating cost, and footprint. In an embodiment disclosed, the working fluid is conveyed directly, without vapor/liquid separation, from the tank 2602 to the working fluid input suction distribution line 204 of compressor 126, and/or from the pressurized working fluid distribution line 218 to the cooler 220, and/or from the cooler 220 to the first pressurized working fluid input suction distribution line 236, and/or from the second pressurized working fluid input suction distribution line 209 to the cooler 220, and/or from the cooler 220 to piping 2618, and/or combinations and/or permutations thereof. In an embodiment disclosed, the working fluid is conveyed from the tank 2602 all the way through and direct to piping 2618 without intermediate phase separation, e.g. without any separator vessel.

Among the many possible uses of the compressor disclosed herein, it may be advantageously used with a vapor recovery unit (VRU). In the types of VRU using produced gas or field gas, the compressor may be utilized to draw pressure off the tank when/if needed, and compress the vapor for use. Possible uses of the compressed vapor, e.g. in piping 2618, may include return to a makeup gas system to provide vapor back to the tank, e.g. in the vapor space above the liquid in the tank, for example when the liquid level in the tank is drawn down. The compressed vapor, e.g. in piping 2618 may be used for other purposes, including but not limited to, delivery to a sales gas pipeline, delivery to a storage vessel, delivery to a flare or incinerator, delivery to a fuel gas system, or any combination thereof.

Vapors recovered by a VRU tend to include or consist of valuable hydrocarbons, e.g. which may be valuable light hydrocarbons evaporated from hydrocarbon liquids in the tank and/or field gas and/or sales gas used to charge the makeup gas system, and use of the compressor disclosed herein in a VRU helps facilitate recovery of such vapors.

In some embodiments, a portion of the compressed working fluid from one or more of the intermediate compression stages (i.e., any stage except the final compression stage) may be removed (via an outlet in the working fluid communication system) for further use or disposal, whilst the remainder of the compressed working fluid proceeds to the next compression stage(s).

When introducing elements of the present invention or the embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

Wherever applicable and practical, like reference numerals and/or like designations refer to like elements.

Embodiments of the invention may include any combinations of the methods and systems shown in the following numbered paragraphs. This is not to be considered a complete listing of all possible embodiments, as any number of variations can be envisioned from the description above.

Embodiment 1. A multi-cylinder fluid compressor operable to compress a working fluid, said multi-cylinder fluid compressor comprising: a first gas compression cylinder, divided into first and second axially aligned compression chambers by a first reciprocating gas piston, each of the first and second compression chambers of the first gas compression cylinder having an inlet and an outlet; a second gas compression cylinder, divided into third and fourth axially aligned compression chambers by a second reciprocating gas piston, each of the third and fourth compression chambers of the second gas compression cylinder having an inlet and an outlet; wherein the first gas compression cylinder and the second gas compression cylinder are axially aligned; a common piston rod extending through said first and second axially aligned compression cylinders and operably connected with the first reciprocating gas piston and the second reciprocating gas piston; first and second hydraulic cylinders positioned at opposite ends of the multi-cylinder fluid compressor, with the first and second compression cylinders therebetween to axially drive the common piston rod; wherein the first and second hydraulic cylinders are adapted to be actuated by a hydraulic fluid supply system to reciprocally drive the common piston rod and thereby the first reciprocating gas piston and the second reciprocating gas piston.

Embodiment 2. The multi-cylinder fluid compressor of Embodiment 1, further comprising: a seal device between the common piston rod and the first gas compression cylinder and a seal device between the common piston rod and the second gas compression cylinder; a piston seal device between the first reciprocating gas piston and the first gas compression cylinder; and a piston seal device between the second reciprocating gas piston and the second gas compression cylinder.

Embodiment 3. The multi-cylinder fluid compressor of Embodiment 1 or 2, wherein the first hydraulic cylinder is at a head of the first gas compression cylinder and has a first hydraulic piston operatively connected to the piston rod to drive the piston rod in a first axial direction, and wherein the second hydraulic cylinder is at a head of the second gas compression cylinder and has a second hydraulic piston operatively connected to the piston rod to drive the piston rod in a second axial direction, the second axial direction opposite the first axial direction.

Embodiment 4. The multi-cylinder fluid compressor of any one of Embodiments 1 to 3, further comprising a first hydraulic piston seal device between the first hydraulic piston and the first hydraulic cylinder and a second hydraulic piston seal device between the second hydraulic piston and the second hydraulic cylinder.

Embodiment 5. The multi-cylinder fluid compressor of any one of Embodiments 1 to 4, wherein the outlets of the first gas compression cylinder are in fluid communication with the inlets of the second gas compression cylinder to provide a multi-stage fluid compressor.

Embodiment 6. The multi-cylinder fluid compressor of any one of Embodiments 1 to 5, further comprising a cooler in fluid communication with the outlets of the first gas compression cylinder and the inlets of the second gas compression cylinder.

Embodiment 7. The multi-cylinder fluid compressor of Embodiment 6, further comprising an outlet header fluidly connecting the outlets of the first gas compression cylinder and further comprising an inlet header fluidly connecting the inlets of the second gas compression cylinder, wherein the cooler is in fluid communication between the outlet header and the inlet header.

Embodiment 8. The multi-cylinder fluid compressor of Embodiment 6 or 7, wherein the cooler comprises a plate and frame oil cooler.

Embodiment 9. The multi-cylinder fluid compressor of any one of Embodiments 1 to 8, comprising a first buffer chamber, comprising a variable annular space between the common piston rod and the first hydraulic piston extending between the head of the first gas compression cylinder and the first hydraulic piston, and a second buffer chamber, comprising a variable annular space between the common piston rod and the second hydraulic piston extending between the head of the second gas compression cylinder and the second hydraulic piston.

Embodiment 10. The multi-cylinder fluid compressor of Embodiment 9, wherein the first buffer chamber and the second buffer chamber are pressurized, pressure equalized, vented, fluidly connected, or combinations thereof.

Embodiment 11. The multi-cylinder fluid compressor of any one of Embodiments 1 to 10, wherein the inlets of the first and second gas compression cylinders are proximate a top of the first and second gas compression cylinders. In an embodiment disclosed, the inlets of the first and second gas compression cylinders are at the top of the first and second gas compression cylinders.

Embodiment 12. The multi-cylinder fluid compressor of any one of Embodiments 1 to 11, wherein the outlets of the first and second gas compression cylinders are proximate a bottom of the first and second gas compression cylinders. In an embodiment disclosed, the outlets of the first and second gas compression cylinders are at the bottom of the first and second gas compression cylinders. This, for example, enables any liquids and/or solids which may enter or form in the first and second gas compression cylinders to exit therefrom.

Embodiment 13. The multi-cylinder fluid compressor of any one of Embodiments 1 to 12, wherein one or more of the inlets or the outlets or both of the first and second gas compression cylinders are radial.

Embodiment 14. The multi-cylinder fluid compressor of any one of Embodiments 1 to 13, wherein one or more of the inlets or the outlets or both of the first and second gas compression cylinders are axial.

Embodiment 15. The multi-cylinder fluid compressor of any one of Embodiments 1 to 14, wherein the first and second gas compression cylinders are spaced axially apart.

Embodiment 16. The multi-cylinder fluid compressor of Embodiment 15, wherein a housing encloses the common piston rod between the first and second gas compression cylinders.

Embodiment 17. The multi-cylinder fluid compressor of any one of Embodiments 1 to 14, wherein the first and second gas compression cylinders are substantially adjacent, and connected by a connector plate. In an embodiment disclosed, the connector plate may provide a common head between the adjacent first and second gas compression cylinders.

Embodiment 18. The multi-cylinder fluid compressor of any one of Embodiments 1 to 17, further comprising a variable volume pocket fluidly connected with at least one of the first, second, third, and fourth compression chambers.

Embodiment 19. The multi-cylinder fluid compressor of any one of Embodiments 1 to 18, wherein each of the inlets and the outlets of the first, second, third, and fourth compression chambers are in fluid communication with a one-way check valve.

Embodiment 20. The multi-cylinder fluid compressor of any one of Embodiments 1 to 19, wherein the piston seal devices include one or more wear rings.

Embodiment 21. The multi-cylinder fluid compressor of any one of Embodiments 1 to 20, further comprising: a third gas compression cylinder, divided into fifth and sixth axially aligned compression chambers by a third reciprocating gas piston, each of the fifth and sixth compression chambers of the third gas compression cylinder having an inlet and an outlet; wherein the third gas compression cylinder is substantially axially aligned with the first gas compression cylinder and the second gas compression cylinder; wherein the common piston rod is operably connected to the third reciprocating gas piston; wherein the outlets of the second gas compression cylinder are in fluid communication with the inlets of the third gas compression cylinder; a seal device between the common piston rod and the third gas compression cylinder; and a piston seal device between the third reciprocating gas piston and the third gas compression cylinder.

Embodiment 22. The multi-cylinder fluid compressor of any one of Embodiments 1 to 21, further comprising the hydraulic fluid supply system.

Embodiment 23. A method of recovering vapor from a tank containing liquid hydrocarbons, the method comprising: delivering a flow of the vapor to a first gas compression cylinder of a multi-cylinder fluid compressor, the first gas compression cylinder divided into first and second axially aligned compression chambers by a first reciprocating gas piston; operating the first reciprocating gas piston to increase pressure of the vapor delivered to the first and second compression chambers to provide a flow of pressurized vapor; delivering the flow of pressurized vapor to a second gas compression cylinder of the multi-cylinder fluid compressor, the second gas compression cylinder divided into third and fourth axially aligned compression chambers by a second reciprocating gas piston; operating the second reciprocating gas piston in common with the first reciprocating gas piston, to further increase pressure of the pressurized vapor delivered to the third and fourth compression chambers to provide a flow of further pressurized vapor; and delivering the flow of further pressurized vapor from the third and fourth compression chambers.

Embodiment 24. The method of Embodiment 23, further comprising cooling the flow of pressurized vapor from the first and second compression chambers to provide a flow of cooled pressurized vapor, prior to delivering the flow of cooled pressurized vapor to the third and fourth compression chambers.

Embodiment 25. The method of Embodiment 23 or 24, wherein operating the second reciprocating gas piston in common with the first reciprocating gas piston comprises starting the operating, stopping the operating, setting a speed of the operating, adjusting a speed of the operating, maintaining the speed of the operating, or combinations thereof.

Embodiment 26. The method of any one of Embodiments 23 to 25, wherein operating the second reciprocating gas piston in common with the first reciprocating gas piston is responsive to pressure of the vapor in the tank.

Embodiment 27. The method of any one of Embodiments 23 to 26 wherein the multi-cylinder fluid compressor comprises the multi-cylinder fluid compressor of any one of Embodiments 1 to 22.

Embodiment 28. A method of recovering vapor from a tank containing liquid hydrocarbons, the method comprising using the multi-cylinder fluid compressor of any one of Embodiments 1 to 22 to compress the vapor.

Embodiment 29. A method of compressing the products of an oil and/or gas well, the method comprising using the multi-cylinder fluid compressor of any one of Embodiments 1 to 22 to compress a vapor phase of the products, pump a liquid phase of the products, compress and pump a multi-phase of the products or combinations thereof.

Embodiment 30. The method of any one of Embodiments 23 to 27, further comprising delivering the flow of further pressurized vapor from the third and fourth compression chambers for use as one or more of lift gas, injection gas, fuel gas, purge gas, buffer gas, sales gas, flare gas, or combinations thereof, or be piped to a natural gas pipeline for further processing, sale, or disposal or combinations thereof.

Embodiment 31. A multi-cylinder fluid compressor operable to compress a working fluid, said multi-cylinder fluid compressor comprising: a first gas compression cylinder, divided into first and second axially aligned compression chambers by a first reciprocating gas piston, each of the first and second compression chambers of the first gas compression cylinder having an inlet and an outlet; a second gas compression cylinder, divided into third and fourth axially aligned compression chambers by a second reciprocating gas piston, each of the third and fourth compression chambers of the second gas compression cylinder having an inlet and an outlet; wherein the second gas compression cylinder has a diameter less than the first gas compression cylinder; wherein the first gas compression cylinder and the second gas compression cylinder are axially aligned, and substantially axially adjacent; wherein a second gas cylinder head of the first gas compression cylinder and a first gas cylinder head of the second gas compression cylinder are axially connected; wherein the first gas cylinder head of the second gas compression cylinder provides an internal inlet flow passage extending between the inlet and the third compression chamber and an internal outlet flow passage extending between the third compression chamber and the outlet, a common piston rod extending through said first and second axially aligned compression cylinders and operably connected with the first reciprocating gas piston and the second reciprocating gas piston; first and second hydraulic cylinders positioned at opposite ends of the multi-cylinder fluid compressor, with the first and second compression cylinders therebetween to axially drive the common piston rod; wherein the first and second hydraulic cylinders are adapted to be actuated by a hydraulic fluid supply system to reciprocally drive the common piston rod and thereby the first reciprocating gas piston and the second reciprocating gas piston.

Embodiment 32. The multi-cylinder fluid compressor of Embodiment 31, further comprising: a seal device between the common piston rod and the first gas compression cylinder and a seal device between the common piston rod and the second gas compression cylinder; a piston seal device between the first reciprocating gas piston and the first gas compression cylinder; and a piston seal device between the second reciprocating gas piston and the second gas compression cylinder.

Embodiment 33. The multi-cylinder fluid compressor of Embodiment 31 or 32, wherein the first hydraulic cylinder is at a head of the first gas compression cylinder and has a first hydraulic piston operatively connected to the piston rod to drive the piston rod in a first axial direction, and wherein the second hydraulic cylinder is at a head of the second gas compression cylinder and has a second hydraulic piston operatively connected to the piston rod to drive the piston rod in a second axial direction, the second axial direction opposite the first axial direction.

Embodiment 34. The multi-cylinder fluid compressor of any one of Embodiments 31 to 33, further comprising a first hydraulic piston seal device between the first hydraulic piston and the first hydraulic cylinder and a second hydraulic piston seal device between the second hydraulic piston and the second hydraulic cylinder.

Embodiment 35. The multi-cylinder fluid compressor of any one of Embodiments 31 to 34, wherein the outlets of the first gas compression cylinder are in fluid communication with the inlets of the second gas compression cylinder to provide a multi-stage fluid compressor.

Embodiment 36. The multi-cylinder fluid compressor of Embodiment 35, further comprising a cooler in fluid communication with the outlets of the first gas compression cylinder and the inlets of the second gas compression cylinder.

Embodiment 37. The multi-cylinder fluid compressor of Embodiment 36, further comprising an outlet header fluidly connecting the outlets of the first gas compression cylinder and further comprising an inlet header fluidly connecting the inlets of the second gas compression cylinder, wherein the cooler is in fluid communication between the outlet header and the inlet header.

Embodiment 38. The multi-cylinder fluid compressor of Embodiment 36 or 37, wherein the cooler comprises a plate and frame oil cooler.

Embodiment 39. The multi-cylinder fluid compressor of any one of Embodiments 31 to 38, comprising a first buffer chamber, comprising a variable annular space between the common piston rod and the first hydraulic piston extending between the head of the first gas compression cylinder and the first hydraulic piston, and a second buffer chamber, comprising a variable annular space between the common piston rod and the second hydraulic piston extending between the head of the second gas compression cylinder and the second hydraulic piston.

Embodiment 40. The multi-cylinder fluid compressor of Embodiment 39, wherein the first buffer chamber and the second buffer chamber are pressurized, pressure equalized, vented, fluidly connected, or combinations thereof.

Embodiment 41. The multi-cylinder fluid compressor of any one of Embodiment ss 31 to 40, wherein the inlets of the first and second gas compression cylinders are proximate a top of the first and second gas compression cylinders.

Embodiment 42. The multi-cylinder fluid compressor of any one of Embodiments 31 to 41, wherein the outlets of the first and second gas compression cylinders are proximate a bottom of the first and second gas compression cylinders.

Embodiment 43. The multi-cylinder fluid compressor of any one of Embodiments 31 to 42, wherein one or more of the inlets or the outlets or both of the first and second gas compression cylinders are radial.

Embodiment 44. The multi-cylinder fluid compressor of any one of Embodiments 31 to 43, wherein one or more of the inlets or the outlets or both of the first and second gas compression cylinders are axial.

Embodiment 45. The multi-cylinder fluid compressor of any one of Embodiments 31 to 44, further comprising a variable volume pocket fluidly connected with at least one of the first, second, third, and fourth compression chambers.

Embodiment 46. The multi-cylinder fluid compressor of any one of Embodiments 31 to 45, wherein each of the inlets and the outlets of the first, second, third, and fourth compression chambers are in fluid communication with a one-way check valve.

Embodiment 47. The multi-cylinder fluid compressor of Embodiment 32, wherein the piston seal devices include one or more wear rings.

Embodiment 48. The multi-cylinder fluid compressor of any one of Embodiments 35 to 37, further comprising: a third gas compression cylinder, divided into fifth and sixth axially aligned compression chambers by a third reciprocating gas piston, each of the fifth and sixth compression chambers of the third gas compression cylinder having an inlet and an outlet; wherein the third gas compression cylinder is substantially axially aligned with the first gas compression cylinder and the second gas compression cylinder; wherein the third gas compression cylinder has a diameter less than the second gas compression cylinder; wherein the third gas compression cylinder and the second gas compression cylinder are axially aligned, and substantially adjacent; wherein a head of the second gas compression cylinder and a head of the third gas compression cylinder are axially connected; wherein the head of the third gas compression chamber provides an internal inlet flow passage extending between the inlet and the fifth compression chamber, and an internal outlet flow passage extending between the fifth compression chamber and the outlet, wherein the common piston rod is operably connected to the third reciprocating gas piston; wherein the outlets of the second gas compression cylinder are in fluid communication with the inlets of the third gas compression cylinder; a seal device between the common piston rod and the third gas compression cylinder; and a piston seal device between the third reciprocating gas piston and the third gas compression cylinder.

Embodiment 49. The multi-cylinder fluid compressor of any one of Embodiments 31 to 48, further comprising the hydraulic fluid supply system.

Embodiment 50. A method of recovering vapor from a tank containing liquid hydrocarbons, the method comprising: providing a multi-cylinder fluid compressor of any one of Embodiments 35 to 37; conveying the vapor to the first gas compression cylinder; operating the multi-cylinder fluid compressor to increase pressure of the vapor to provide first stage pressurized vapor; cooling the first stage pressurized vapor to provide cooled first stage pressurized vapor; conveying the cooled first stage pressurized vapor to the second gas compression cylinder; and operating the multi-cylinder fluid compressor to increase pressure of the cooled first stage pressurized vapor to provide second stage pressurized vapor.

Embodiment 51. The method of Embodiment 50, further comprising cooling the second stage pressurized vapor to provide cooled second stage pressurized vapor.

Embodiment 52. The method of Embodiment 51, further comprising conveying the cooled second stage pressurized vapor to one or more of a makeup gas system, a vapor recovery unit, a sales gas pipeline, a storage vessel, and/or a flare.

Embodiment 53. The method of any one of Embodiments 50 to 52, wherein operating the multi-cylinder fluid compressor comprises starting the operating, stopping the operating, setting a speed of the operating, setting a stroke of the operating, adjusting a speed of the operating, maintaining a speed of the operating, adjusting a stroke of the operating, maintaining a stroke of the operating, or any combinations thereof.

Embodiment 54. The method of any one of Embodiments 50 to 53, wherein operating the multi-cylinder fluid compressor is responsive to pressure of the vapor in the tank.

Embodiment 55. A method of recovering vapor from a tank containing liquid hydrocarbons, the method comprising: providing a multi-cylinder fluid compressor of Embodiment 48; conveying vapor to the first gas compression cylinder; operating the multi-cylinder fluid compressor to increase pressure of the vapor to provide first stage pressurized vapor; cooling the first stage pressurized vapor to provide cooled first stage pressurized vapor; conveying the cooled first stage pressurized vapor to the second gas compression cylinder; operating the multi-cylinder fluid compressor to increase pressure of the cooled pressurized vapor to provide second stage pressurized vapor; cooling the second stage pressurized vapor to provide cooled second stage pressurized vapor; conveying the cooled second stage pressurized vapor to the third gas compression cylinder; operating the multi-cylinder fluid compressor to increase pressure of the cooled second stage pressurized vapor to provide third stage pressurized vapor.

Embodiment 56. The method of Embodiment 55, further comprising cooling the third stage pressurized vapor to provide cooled third stage pressurized vapor.

Embodiment 57. The method of Embodiment 56, further comprising conveying the cooled third stage pressurized vapor to one or more of a makeup gas system, a vapor recovery unit, a sales gas pipeline, a storage vessel, and/or to a flare.

Embodiment 58. The method of any one of Embodiments 55 to 57, wherein operating the multi-cylinder fluid compressor comprises starting the operating, stopping the operating, setting a speed of the operating, setting a stroke of the operating, adjusting a speed of the operating, maintaining the speed of the operating, adjusting a stroke of the operating, maintaining a stroke of the operating, or any combinations thereof.

Embodiment 59. The method of any one of Embodiments 55 to 58, wherein operating the multi-cylinder fluid compressor is responsive to pressure of the vapor in the tank.

Embodiment 60. The method of Embodiment 54 or 59, wherein the pressure of the vapor in the tank is between about 0 oz/in² to about 4 oz/in².

While specific embodiments have been described and illustrated, such embodiments should be considered illustrative of the subject matter described herein rather than limiting.

Various modifications and additions can be made without departing from the spirit and scope of the invention. Features of each of the various embodiments described above may be combined with features of other described embodiments as appropriate in order to provide a multiplicity of feature combinations in associated new embodiments. Also, it is to be understood that the phraseology and terminology employed herein are for the purposes of description and should not be regarded as limiting the claims.

1. A multi-cylinder fluid compressor operable to compress a working fluid, said multi-cylinder fluid compressor comprising:
a first gas compression cylinder, divided into first and second axially aligned compression chambers by a first reciprocating gas piston, each of the first and second compression chambers of the first gas compression cylinder having an inlet and an outlet;
a second gas compression cylinder, divided into third and fourth axially aligned compression chambers by a second reciprocating gas piston, each of the third and fourth compression chambers of the second gas compression cylinder having an inlet and an outlet;
wherein the second gas compression cylinder has a diameter less than the first gas compression cylinder;
wherein the first gas compression cylinder and the second gas compression cylinder are axially aligned, and substantially axially adjacent;
wherein a second gas cylinder head of the first gas compression cylinder and a first gas cylinder head of the second gas compression cylinder are axially connected;
wherein the first gas cylinder head of the second gas compression cylinder provides an internal inlet flow passage extending between the inlet and the third compression chamber and an internal outlet flow passage extending between the third compression chamber and the outlet,
a common piston rod extending through said first and second axially aligned compression cylinders and operably connected with the first reciprocating gas piston and the second reciprocating gas piston;
first and second hydraulic cylinders positioned at opposite ends of the multi-cylinder fluid compressor, with the first and second compression cylinders therebetween to axially drive the common piston rod;
wherein the first and second hydraulic cylinders are adapted to be actuated by a hydraulic fluid supply system to reciprocally drive the common piston rod and thereby the first reciprocating gas piston and the second reciprocating gas piston.

2. The multi-cylinder fluid compressor of claim 1, further comprising:
a seal device between the common piston rod and the first gas compression cylinder and a seal device between the common piston rod and the second gas compression cylinder;
a piston seal device between the first reciprocating gas piston and the first gas compression cylinder; and
a piston seal device between the second reciprocating gas piston and the second gas compression cylinder.

3. The multi-cylinder fluid compressor of claim 2, wherein the first hydraulic cylinder is at a head of the first gas compression cylinder and has a first hydraulic piston operatively connected to the piston rod to drive the piston rod in a first axial direction, and wherein the second hydraulic cylinder is at a head of the second gas compression cylinder and has a second hydraulic piston operatively connected to the piston rod to drive the piston rod in a second axial direction, the second axial direction opposite the first axial direction.

4. The multi-cylinder fluid compressor of claim 3, further comprising a first hydraulic piston seal device between the first hydraulic piston and the first hydraulic cylinder and a second hydraulic piston seal device between the second hydraulic piston and the second hydraulic cylinder.

5. The multi-cylinder fluid compressor of claim 3, wherein the outlets of the first gas compression cylinder are in fluid communication with the inlets of the second gas compression cylinder to provide a multi-stage fluid compressor.

6. The multi-cylinder fluid compressor of claim 5, further comprising a cooler in fluid communication with the outlets of the first gas compression cylinder and the inlets of the second gas compression cylinder.

7. The multi-cylinder fluid compressor of claim 6, further comprising an outlet header fluidly connecting the outlets of the first gas compression cylinder and further comprising an inlet header fluidly connecting the inlets of the second gas compression cylinder, wherein the cooler is in fluid communication between the outlet header and the inlet header.

8. The multi-cylinder fluid compressor of claim 7, wherein the cooler comprises a plate and frame oil cooler.

9. The multi-cylinder fluid compressor of claim 4, comprising a first buffer chamber, comprising a variable annular space between the common piston rod and the first hydraulic piston extending between the head of the first gas compression cylinder and the first hydraulic piston, and a second buffer chamber, comprising a variable annular space between the common piston rod and the second hydraulic piston extending between the head of the second gas compression cylinder and the second hydraulic piston.

10. The multi-cylinder fluid compressor of claim 9, wherein the first buffer chamber and the second buffer chamber are pressurized, pressure equalized, vented, fluidly connected, or combinations thereof.

11. The multi-cylinder fluid compressor of claim 2, wherein the inlets of the first and second gas compression cylinders are proximate a top of the first and second gas compression cylinders.

12. The multi-cylinder fluid compressor of claim 2, wherein the outlets of the first and second gas compression cylinders are proximate a bottom of the first and second gas compression cylinders.

13. The multi-cylinder fluid compressor of claim 2, wherein one or more of the inlets or the outlets or both of the first and second gas compression cylinders are radial.

14. The multi-cylinder fluid compressor of claim 2, wherein one or more of the inlets or the outlets or both of the first and second gas compression cylinders are axial.

15. The multi-cylinder fluid compressor of claim 2, further comprising a variable volume pocket fluidly connected with at least one of the first, second, third, and fourth compression chambers.

16. The multi-cylinder fluid compressor of claim 2, wherein each of the inlets and the outlets of the first, second, third, and fourth compression chambers are in fluid communication with a one-way check valve.

17. The multi-cylinder fluid compressor of claim 2, wherein the piston seal devices include one or more wear rings.

18. The multi-cylinder fluid compressor of claim 5, further comprising:
a third gas compression cylinder, divided into fifth and sixth axially aligned compression chambers by a third reciprocating gas piston, each of the fifth and sixth compression chambers of the third gas compression cylinder having an inlet and an outlet;
wherein the third gas compression cylinder is substantially axially aligned with the first gas compression cylinder and the second gas compression cylinder;
wherein the third gas compression cylinder has a diameter less than the second gas compression cylinder;
wherein the third gas compression cylinder and the second gas compression cylinder are axially aligned, and substantially adjacent;
wherein a head of the second gas compression cylinder and a head of the third gas compression cylinder are axially connected;
wherein the head of the third gas compression chamber provides an internal inlet flow passage extending between the inlet and the fifth compression chamber, and an internal outlet flow passage extending between the fifth compression chamber and the outlet, wherein the common piston rod is operably connected to the third reciprocating gas piston;
wherein the outlets of the second gas compression cylinder are in fluid communication with the inlets of the third gas compression cylinder;
a seal device between the common piston rod and the third gas compression cylinder; and
a piston seal device between the third reciprocating gas piston and the third gas compression cylinder.

19. The multi-cylinder fluid compressor of claim 1, further comprising the hydraulic fluid supply system.

20. A method of recovering vapor from a tank containing liquid hydrocarbons, the method comprising:
providing a multi-cylinder fluid compressor of claim 5;
conveying the vapor to the first gas compression cylinder;
operating the multi-cylinder fluid compressor to increase pressure of the vapor to provide first stage pressurized vapor;
cooling the first stage pressurized vapor to provide cooled first stage pressurized vapor;
conveying the cooled first stage pressurized vapor to the second gas compression cylinder; and
operating the multi-cylinder fluid compressor to increase pressure of the cooled first stage pressurized vapor to provide second stage pressurized vapor.

21. The method of claim 20, further comprising cooling the second stage pressurized vapor to provide cooled second stage pressurized vapor.

22. The method of claim 21, further comprising conveying the cooled second stage pressurized vapor to one or more of a makeup gas system, a vapor recovery unit, a sales gas pipeline, a storage vessel, and/or a flare.

23. The method of claim 20, wherein operating the multi-cylinder fluid compressor comprises starting the operating, stopping the operating, setting a speed of the operating, setting a stroke of the operating, adjusting a speed of the operating, maintaining a speed of the operating, adjusting a stroke of the operating, maintaining a stroke of the operating, or any combinations thereof.

24. The method of claim 23, wherein operating the multi-cylinder fluid compressor is responsive to pressure of the vapor in the tank.

25. A method of recovering vapor from a tank containing liquid hydrocarbons, the method comprising:
providing a multi-cylinder fluid compressor of claim 18;
conveying vapor to the first gas compression cylinder;
operating the multi-cylinder fluid compressor to increase pressure of the vapor to provide first stage pressurized vapor;
cooling the first stage pressurized vapor to provide cooled first stage pressurized vapor;
conveying the cooled first stage pressurized vapor to the second gas compression cylinder;
operating the multi-cylinder fluid compressor to increase pressure of the cooled pressurized vapor to provide second stage pressurized vapor;
cooling the second stage pressurized vapor to provide cooled second stage pressurized vapor;
conveying the cooled second stage pressurized vapor to the third gas compression cylinder;
operating the multi-cylinder fluid compressor to increase pressure of the cooled second stage pressurized vapor to provide third stage pressurized vapor.

26. The method of claim 25, further comprising cooling the third stage pressurized vapor to provide cooled third stage pressurized vapor.

27. The method of claim 26, further comprising conveying the cooled third stage pressurized vapor to one or more of a makeup gas system, a vapor recovery unit, a sales gas pipeline, a storage vessel, and/or a flare.

28. The method of claim 25, wherein operating the multi-cylinder fluid compressor comprises starting the operating, stopping the operating, setting a speed of the operating, setting a stroke of the operating, adjusting a speed of the operating, maintaining the speed of the operating, adjusting a stroke of the operating, maintaining a stroke of the operating, or any combinations thereof.

29. The method of claim 28, wherein operating the multi-cylinder fluid compressor is responsive to pressure of the vapor in the tank.

30. The method of claim 20, wherein the pressure of the vapor in the tank is between about 0 oz/in² to about 4 oz/in².
